(19) United States
(12) Patent Application Publication
(10) Pub. No.: US 2015/0281126 A1
(43) Pub. Date: Oct. 1, 2015

(54) METHODS AND APPARATUS FOR A HIGH PERFORMANCE MESSAGING ENGINE INTEGRATED WITHIN A PCIe SWITCH

(71) Applicant: PLX Technology, Inc., Sunnyvale, CA (US)

(72) Inventors: Jack REGULA, Durham, NC (US); Jeffrey M. DODSON, Portland, OR (US); Nagarajan SUBRAMANIYAN, San Jose, CA (US)

(73) Assignee: PLX Technology, Inc., Sunnyvale, CA (US)

(21) Appl. No.: 14/244,634

(22) Filed: Apr. 3, 2014

Related U.S. Application Data
(63) Continuation-in-part of application No. 14/231,079, filed on Mar. 31, 2014.

(51) Int. Cl. H04L 12/947; H04L 29/08

(52) U.S. Cl. CPC H04L 49/25; H04L 67/26; H04L 67/10

(57) ABSTRACT

A method of transferring data over a switch fabric with at least one switch with an embedded network class endpoint device is provided. At a device transmit driver a transfer command is received to transfer a message. If the message length is less than a threshold the message is pushed. If the message length is greater than the threshold, the message is pulled.

### BACKGROUND OF THE INVENTION

1. Field of the Invention

The present invention relates generally to switches and electronic communication. More specifically, the present invention relates to the transfer of data over switch fabrics.

2. Description of the Related Art

Diverse protocols have been used to transport digital data over switch fabrics. A protocol is generally defined by the sequence of packet exchanges used to transfer a message or data from source to destination and the feedback and configurable parameters used to ensure its goals as are met. Transport protocols have the goals of reliability, maximizing throughput, minimizing latency, and adhering to ordering requirements, among others. Design of a transport protocol requires an artful set of compromises among the often competing goals.

### SUMMARY OF THE INVENTION

One aspect of the invention is a method of transferring data over a switch fabric with at least one switch with an embedded network class endpoint device is provided. A push vs. pull threshold is initialized. A device transmit driver receives a command to transfer a message. If the message length is less than the push vs. pull threshold the message is pushed. If the message length is greater than the push pull threshold, the message is pulled. Congestion at various message destinations is measured. The push vs. pull threshold is adjusted according to the measured congestion.

In another manifestation of the invention, an apparatus is provided. The apparatus comprises a switch. At least one network class device endpoint is embedded in the switch.

In another manifestation of the invention, a method of transferring data over a switch fabric with at least one switch with an embedded network class endpoint device is provided. At a device transmit driver a transfer command is received to transfer a message. If the message length is less than a threshold the message is pushed. If the message length is greater than the threshold, the message is pulled.

In another manifestation of the invention, a method of transferring data over a fabric switch is provided. A device transmit driver receives a command to transfer a message. If the message length is less than the threshold the message is pushed. If the message length is greater than the threshold, the message is pulled.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a ladder diagram for the short packet push transfer.

FIG. 2 is a ladder diagram for the NIC mode write pull transfer.

FIG. 3 is a ladder diagram of an RDMA write.

FIG. 4 is schematic illustration of a VDM Header Format Excerpt from the PCIe Specification.

FIG. 5 is a schematic view of a buffer described by an S/G list with 4 KB pages.

FIG. 6 describes how a memory region greater than 2 MB and less than 4 GB is described by a list of S/G lists, each with 4 KB pages.

FIG. 7 is a flow chart of a RDMA buffer tag table lookup process.

FIG. 8 is block diagram of a complete system containing a switch fabric in which the individual switches are embodiments of the invention

FIG. 9 is a computing device that is used as a server in an embodiment of the invention.

FIG. 10 is a flow chart of an embodiment of the invention.

FIG. 11 is a block diagram view of a DMA engine.

These and other features of the present invention will be described in more detail below in the detailed description of the invention and in conjunction with the following figures.

### DETAILED DESCRIPTION OF SPECIFIC EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

While the multiple protocols in use differ greatly in many respects, most have at least this property in common: that they push data from source to destination. In a push protocol, the sending of a message is initiated by the source. In a pull protocol, data transfer is initiated by the destination. When fabrics support both push and pull transfers, it is the norm to allow applications to choose whether to use push or pull semantics.

Pull protocols have been avoided primarily because at least two passes and sometimes three passes across the fabric are required in order to communicate. First a message has to be sent to request the data from the remote node and then the node has to send the data back across the fabric. A load/store fabric provides the simplest examples of pushes (writes) and pulls (reads). However, simple processor PIO reads and writes are primitive operations that don't rise to the level of a protocol. Nevertheless, even at the primitive level, reads are avoided wherever possible because of the higher latency of the read and because the processing thread containing the read blocks until it completes.

The necessity for at least a fabric round trip is a disadvantage that can't be overcome when the fabric diameter is high. However, there are compensating advantages for the use of a pull protocol that may compel its use over a small fabric diameter, such as one sufficient to interconnect a rack or a small number of racks of servers.

Given the ubiquity of push protocols at the fabric transport level, any protocol that successfully uses pull mechanisms to provide a balance of high throughput, low latency, and resiliency must be considered innovative.

Sending messages at the source's convenience leads to one of the fundamental issues with a push protocol: Push messages and data may arrive at the destination when the destination isn't ready to receive them. An edge fabric node may receive messages or data from multiple sources concurrently at an aggregate rate faster than it can absorb them. Congestion caused by these factors can spread backwards in the network causing significant delays.

Depending on fabric topology, contention, resulting in congestion, can arise at intermediate stages also and can arise due to faults as well as to an aggregating of multiple data flows through a common nexus. When a fabric has contention “hot spots” or faults, it is useful to be able to route around the faults and hot spots without or with minimum intervention by software and with a rapid reaction time. In current systems, re-routing typically requires software intervention to select alternate routes and update routing tables.

Additional time consuming steps to avoid out of order delivery may be required, as is the case, for example, with Remote Direct Memory Access (RDMA). It is frequently the case that attempts to reroute around congestion are ineffective because the congestion is transient in nature and dissipates or moves to another node before the fabric and its software can react.

Pull protocols can avoid or minimize output port contention by allowing a data-destination to regulate the movement of data into its receiving interface but innovative means must be found to take advantage of this capability. While minimizing output port contention, pull protocols can suffer from source port contention. A pull protocol should therefore include means to minimize or regulate source port contention as well. An embodiment of the invention provides a pull protocol where the data movement traffic it generates is comprised of unordered streams. This allows us to route those streams dynamically on a packet by packet basis without software intervention to meet criteria necessary for the fabric to be non-blocking.

A necessary but in itself insufficient condition for a multiple stage switches fabric to be non-blocking is that it have at least constant bisection bandwidth between stages or switch ranks. If a multi-stage switch fabric has constant bi-section bandwidth, then it can be strictly non-blocking only to the extent that the traffic load is equally divided among the redundant paths between adjacent switch ranks. Certain fabric topologies, such as Torus fabrics of various dimensions, contain redundant paths but are inherently blocking because of the oversubscription of links between switches. There is great benefit in being able to reroute dynamically so as to avoid congested links in these topologies.

Statically routed fabrics often fall far short of achieving load balance but preserve ordering and are simple to implement. Dynamically routed fabrics incur various amounts of overhead, cost, complexity, and delay in order to reroute traffic and handle ordering issues caused by the rerouting. Dynamic routing is typically used on local and wide area networks and at the boundaries between the two, but, because of cost and complexity, not on a switch fabric acting as a backplane for something of the scale of a rack of servers.

A pull protocol that not only takes full advantage of the inherent congestion avoidance potential of pull protocols but also allows dynamic routing on a packet by packet basis without software intervention would be a significant innovation.

Any switch fabric intended to be used to support clustering of compute nodes should include means to allow the TCP/IP stack to be bypassed to both reduce software latency and to eliminate the latency and processor overhead of copying transmit and receive data between intermediate buffers. It has become the norm to do this by implementing support for RDMA in conjunction with, for example, the use of the OpenFabrics Enterprise Distribution (OFED) software stack.

RDMA adds cost and complexity to fabric interface components for implementing memory registration tables, among other things. These tables could be more economically located in the memories of attached servers. However, then the latency of reading these tables, at least once and in some cases two or more times per message, would add to the latency of communications. An RDMA mechanism that uses a pull protocol such that the latency of reading buffer registration tables, sometimes called BTT for Buffer Tag Table (or Memory Region table), in host/server memory overlaps the remote reads of the pull protocol and masks this latency allowing such tables to be located in host/server memory without a performance penalty.

Embodiments of the invention provide several ways, which have been shown in which pull techniques can be used to achieve high switch fabric performance at low cost. In various embodiment, these methods have been synthesized into a complete fabric data transfer protocol and DMA engine. An embodiment is provided by describing the protocol, and its implementation, in which the transmit driver accepts both push and pull commands from higher level software but chooses to use pull methods to execute a push command on a transfer by transfer to optimize performance or in reaction to congestion feedback.

In designing a messaging system to use a mix of push and pull methods to transfer data/messages between peer compute nodes attached to a switch fabric, the messaging system must support popular Application Programming Interfaces, APIs, which most often employ a push communication paradigm. In order to obtain the benefits of a pull protocol, for avoiding congestion and having sufficient real time reroutable traffic to achieve the non-blocking condition, a method is required to transform push commands received by driver software via one of these APIs into pull data transfers. Furthermore, the driver for the messaging mechanism must, on a transfer command by transfer command basis, decide whether to use push semantics or pull semantics for the transfer and to do so in such a way that sufficient pull traffic is generated to allow loading on redundant paths to be balanced.

The problem of allowing pushes to be transformed into pulls is solved in the following manner. First, a relatively large message transmit descriptor size is employed. The preferred embodiment uses a 128 byte descriptor that can contain message parameters and routing information (source and destination IDs, in the case of ExpressFabric) plus either a complete short message of 116 bytes or a set of 10 pointers and associated transfer lengths that can be used as the gather list of a pull command. A descriptor formatted to contain a 116B message is called a short packet push descriptor. A descriptor formatted to contain a gather list is called a pull request descriptor.

When our device's transmit driver receives a transfer command from an API or a higher layer protocol, it makes a decision to use push or pull semantics based primarily on the transfer length of the command. If 116 bytes or less are to be transferred, the short pack push transfer method is used. If the transfer length is somewhat longer than 116 bytes but less than a threshold that is typically 1 KB or less, the data is sent as a sequence of short packet pushes. If the transfer length exceeds the threshold the pull transfer method is used. In the preferred embodiment, up to 640K bytes can be moved via a single pull command. Transfers too large for a single pull command are done with multiple pull commands in sequence.

In analyzing protocol efficiency, we found unsurprisingly that use of pull commands was more efficient than use of the short packet push for transfers greater than a certain amount. However, the goal of low latency competes with the goal of high efficiency, which in turn leads to higher throughput. In many applications, but not all, low latency is critical. Thus we made the threshold for choosing to use push vs. pull configurable and have the ability to adapt the threshold to fabric conditions and application priority. Where low latency is deemed important, the initial threshold is set to a relatively high value of 512 bytes or perhaps even 1K bytes. This will minimize latency only if congestion doesn't result from the resulting high percentage of push traffic. In our messaging process, each transfer command receives an acknowledgement via a Transmit Completion Queue vendor defined message, abbreviated TxCQ VDM, that contains a coarse congestion indication from the destination of the transfer it acknowledges. If the driver sees congestion at a destination when processing the TxCQ VDM, it can raise the push/pull threshold to increase the relative fraction of pull traffic. This has two desirable effects:
1. Better use is made of the remaining queue space at the destination because for transfer lengths greater than 116 bytes pull commands store more compactly than push commands
2. A higher percentage of pulls allows the destination's egress link bandwidth to be controlled and ultimately the congestion to be reduced.

If low latency is not deemed to be critically important, then the push vs. pull threshold can be set at the transfer length where push and pull have equal protocol efficiency (defined as the number of bytes of payload delivered divided by the total number of bytes transferred). In reaction to congestion feedback the threshold can be reduced to the message length that can be embedded in a single descriptor.

In order to be transmit a message, its descriptor is created and added onto the tail of a transmit queue by the driver software. Eventually the transmit engine reads the queue and obtains the descriptor. In a conventional device, the transmit engine must next read server/host memory again at an address contained in the descriptor. Only when this read completes can it forward the message into the fabric. With current technology, that second read of host memory adds at least 200 ns to the transfer latency and more when there is contention for the use of memory inside the attached server/host. In a transmit engine in an embodiment of the invention that second read isn't required, eliminating that component of the latency when the push mode is used and compensating in part for additional pass(es) through the fabric needed when the pull mode is used.

In the pull mode, the pull request descriptor is forwarded to the destination and buffered there in a work request queue for the DMA engine at the destination node. When the message bubbles to the top of its queue it may be selected for execution. In the course of its execution, what we call a remote read request message is sent by the destination DMA engine back to the source node. An optional latency reducing step can be taken by the transmit engine when it forwards the pull request descriptor message: it can also send a read request for the data to be pulled. If this is done, then the data requested by the pull request can be waiting in the switch when the remote read request message arrives at the switch. This can reduce the overall transfer latency by the round trip latency for a read of host/server memory by the switch containing the DMA engine.

Any prefetched data must be capable of being buffered in the switch. Since only a limited amount of memory is available for this purpose, prefetch must be used judiciously. Prefetch is only used when buffer space is available to be reserved for this use and only for packets whose length is greater than the push vs. pull threshold and less than a second threshold. That second threshold must be consistent with the amount of buffer memory available, the maximum number of outstanding pull request messages allowed for which prefetch might be beneficial, and the perception that the importance of low latency diminishes with increasing message length. In the preferred embodiment, this threshold can range from 117B up to 4 KB.

Capella is the name given to an embodiment of the invention. With Capella, the paradigm for host to host communications on a PCIe switch fabric shifts from the conventional non-transparent bridge based memory window model to one of Network Interface Cards (NICs) embedded in the switch that tunnel data through ExpressFabric™ and implement RDMA over PCI express (PCIe). Each 16-lane module, called a station in the architecture of an embodiment of the invention includes a physical DMA messaging engine shared by all the ports in the module. Its single physical Direct Memory Access (DMA) function is enumerated and managed by the management processor. Virtual DMA functions are spawned from this physical function and assigned to the local host ports using the same Configuration Space Registers (CSR) redirection mechanism that enables ExpresssIOV™.

The messaging engine interprets descriptors given to it via transmit descriptor queues, (TxQs). Descriptors can define NIC mode operations or RDMA mode operations. For a NIC mode descriptor, the message engine transmits messages pointed to by transmit descriptor queues, TxQs, and stores received messages into buffers described by a receive descriptor ring or receive descriptor queue (RxQ). It thus emulates the operation of an Ethernet NIC and accordingly is used with a standard TCP/IP protocol stack. For RDMA mode, which requires prior connection set up to associate destination/application buffer pointers with connection parameters, the destination write address is obtained by looking up in a Buffer Tag Table (BTT) at the destination, indexed by the Buffer Tag that is sent to the destination in the Work Request Vendor Defined Message (WR VDM). RDMA layers in both the hardware and the drivers implement RDMA over PCIe with reliability and security, as standardized in the industry for other fabrics. The PLX RDMA driver sits at the bottom of the OFED protocol stack.

RDMA provides low latency after the connection setup overhead has been paid and eliminates the software copy overhead by transferring directly from source application buffer to destination application buffer. The RDMA Layer subsection describes how RDMA protocol is tunneled through the fabric.

### DMA VF Configurations

The DMA functionality is presented to hosts as a number of DMA virtual functions (VFs) that show up as networking class endpoints in the hosts' PCIe hierarchy. In addition to the host port DMA VFs, a single DMA VF is provisioned for use by the MCPU. An addition DMA VF is provided for the MCPU and is documented in a separate subsection.

Each host DMA VF includes a single TxCQ (transmit completion queue), a single Rx Queue (receive Queues/Receive descriptor ring), Multiple RxCQs (receive completion queues), Multiple TxQs (transmit queues/transmit descriptor rings), and three MSI-X interrupt vectors, which are Vector 0 General/Error Interrupt, Vector 1 TxCQ Interrupt with time and count moderation, and Vectors 2++: RxCQ Interrupt with time and count moderation. One vector per RxCQ is configured in the VF. In other embodiments, multiple RxCQs can share a vector.

Each DMA VF appears to the host as an R-NIC (RDMA capable NIC) or network class endpoint embedded in the switch. Each VF has a synthetic configuration space created by the MCPU via CSR redirection and a set of directly accessible memory mapped registers mapped via the BARO of its synthetic configuration space header. Some DMA parameters not visible to hosts are configured in the GEP of the station. An address trap may be used to map BARs (Base Address Register) of the DMA VF engine.

The number of DMA functions in a station is configured via the DMA Function Configuration registers in the Per Station Register block in the GEP's BARO memory mapped space. The VF to Port Assignment register is in the same block. The latter register contains a port index field. When this register is written, the specified block of VFs is configured to the port identified in the port index field. While this register structure provides a great deal of flexibility in VF assignment, only those VF configurations described in Table 1 have been verified.

TABLE 1
Supported DMA VF Configurations

| | Default | | | | | |
|---|---|---|---|---|---|---|
| | Value | Attribute | EEPROM | Reset | Register or Field | |
| Offset | (hex) | (MCPU) | Writable | Level | Name | Description |
| | | | | | DMA Station | |
| | | | | | Registers | |
| 100 h | | | | | DMA Function | |
| | | | | | Configuration | |
| [3:0] | 6 | RW | Yes | Level01 | DMA Function | This field specifies the number of DMA function in the |
| | | | | | Configuration | station: 0 = 1, 1 = 2, 2 = 4, 3 = 8, 4 = 16, 5 = 32, 6 = 64, |
| | | | | | | 7-15 = Reserved. |
| 128 h | | | | | VF to Port | |
| | | | | | Assignment | |
| [2:0] | 0 | RW | Yes | Level01 | Port Index | This field specifies the port (port number within the |
| | | | | | | station) that will be assigned DMA VFs. |
| [7:3] | 0 | RsvdP | No | Level0 | Reserved | |
| [13:8] | 0 | RW | Yes | Level01 | Starting VF ID | This is the starting VF ID that is assigned to the port |
| | | | | | | specified in the Port Index field. |
| | | | | | | The starting VF number plus the number of VFs |
| | | | | | | assigned to a port cannot exceed the number of VFs |
| | | | | | | available. Additionally, the total number of VFs assigned |
| | | | | | | to ports cannot exceed the number of VFs available. The |
| | | | | | | number of VFs available is programmable through the |
| | | | | | | Function Configuration register. |
| [15:14] | 0 | RsvdP | No | Level0 | Reserved | |
| [19:16] | 7 | RW | Yes | Level01 | Number of VFs | This field specifies the number of VFs assigned to the |
| | | | | | | port specified in the Port Index field as a power of 2. A |
| | | | | | | value of 7 means there are no VFs assigned to the |
| | | | | | | specified port. |
| [30:20] | 0 | RsvdP | No | Level0 | Reserved | |
| [31] | 0 | RW | Yes | Level01 | VF Field Write | When this bit is one, the Starting VF and Number of VF |
| | | | | | Enable | fields are writable. Otherwise only the Port Index field is |
| | | | | | | writable. This field always returns zero when read. |

| | | | | | | | | | | RDMA | | | |
|---|---|---|---|---|---|---|---|---|---|---|---|---|---|
| | VFs | TXQs | | RXQs | | TXCQs | | RXCQs | | Connections | | MSI-X Vectors | |
| Mode | PER STN | PER VF | PER STN | PER VF | PER STN | PER VF | PER STN | PER VF | PER STN | PER VF | PER STN | PER VF | PER STN |
| 2 | 4 | 128 | 512 | 1 | 4 | 1 | 4 | 64 | 256 | 4096 | 16k | 66 | 264 |
| (HPC) | | | | | | | | | | | | | |
| 6 | 64 | 8 | 512 | 1 | 64 | 1 | 64 | 4 | 256 | 256 | 16k | 6 | 384 |
| (IOV) | | | | | | | | | | | | | |

For HPC applications, a 4 VF configuration concentrates a port's DMA resources in the minimum number of VFs—1 per port with 4×4 ports in the station. For I/O virtualization applications, a 64 VF configuration provides a VF for each of up to 64 VMs running in the RCs above the up to 4 host ports in the station. Table 1 shows the number of queues, connections, and interrupt vectors available in each to be divided among the DMA VFs in each of the two supported VF configurations.

The DMA VF configuration is established after enumeration by the MCPU but prior to host boot, allowing the host to enumerate its VFs in the standard fashion. In systems where individual backplane/fabric slots may contain either a host or an I/O adapter, the configuration should allocate VFs for the downstream ports to allow the future hot plug of a host in their slots. Some systems may include I/O adapters or GPUs with which use can be made of DMA VFs in the downstream port to which the adapter is attached.

### DMA Transmit Engine

The DMA transmit engine may be modeled as a set of transmit queues (TxQs) for each VF, a single transmit completion queue (TxCQ) that receives completions to messages sent from all of the VF's TxQs, a Message Pusher state machine that tries to empty the TxQs by reading them so that the messages and descriptors in them may be forwarded across the fabric, a TxQ Arbiter that prioritizes the reading of the TxQs by the Message Pusher, a DMA doorbell mechanism that tracks TxQ depth, and a set of Tx Congestion avoidance mechanisms that shape traffic generated by the Transmit Engine.

### Transmit Queues

TxQs are Capella's equivalent of transmit descriptor rings. Each Transmit Queue, TxQ, is a circular buffer consisting of objects sized and aligned on 128B boundaries. There are 512 TxQs in a station mapped to ports and VFs per Table 1, as a function of the DMA VF configuration of the station. TxQs are a power of two in size, from 2⁹ to 2¹² objects aligned on a multiple of their size. Objects in a queue are either pull descriptors or short packet push message descriptors. Each queue is individually configurable as to depth. TxQs are managed via indexed access to the following registers defined in their VF's BARO memory mapped register space.

TABLE 2
TxQ Management Registers

| | Default | | | | | | |
|---|---|---|---|---|---|---|---|
| | Value | Attribute | Attribute | EEPROM | Reset | | |
| Offset | (hex) | (MCPU) | (Host) | Writable | Level | Register or Field Name | |
| 830h | | | | | | QUEUE_INDEX | Index (0 based entry number) |
| | | | | | | | for all index based read/write |
| | | | | | | | of queue/data structure |
| | | | | | | | parameters below this |
| | | | | | | | register; software writes this |
| | | | | | | | first before read/write of |
| | | | | | | | other index based registers |
| | | | | | | | below (TXQ, RXCQ, RDMA |
| | | | | | | | CONN) |
| [15:0] | | RW | RW | Yes | Level01 | | TXQ number for read/write |
| | | | | | | | of TXQ base address |
| [31:16] | | RsvdP | RsvdP | No | | Reserved | |
| 834h | | | | | | TXQ_BASE_ADDR_LOW | Low 32 bits of NIC TX |
| | | | | | | | queue base address |
| [2:0] | | RW | RW | Yes | Level01 | TxQ Size | size of TXQ0 in entries |
| | | | | | | | (power of 2 * 128) (0 = 128; |
| | | | | | | | 7 = 16k) |
| [3] | 1 | RW | RW | Yes | Level01 | TxQ Descriptor Size | Descriptor size (1 = 128 |
| | | | | | | | bytes) |
| [14:4] | | RsvdP | RsvdP | No | Level01 | Reserved | Reserved |
| [31:15] | | RW | RW | Yes | Level01 | TxQ Base Address Low | Low order bits of TXQ Base |
| | | | | | | | address |
| 838h | | | | | | TXQ_BASE_ADDR_HIGH | High 32 bits of NIC TX |
| | | | | | | | queue base address |
| [31:0] | | RW | RW | Yes | Level01 | | |
| 83Ch | | | | | | TXQ_HEAD | Hardware maintained TXQ |
| | | | | | | | head value (entry number of |
| | | | | | | | next entry) |
| [15:0] | | RW | RW | Yes | Level01 | | TXQ fifo entry index |
| [31:16] | | RsvdP | RsvdP | No | | Reserved | |

### DMA Doorbells

The driver enqueues a packet by writing it into host memory at the queue's base address plus TXQ_TAIL*size of each descriptor, where TXQ_TAIL is the tail pointer of the queue maintained by the driver software. TXQ_TAIL gets incremented after each enqueuing of a packet, to point to the next entry to be queued. Sometime after writing to the host memory, the driver does an indexed write to the TXQ_TAIL register array to point to the last object placed in that queue. The switch compares its internal TXQ_HEAD values to the TXQ_TAIL values in the array to determine the depth of each queue. The write to a TXQ_TAIL serves as a DMA doorbell, triggering the DMA engine to read the queue and transmit the work request message associated with the entry at its tail. TXQ_TAIL is one of the driver updated queue indices described in the table below.

All of the objects in a TxQ must be 128B in size and aligned on 128B boundaries, providing a good fit to the cache line size and RCBs of server class processors.

TABLE 3
Driver Updated Queue Indices

| | Default | | | | | | |
|---|---|---|---|---|---|---|---|
| | Value | Attribute | Attribute | EEPROM | Reset | Register or Field | |
| Offset | (hex) | (MCPU) | (Host) | Writable | Level | Name | Description |
| | | | | | | Driver updated | |
| | | | | | | queue indices | |
| Array | 512 | | | | | | |
| 1000h | | | | | | TXQ_TAIL | Software maintained TXQ tail value |
| [15:0] | 0 | RW | RW | Yes | Level01 | TXQ_TAIL | TXQ fifo entry index (0 based) |
| [31:16] | | RsvdP | RsvdP | No | Level0 | | |
| 1004h | | | | | | RXCQ_HEAD | Software maintained RXCQ head value |
| | | | | | | | (only the first 4 or 64 are used based on |
| | | | | | | | the DMA Config mode of 6 or 2; the rest |
| | | | | | | | of the RXCQ_HEAD entries are |
| | | | | | | | reserved) |
| [15:0] | 0 | RW | RW | Yes | Level01 | RXCQ_HEAD | RXCQ fifo entry index (0 based) |
| [31:16] | | RsvdP | RsvdP | No | Level0 | | |
| End | | | | | | | 1FFCh |

In the above Table 3, 1000h is the location for TXQ 0's TXQ_TAIL, 1008h is the location for TXQ 1's TXQ_TAIL and so on. Similarly, 1004h is the location for RXCQ 0's RXCQ_HEAD, 100Ch is the location for RXCQ 1's RXCQ_HEAD and so on.

### Message Pusher

Message pusher is the name given to the mechanism that reads work requests from the TxQs, changes the resulting read completions into ID-routed Vendor Defined Messages, adds the optional ECRC, if enabled, and then forwards the resulting work request vendor defined messages (WR VDMs) to their destinations. The Message Pusher reads the TxQs nominated by the DMA scheduler.

The DMAC maintains a head pointer for each TxQ. These are accessible to software via indexed access of the TxQ Management Register Block defined in Table 2. The Message Pusher reads a single aligned message/descriptor object at a time from the TxQ selected by a scheduling mechanism that considers fairness, priority, and traffic shaping to avoid creating congestion. When a PCIe read completion containing the TxQ message/descriptor object returns from the host/RC, the descriptor is morphed into one of the ID-routed Vendor Defined Message formats defined in the Host to Host DMA Descriptor Formats subsection for transmission. The term “object” is used for the contents of a TxQ because an entry can be either a complete short message or a descriptor of a long message to be pulled by the destination. In either case, the object is reformed into a VDM and sent to the destination. The transfer defined in a pull descriptor is executed by the destination's DMAC, which reads the message from the source memory using pointers in the descriptor. Short packet messages are written directly into a receive buffer in the destination host's memory by the destination DMA without need to read source memory.

### DMA Scheduling and Traffic Shaping

The TxQ arbiter selects the next TxQ from which a descriptor will be read and executed from among those queues that have backlog and are eligible to compete for service. The arbiter's policies are based upon QoS principles and interact with traffic shaping/congestion avoidance mechanisms documented below.

Each of the up to 512 TxQs in a station can be classified as high, medium, or low priority via the TxQ Control Register in its VF's BARO memory mapped register space, shown in Table below. Arbitration among these classes is by strict priority with ties broken by round robin.

The descriptors in a TxQ contain a traffic class (TC) label that will be used on all the Express Fabric traffic generated to execute the work request. The TC label in the descriptor should be consistent with the priority class of its TxQ. The TCs that the VF's driver is permitted to use are specified by the MCPU in a capability structure in the synthetic CSR space of the DMA VF. The fabric also classifies traffic as low, medium, or high priority but, depending on link width, separates it into 4 egress queues based on TC. There is always at least one high priority TC queue and one best efforts (low priority) queue. The remaining egress queues provide multiple medium priority TC queues with weighted arbitration among them. The arbitration guarantees a configurable minimum bandwidth to each queue and is work conserving.

Medium and low priority TxQs are eligible to compete for service only if their port hasn't consumed its bandwidth allocation, which is metered by a leaky bucket mechanism. High priority queues are excluded from this restriction based on the assumption and driver-enforced policy that there is only a small amount of high priority traffic.

The priority of a TxQ is configured by an indexed write to the TxQ Control Register in its VF's BARO memory mapped register space via the TXQ_Priority field of the register. The TxQ that is affected by such a write is the one pointed by the QUEUE_INDEX field of the register.

A TxQ must first be enabled by its TXQ Enable bit. It then can be paused/continued by toggling its TXQ Pause bit.

Each TxQ's leaky bucket is given a fractional link bandwidth share via the TxQ_Min_Fraction field of the TxQ control Register. A value of 1 in this register guarantees a TxQ at least 1/256 of its port's link BW. Every TxQ should be configured to have at least this minimum BW in order to prevent starvation.

TABLE 4
TxQ Control Register

| | Default | | | | | | |
|---|---|---|---|---|---|---|---|
| | Value | Attribute | Attribute | EEPROM | Reset | Register or Field | |
| Offset | (hex) | (MCPU) | (Host) | Writable | Level | Name | Description |
| | | | | | | DMA_MM_VF | Registers in the |
| | | | | | | | BAR0 of the VF |
| 830h | | | | | | QUEUE_INDEX | Index (0 based |
| | | | | | | | entry number) for |
| | | | | | | | all index based |
| | | | | | | | read/write of |
| | | | | | | | queue/data |
| | | | | | | | structure |
| | | | | | | | parameters below |
| | | | | | | | this register; |
| | | | | | | | software writes |
| | | | | | | | this first before |
| | | | | | | | read/write of |
| | | | | | | | other index based |
| | | | | | | | registers below |
| | | | | | | | (TXQ, RXCQ, |
| | | | | | | | RDMA CONN) |
| 900h | | | | | | TXQ_control | Index based |
| | | | | | | | TXQ control |
| | | | | | | | bits |
| [0] | 1 | RW | RW | Yes | Level01 | TXQ Enable | disable(0)/ |
| | | | | | | | enable (1) |
| [1] | 0 | RW | RW | Yes | Level01 | TXQ Pause | continue/pause |
| [7:2] | | RsvdP | RsvdP | No | Level0 | Reserved | Unused |
| [9:8] | 0 | RW | RW | Yes | Level01 | TXQ_Priority | Ingress priority |
| | | | | | | | per TXQ; 0 = |
| | | | | | | | Low, 1 = |
| | | | | | | | Medium; |
| | | | | | | | 2 = High; 3 = |
| | | | | | | | Reserved; |
| | | | | | | | Default: Low |
| [23:10] | 0 | RsvdP | RsvdP | No | Level0 | Reserved | |
| [31:24] | 0 | RW | RW | Yes | Level01 | TXQ_Min_Fraction | Minimum |
| | | | | | | | bandwidth for |
| | | | | | | | this TXQ as a |
| | | | | | | | fraction of total |
| | | | | | | | Link fraction |
| | | | | | | | for the port |

Each port is permitted a limited number of outstanding DMA work requests. A counter for each port is incremented when a descriptor is read from a TxQ and decremented when a TxCQ VDM for the resulting work request is returned. If the count is above a configurable threshold, the port's VF's are ineligible to compete for service. Thus, the threshold and count mechanism function as an end to end flow control.

This mechanism is controlled by the registers described in the table below. These registers are in the BARO space of each station's GEP and are accessible to the management software only. Note the “Port Index” field used to select the registers of one of the ports in the station for access and the “TxQ Index” field used to select an individual TxQ of the port. A single threshold limit is supported for each port but status can be reported on an individual queue basis.

To avoid deadlock, it's necessary that the values configured into the Work Request Thresholds not exceed the values defined below.
If there is only one host port configured in the station, the maximum values for each byte of reg 110h (Work Request Thresholds) are respectively 32′h50_{—}20_{—}5 e_{—}50
If multiple host ports are configured in the station, the maximum values for each byte of reg 110h are respectively 32′h80_{—}20_{—}90_{—}80

TABLE 5
DMA Work Request Threshold and Threshold Status Registers

| | Default | | | | | |
|---|---|---|---|---|---|---|
| | Value | Attribute | EEPROM | Reset | | |
| Offset | (hex) | (MCPU) | Writable | Level | Register or Field Name | Description |
| 110h | | | | | Work Request Thresholds | |
| [7:0] | 20 | RW | Yes | Level01 | Work Request Busy | When this outstanding work request |
| | | | | | Threshold | threshold is reached, a port will be |
| | | | | | | considered busy. |
| [15:8] | 28 | RW | Yes | Level01 | Work Request Max Threshold | This field specifies the maximum |
| | | | | | | number of work requests a port can |
| | | | | | | have outstanding. |
| [23:16] | 8 | RW | Yes | Level01 | Work Request Max per TxQ - | This field specifies the maximum |
| | | | | | Port Busy | number of work requests any one |
| | | | | | | TxQ that belongs to a port that is |
| | | | | | | considered busy can have outstanding. |
| [31:24] | 10 | RW | Yes | Level01 | Work Request Max per TxQ - | This field specifies the maximum |
| | | | | | Port Not Busy | number of work requests any one |
| | | | | | | TxQ that belongs to a port that is not |
| | | | | | | considered busy can have outstanding. |
| 114h | | | | | Work Request Threshold | |
| | | | | | Status | |
| [8:0] | 0 | RW | Yes | Level01 | TxQ Index | This field points to TxQ work request |
| | | | | | | outstanding count to read. |
| [11:9] | 0 | RsvdP | No | Level0 | Reserved | |
| [14:12] | 0 | RW | Yes | Level01 | Port Index | This field points to the port work |
| | | | | | | request outstanding count to read. |
| [15] | 0 | RsvdP | No | | Reserved | |
| [23:16] | 0 | RO | No | Level01 | TxQ Outstanding Work | This field returns the number of |
| | | | | | Requests | outstanding work requests for the |
| | | | | | | selected TxQ. |
| [31:24] | 0 | RO | No | Level01 | Port Outstanding Work | This field returns the number of |
| | | | | | Requests | outstanding work requests for the |
| | | | | | | selected port. |

A VF arbiter serves eligible VF's with backlog using a round-robin policy. After the VF selected, priority arbitration is performed among its TxQ's. Ties are resolved by round-robin among TxQs of the same priority level.

### Transmit Completion Queue

Completion messages are written by the DMAC into completion queues at source and destination nodes to signal message delivery or report an uncorrectable error, a security violation, or other failure. They are used to support error free and in-order delivery guarantees. Interrupts associated with completion queues are moderated on both a number of packets and a time basis.

A completion message is returned for each descriptor/message sent from a TxQ. Received transmit completion message payloads are enqueued in a single TxCQ for the VF in host memory. The transmit driver in the host dequeues the completion messages. If a completion message isn't received, the driver eventually notices. For a NIC mode transfer, the driver policy is to report the error and let the stack recover. For an RDMA message, the driver has options: it can retry original request, or can break the connection, forcing the application to initiate recovery; this choice depends on the type of RDMA operation attempted and the error code received.

Transmit completion messages are also used to flow control the message system. Each source DMA VF maintains a single TxCQ into which completion messages returned to it from any and all destinations and traffic classes are written. A TxCQ VDM is returned by the destination DMAC for every WR VDM it executes to allow the source to maintain its counts of outstanding work request messages and to allow the driver to free the associated transmit buffer and TxQ entry. Each transmit engine limits the number of open work request messages it has in total. Once the global limit has been reached, receipt of a transmit completion queue message, TxCQ VDM, is required before the port can send another WR VDM. Limiting the number of completion messages outstanding at the source provides a guarantee that a TxCQ won't be overrun and, equally importantly, that fabric queues can't saturate. It also reduces the source injection rate when the destination node's BW is being shared with other sources.

The contents and structure of the TxCQ VDM and queue entry are defined in the Transmit Completion Message subsection. TxCQs are managed using the following registers in the VF's BARO memory mapped space.

TABLE 6
TxCQ Management Registers

| | Default | | | | | | |
|---|---|---|---|---|---|---|---|
| | Value | Attribute | Attribute | EEPROM | Reset | | |
| Offset | (hex) | (MCPU) | (Host) | Writable | Level | Register or Field Name | Description |
| 818h | | | | | | TXCQ_BASE_ADDR_LOW | |
| [3:0] | 0 | RO | RO | Yes | Level01 | TxCQ Size | Size of TX completion |
| | | | | | | | queue in entries (power 2 * |
| | | | | | | | 256) (0 = 256; 15 = 8m) |
| [7:4] | 0 | RW | RW | Yes | Level01 | Interrupt Moderation Count | Interrupt moderation— |
| | | | | | | | Count (power of 2); 0—for |
| | | | | | | | every completion; 1—every |
| | | | | | | | 2, 2—every 4 . . . 15—every |
| | | | | | | | 32k entries |
| [11:8] | 0 | RW | RW | Yes | Level01 | Interrupt Moderation | Interrupt timer value in |
| | | | | | | Timeout | power of 2 microseconds; |
| | | | | | | | 0-1 microsecond, 1-2 |
| | | | | | | | microseconds and so on . . . ; |
| | | | | | | | timer reset after every |
| | | | | | | | TXCQ entry |
| [31:12] | 0 | RW | RW | Yes | Level01 | TxCQ Base Address Low | Low 32 bits of TX |
| | | | | | | | completion queue 0—zero |
| | | | | | | | extend for the last 12 bits |
| 81Ch | | | | | | TXCQ_BASE_ADDR_HIGH | |
| [31:0] | | RW | RW | Yes | Level01 | TxCQ Base Address High | High 32 bits of TX |
| | | | | | | | completion queue 0 base |
| | | | | | | | address |
| 828h | | | | | | TXCQ_HEAD | |
| [15:0] | | RW | RW | No | Level01 | | head (consumer |
| | | | | | | | index/entry number of |
| | | | | | | | TXCQ—updated by driver) |
| [31:16] | | RsvdP | RsvdP | | | Reserved | |
| 82Ch | | | | | | TXCQ_TAIL | |
| [15:0] | | RW | RW | Yes | Level01 | | tail (producer index/entry |
| | | | | | | | number of TXCQ—updated |
| | | | | | | | by hardware) |
| [31:16] | | RsvdP | RsvdP | No | | Reserved | |
| 830h | | | | | | QUEUE_INDEX | Index (0 based entry |
| | | | | | | | number) for all index based |
| | | | | | | | read/write of queue/data |
| | | | | | | | structure parameters |
| | | | | | | | below this register; |
| | | | | | | | software writes this first |
| | | | | | | | before read/write of other |
| | | | | | | | index based registers |
| | | | | | | | below (TXQ, RXCQ, |
| | | | | | | | RDMA CONN) |
| [15:0] | | RW | RW | Yes | Level01 | | TXQ number for read/write |
| | | | | | | | of TXQ base address |
| [31:16] | | RsvdP | RsvdP | No | | Reserved | |

### TC Usage for Host Memory Reads

The DMA engine reads host memory for a number of purposes, such as to fetch a descriptor from a TxQ using the TC configured for the queue in the TxQ Control Register, to complete a remote read request using the TC of the associated VDM, to fetch buffers from the RxQ using the TC specified in the Local Read Traffic Class Register, and to read the BTT when executing an RDMA transfer again using the TC specified in the Local Read Traffic Class Register. The Local Read Traffic Class Register appears in the GEP's BARO memory mapped register space and is defined in Table below.

TABLE 7
Local Read Traffic Class Register

| | Default | | | | | |
|---|---|---|---|---|---|---|
| | Value | Attribute | Attribute | EEPROM | | |
| Offset | (hex) | (MCPU) | (Host) | Writable | Register or Field Name | Description |
| 12Ch | | | | | Local Read Traffic Class | |
| [2:0] | 7 | RW | Yes | Level01 | Port 0 Local Read Traffic | This field selects the traffic class for |
| | | | | | Class | local reads of the RxQ or BTT |
| | | | | | | initiated by DMA from port 0. |
| [3] | 0 | RsvdP | No | | Reserved | |
| [6:4] | 7 | RW | Yes | Level01 | Port 1 Local Read Traffic | This field selects the traffic class for |
| | | | | | Class | local reads of the RxQ or BTT |
| | | | | | | initiated by DMA from port 1. |
| [7] | 0 | RsvdP | No | | Reserved | |
| [10:8] | 7 | RW | Yes | Level01 | Port 2 Local Read Traffic | This field selects the traffic class for |
| | | | | | Class | local reads of the RxQ or BTT |
| | | | | | | initiated by DMA from port 2. |
| [11] | 0 | RsvdP | No | | Reserved | |
| [14:12] | 7 | RW | Yes | Level01 | Port 3 Local Read Traffic | This field selects the traffic class for |
| | | | | | Class | local reads of the RxQ or BTT |
| | | | | | | initiated by DMA from port 3. |
| [15] | 0 | RsvdP | No | | Reserved | |
| [18:16] | 7 | RW | Yes | Level01 | Port 4/x1 Management | This field selects the traffic class for |
| | | | | | Port Local Read Traffic | local reads of the RxQ or BTT |
| | | | | | Class | initiated by DMA from port 4 or |
| | | | | | | from the x1 management port. |
| [31:19] | 0 | RsvdP | No | | Reserved | |

### DMA Destination Engine

The DMA destination engine receives and executes WR VDMs from other nodes. It may be modeled as a set of work request queues for incoming WR VDMs, a work request execution engine, a work request arbiter that feeds WR VDMs to the execution engine to be executed, a NIC Mode Receive Queue and Receive Descriptor Cache, and various scoreboards for managing open work requests and outstanding read requests (not visible at this level).

### DMA Work Request Queues

When a work request arrives at the destination DMA, the starting addresses in internal switch buffer memory of its header and payload are stored in a Work Request Queue. There are a total of 20 Work Request Queues per station. Four of the queues are dedicated to the MCPU x1 port. The remaining 16 queues are for the 4 potential host ports with each port getting four queues regardless of port configuration.

The queues are divided by traffic class per port. However, due to a bug in the initial silicon, all DMA TCs will be mapped into a single work request queue in each destination port. The Destination DMA controller will decode the Traffic Class at the interface and direct the data to the appropriate queue. Decoding the TC at the input is necessary to support the WRQ allocation based on port configuration. Work requests must be executed in order per TC. The queue structure will enforce the ordering (the source DMA controller and fabric routing rules ensure the work requests will arrive at the destination DMA controller in order).

Before a work request is processed, it must pass a number of checks designed to ensure that once execution of the work request is started, it will be able to complete. If any of these checks fail, a TxCQ VDM containing a Condition Code indicating the reason for the failure is generated and returned to the source. Table 27 RxCQ and TxCQ Completion Codes shows the failure conditions that are reported via the TxCQ.

### Work Request Queue TC and Port Arbitration

Each work request queue, WRQ, will be assigned either a high, medium0, medium1, or low priority level and arbitrated on a fixed priority basis. Higher priority queues will always win over lower priority queues except when a low priority queue is below its minimum guaranteed bandwidth allocation. Packets from different ingress ports that target the same egress queue are subject to port arbitration. Port arbitration uses a round robin policy in which all ingress ports have the same weight.

### NIC Mode Receive Queue and Receive Descriptor Cache

Each VF's single receive queue, RxQ, is a circular buffer of 64-bit pointers. Each pointer points to a 4 KB page into which received messages, other than tagged RDMA pull messages, are written. A VF's RxQ is configured via the following registers in its VF's BARO memory mapped register space.

TABLE 8
RxQ Configuration Registers

| | Default | | | | | | |
|---|---|---|---|---|---|---|---|
| | Value | Attribute | Attribute | EEPROM | Reset | | |
| Offset | (hex) | (MCPU) | (Host) | Writable | Level | Register or Field Name | Description |
| 810h | | | | | | RXQ_BASE_ADDR_LOW | Low 32 bits of NIC RX buffer |
| | | | | | | | descriptor queue base |
| | | | | | | | address |
| [3:0] | 0 | RW | RW | Yes | Level01 | RxQ Size | size of RXQ0 in entries |
| | | | | | | | (power of 2 * 256) (0 = |
| | | | | | | | 256; 15 = 8M) |
| [11:4] | 0 | RsvdP | RsvdP | No | | Reserved | Reserved |
| [31:12] | 0 | RW | RW | Yes | Level01 | RxQ Base Address Low | Low 32 bits of NIC RX buffer |
| | | | | | | | descriptor queue—zero |
| | | | | | | | extend for the last 12 bits |
| 814h | | | | | | RXQ_BASE_ADDR_HIGH | |
| [31:0] | | RW | RW | Yes | Level01 | RxQ Base Address High | High 32 bits of NIC RX buffer |
| | | | | | | | descriptor queue base |
| | | | | | | | address |

The NIC mode receive descriptor cache occupies a 1024×64 on-chip RAM. At startup, descriptors are prefetched to load 16 descriptors for each of the single RxQ's of the up to 64 VFs. Subsequently, whenever 8 descriptors have been consumed from a VF's cache, a read of 8 more descriptors is initiated.

### Receive Completion Queues (RxCQs)

A receive completion queue entry may be written upon execution of a received WR VDM. The RxCQ entry points to the buffer where the message was stored and conveys upper layer protocol information from the message header to the driver. Each DMA VF maintains multiple receive completion queues, RxCQs, selected by a hash of the Source Global ID (GID) and an RxCQ_hint field in the WR VDM in NIC mode, to support a proprietary Receive Side Scaling mechanism, RSS, which divides the receive processing workload over multiple CPU cores in the host.

The exact hash is:

$$\begin{matrix}( {RxCQ}_{—} hint & XOR & \\ SGID [ 7 \text{:} 0 ] & XOR & \\ SGID [ 15 \text{:} 8 ] ) & AND & MASK )\end{matrix}$$

where

MASK=(2̂(RxCQ Enable[3:0])−1), which picks up just enough of the low 1, 2, 3 . . . 8 bits of the XOR result to encode the number of enabled RxCQs. The RxCQ and GID or source ID may be used for load balancing.

In RDMA mode, an RxCQ is by default only written in case of an error. Writing of the RxCQ for a successful transfer is disabled by assertion of the NoRxCQ flag in the descriptor and message header. The RxCQ to be used for RDMA is specified in the Buffer Tag Table entry for cases where the NoRxCQ flag in the message header isn't asserted. The local completion queue writes are simply posted writes using circular pointers. The receive completion message write payloads are 20B in length and aligned on 32B boundaries. Receive completion messages and further protocol details are in the Receive Completion Message subsection.

A VF may use a maximum of from 4 to 64 RxCQs, per the VF configuration. The software may enable less than the maximum number of available RxCQs but the number enabled must be a power of two. As an example, if a VF can have a maximum of 64 RxCQs, software can enable 1/2/4/8/16/32/64 RxCQ. RxCQs are managed via indexed access to the following registers in the VF's BARO memory mapped register space.

TABLE 9
Receive Completion Queue Configuration Registers

| | Default | | | | | | |
|---|---|---|---|---|---|---|---|
| | Value | Attribute | Attribute | EEPROM | Reset | | |
| Offset | (hex) | (MCPU) | (Host) | Writable | Level | Register or Field Name | Description |
| 830h | | | | | | QUEUE_INDEX | Index (0 based entry |
| | | | | | | | number) for all index |
| | | | | | | | based read/write of |
| | | | | | | | queue/data structure |
| | | | | | | | parameters below this |
| | | | | | | | register; software writes |
| | | | | | | | this first before |
| | | | | | | | read/write of other index |
| | | | | | | | based registers below |
| | | | | | | | (TXQ, RXCQ, RDMA |
| | | | | | | | CONN) |
| 840h | | | | | | RXCQ_ENABLE | |
| [3:0] | | RW | RW | Yes | Level01 | Number of RxCQs to | Number of RxCQs to |
| | | | | | | Enable | enable for this VF |
| | | | | | | | expressed as a power of |
| | | | | | | | 2. A value of 0 enables 1 |
| | | | | | | | RxCQ, a value of 8 |
| | | | | | | | enables 256 RxCQs. |
| [31:4] | | RsvdP | RsvdP | No | | Reserved | |
| 844h | | | | | | RXCQ_BASE_ADDR_LOW | |
| [3:0] | 0 | RW | RW | Yes | Level01 | RxCQ Size | Size of queue in (power |
| | | | | | | | of 2 * 256) (0 = 256, |
| | | | | | | | 15 = 8M) |
| [7:4] | 0 | RW | RW | Yes | Level01 | RxCQ Interrupt | Interrupt moderation— |
| | | | | | | Moderation | Count (power of 2); 0— |
| | | | | | | | for every completion; 1— |
| | | | | | | | every 2, 2—every 4 . . . |
| | | | | | | | 15—every 32k entries |
| [11:8] | 0 | RW | RW | Yes | Level01 | Interrupt Moderation | Interrupt timer value in |
| | | | | | | Timeout | power of 2 |
| | | | | | | | microseconds; 0-1 |
| | | | | | | | microsecond, 1-2 |
| | | | | | | | microseconds and so |
| | | | | | | | on . . . ; timer reset after |
| | | | | | | | every RXCQ entry |
| [31:12] | 0 | RW | RW | Yes | Level01 | RxCQ Base Address Low | low order bits of RXCQ |
| | | | | | | | base address (zero |
| | | | | | | | extend last 12 bits) |
| 848h | | | | | | RXCQ_BASE_ADDR_HIGH | |
| [31:0] | | RW | RW | Yes | Level01 | | High order 32 bits of |
| | | | | | | | RXCQ base address |
| 84Ch | | | | | | RXCQ_TAIL | Hardware maintained |
| | | | | | | | RXCQ tail value (ientry |
| | | | | | | | number of next entry) |
| [15:0] | | RW | RW | No | Level01 | RxCQ Tail Pointer | tail (producer index of |
| | | | | | | | RxCQ—updated by |
| | | | | | | | hardware) |
| [31:16] | | RsvdP | RsvdP | No | Level0 | Reserved | Reserved |

### Destination DMA Bandwidth Management

In order to manage the link bandwidth utilization of the host port by message data pulled from a remote host, limitations are placed on the number of outstanding pull protocol remote read requests. A limit is also placed on the fraction of the link bandwidth that the remote reads are allowed to consume. This mechanism is managed via the registers defined in Table 1 below. A limit is placed on the total number of remote read request an entire port is allowed to have outstanding. Limits are also placed on the number of outstanding remote reads for each individual work request. Separate limits are used for this depending upon whether the port is considered to be busy. The intention is that a higher limit will be configured for use when the port isn't busy than when it is.

TABLE 10
Remote Read Outstanding Thresholds and Link Fraction Registers

| | Default | | | | | |
|---|---|---|---|---|---|---|
| | Value | Attribute | EEPROM | Reset | | |
| Offset | (hex) | (MCPU) | Writable | Level | Register or Field Name | Description |
| 148h | | | | | Remote Read Outstanding Thresholds | |
| [7:0] | 40 | RW | Yes | Leve101 | Port Busy Remote | This field specifies the number of |
| | | | | | Read Threshold | outstanding remote reads to be |
| | | | | | | considered busy. |
| [15:8] | 80 | RW | Yes | Level01 | Port Remote Read | This is the maximum number of |
| | | | | | Max Threshold | remote reads a port can have |
| | | | | | | outstanding. |
| [23:16] | 20 | RW | Yes | Level01 | Remote Read Max per | This field specifies the maximum |
| | | | | | Work Request - Port | number of remote reads a single |
| | | | | | Busy | work request can have outstanding |
| | | | | | | when its port is busy. |
| [31:24] | 40 | RW | Yes | Level01 | Remote Read Max per | This field specifies the maximum |
| | | | | | Work Request-Port | number of remote reads a single |
| | | | | | Not Busy | work request can have outstanding |
| | | | | | | when its port is not busy. |
| 14Ch | | | | | Remote Read Rate Limit Thresholds | |
| [15:0] | 0 | RW | Yes | Level01 | Remote Read Low | Low priority remote reads will not be |
| | | | | | Priority Thresold | submitted once the value of the |
| | | | | | | Remote Read DWord counter passes |
| | | | | | | this threshold. If bit 15 of this field is |
| | | | | | | set, then the threshold value is a |
| | | | | | | negative number. |
| [31:16] | 0 | RW | Yes | Level01 | Remote Read Medium | Medium priority remote reads will not |
| | | | | | Priority Threshold | be submitted once the value of the |
| | | | | | | Remote Read DWord counter passes |
| | | | | | | this threshold. If bit 15 of this field is |
| | | | | | | set, then the threshold value is a |
| | | | | | | negative number. |
| 150h | | | | | Remote Read Link Fraction | |
| [7:0] | 0 | RW | Yes | Level01 | Link Bandwidth | The fraction of link bandwidth DMA is |
| | | | | | Fraction | allowed to utilize. A value of 0 in this |
| | | | | | | field disables the destination rate |
| | | | | | | limiting function. |
| [10:8] | 0 | RW | Yes | Level01 | Port Index | This field selects the port to apply the |
| | | | | | | remote read Thresholds and Link |
| | | | | | | Fraction to. |
| [30:11] | 0 | RsvdP | No | Level01 | Reserved | |
| [31] | 0 | RW | Yes | Level01 | Link Bandwidth | When this bit is written with 1, the |
| | | | | | Fraction Write Enable | Link Fraction field is also writable. |
| | | | | | | Otherwise the Link Fraction field is |
| | | | | | | read only. This field always returns 0 |
| | | | | | | when read. |

### DMA Interrupts

DMA interrupts are associated with TxCQ writes, RxCQ writes and DMA error events. An interrupt will be asserted following a completion queue write (which follows completion of the associated data transfer) if the IntNow field is set in the work request descriptor and the interrupt isn't masked. If the IntNow field is zero, then the interrupt moderation logic determines whether an interrupt is sent. Error event interrupts are not moderated.

Two fields in the TxCQ and RxCQ low base address registers described earlier define the interrupt moderation policy:
Interrupt Moderation—Count[3:0]
   Interrupt moderation—Count (power of 2);
      0—for every completion;
      1—every 2,
      2—every 4
      . . .
      15—every 32 k entries
Interrupt Moderation—Timeout[3:0]
   Interrupt timer value in power of 2 microseconds; 0-1 microsecond, 1-2 microseconds and so on . . . ;

Interrupt moderation count defines the number of completion queue writes that have to occur before causing an interrupt. If the field is zero, an interrupt is generated for every completion queue write. Interrupt moderation timeout is the amount of time to wait before generating an interrupt for completion queue writes. The paired count and timer values are reset after each interrupt assertion based on either value.

The two moderation policies work together. For example, if the moderation count is 16 and the timeout is set to 2 us and the time elapsed between 5 and 6^{th} completion passes 2 μs, an interrupt will be generated due to the interrupt moderation timeout. Likewise, using the same moderation setup, if 16 writes to the completion queues happen without exceeding the time limit between any 2 packets, an interrupt will be generated due to the count moderation policy.

The interrupt moderation fields are 4 bits wide each and specify a power of 2. So an entry of 2 in the count field specifies a moderation count of 4. If either field is zero, then there is no moderation policy for that function.

### DMA VF Interrupt Control Registers

DMA VF Interrupts are controlled by the following registers in the VF's BARO memory mapped register space. The QUEUE_INDEX applies to writes to the RxCQ Interrupt Control array.

For all DMA VF configurations:
MSI-X Vector 0 is for common/general error interrupt (including Link status change)
MSI-X Vector 1 is for TxCQ
MSI-X Vector 2 to (n+2) is for RxCQ (0 to n)

Software can enable as many MSI-X vectors as needed for handling RxCQ vectors (a power of 2 vectors). For example, in a system that has 4 CPU cores, it may be enough to have just 4 MSI-X vectors, one per core, for handling receive interrupts. For this case, software can enable 2+4=6 MSI-X vectors and assign MSI-X vectors 2-5 to each core using CPU Affinity masks provided by operating systems. The register RXCQ_VECTOR (0x868h) described below allows mapping of a RXCQ to a specific MSI-X vector.

The table below shows the device specific interrupt masks for the DMA VF interrupts.

TABLE 11
DMA VF Interrupt Control Registers

| | Default | | | | | | |
|---|---|---|---|---|---|---|---|
| | Value | Attribute | Attribute | EEPROM | Reset | | |
| Offset | (hex) | (MCPU) | (Host) | Writable | Level | Register or Field Name | Description |
| 830h | | | | | | QUEUE_INDEX | Index (0 based entry number) for |
| | | | | | | | all index based read/write of |
| | | | | | | | queue/data structure parameters |
| | | | | | | | below this register; software |
| | | | | | | | writes this first before read/write |
| | | | | | | | of other index based registers |
| | | | | | | | below (TXQ, RXCQ, RDMA |
| | | | | | | | CONN) |
| 864h | | | | | | RXCQ_Vector | RXCQ to MSI-X Vector Mapping |
| | | | | | | | (use with the QUEUE_INDEX |
| | | | | | | | REGISTER) |
| [8:0] | 0 | RW | RW | Yes | Level01 | RXCQ_Vector | MSI-X Vector number for RXCQ |
| [31:9] | 0 | RsvdP | RsvdP | No | Level0 | | |
| 904h | | | | | | Interrupt_Vector0_Mask | |
| [0] | 1 | RW | RW | Yes | Level01 | Vector 0 global interrupt | Set to 1 if MSI-X Vector 0— |
| | | | | | | mask | general/error interrupt to be |
| | | | | | | | disabled-by Host software |
| [31:1] | 0 | RsvdP | RsvdP | No | Level0 | Reserved | Can be used for further classify |
| | | | | | | | Interrupt 0/general/error interrupt |
| 908h | | | | | | TxCQ_Interrupt_Mask | |
| [0] | 1 | RW | RW | Yes | Level01 | Vector 0 global interrupt | Set to 1 if TXCQ interrupt is to be |
| | | | | | | mask | disabled; (writen by host |
| | | | | | | | software); default—interrupt |
| | | | | | | | disabled |
| [31:1] | 0 | RsvdP | RsvdP | No | Level0 | Reserved | |
| Array | 64 | | | | | | |
| A00h | | | | | | RXCQ Interrupt Control | Each DWORD contains bits for 4 |
| | | | | | | | RXCQs—the total number for one |
| | | | | | | | VF in 64 VF configuration. If the |
| | | | | | | | VF has more, VF has to calculate |
| | | | | | | | the DWORD based on the RXCQ |
| | | | | | | | number |
| [3:0] | 0 | RW | RW | No | Level01 | RxCQ Interrupt Enable | 1 bit per RXCQ; write 1 to enable |
| | | | | | | | interrupt; default: all interrupts |
| | | | | | | | disabled |
| [7:4] | 0 | RsvdP | RsvdP | No | Level0 | Reserved | |
| [11:8] | F | RW | RW | Yes | Level01 | RxCQ Interrupt Disable | 1 bit per RXCQ; write 1 to disable |
| | | | | | | | interrupt; default: all interrupts |
| | | | | | | | disabled |
| [31-12] | 0 | RsvdP | RsvdP | No | Level0 | | |
| End | | | | | | | AFCh |

### DMA VF MSI-X Interrupt Vector Table and PBA Array

MSI-X capability structures are implemented in the synthetic configuration space of each DMA VF. The MSI-X vectors and the PBA array pointed to by those capability structures are located in the VF's BARO space, as defined by the table below. While the following definition defines 258 MSI-X vectors, the number of vectors and entries in the PBA array are as per the DMA configuration mode: Only 6 vectors per VF for mode 6 and only 66 vectors per VF for mode 2. The MSI-X Capability structure will show the correct number of MSI-X vectors supported per VF based on the DMA configuration mode.

TABLE 12
DMA VF MSI-X Interrupt Vector Table and PBA Array

| | Default | | | | | | |
|---|---|---|---|---|---|---|---|
| | Value | Attribute | Attribute | EEPROM | Reset | Register or Field | |
| Offset | (hex) | (MCPU) | (Host) | Writable | Level | Name | Description |
| | | | | | | MSI-X Vector Table | 64x6 vectors supported per |
| | | | | | | | station (RAM space) |
| | | | | | | | 4 functions = 66 vectors |
| | | | | | | | (DMA config mode 2) |
| | | | | | | | or 64 func --> 6 vectors |
| | | | | | | | (DMA config Mode 6) |
| Array | 258 | 1 | 1 | | | | |
| 2000h | | | | | | Vector_Addr_Low | |
| [1:0] | 0 | RsvdP | RsvdP | No | Level0 | Reserved | |
| [31:2] | 0 | RW | RW | Yes | Level01 | Vector_Addr_Low | |
| 2004h | | | | | | Vector_Addr_High | |
| [31:0] | 0 | RW | RW | Yes | Level01 | Vector_Addr_High | |
| 2008h | | | | | | Vector_Data | |
| [31:0] | 0 | RW | RW | Yes | Level01 | Vector_Data | |
| 200Ch | | | | | | Vector_Ctrl | |
| [0] | 1 | RW | RW | Yes | Level01 | Vector_Mask | |
| [31:1] | 0 | RsvdP | RsvdP | No | Level0 | Reserved | |
| End | | | | | | | 301Ch |
| | | | | | | MSI-X PBA Table | optional in the hardware |
| 3800h | | | | | | PBA_0_31 | |
| [31:0] | 0 | RO | RO | No | Level01 | PBA_0_31 | Pending Bit Array |
| 3804h | | | | | | PBA_32_63 | |
| [31:0] | 0 | RO | RO | No | Level01 | PBA_32_63 | Pending Bit Array |
| 3808h | | | | | | PBA_64_95 | |
| [31:0] | 0 | RO | RO | No | Level01 | PBA_64_95 | Pending Bit Array |

### Miscellaneous DMA VF Control Registers

These registers are in the VF's BARO memory mapped space. The first part of the table below shows configuration space registers that are memory mapped for direct access by the host. The remainder of the table details some device specific registers that didn't fit in prior subsections.

TABLE 13
DMA VF Memory Mapped CSR Header Registers

| | Default | | | | | | |
|---|---|---|---|---|---|---|---|
| | Value | Attribute | Attribute | EEPROM | Reset | | |
| Offset | (hex) | (MCPU) | (Host) | Writable | Level | Register or Field Name | Description |
| | Structure | | | | | Per DMA VF Memory Mapped | |
| 0h | | | | | | Reserved | |
| 4h | | | | | | PCI Command | RO for Host and RW |
| | | | | | | | for MCPU |
| [0] | 0 | RO | RO | No | Level01 | IO Access Enable | |
| [1] | 0 | RW | RO | Yes | Level01 | Memory Access Enable | |
| [2] | 0 | RW | RO | Yes | Level01 | Bus Master Enable | |
| [3] | 0 | RsvdP | RsvdP | No | Level0 | Special Cycle | |
| [4] | 0 | RsvdP | RsvdP | No | Level0 | Memory Write and Invalidate | |
| [5] | 0 | RsvdP | RsvdP | No | Level0 | VGA Palette Snoop | |
| [6] | 0 | RW | RO | Yes | Level01 | Parity Error Response | |
| [7] | 0 | RsvdP | RsvdP | No | Level0 | IDSEL Stepping or Write Cycle | |
| | | | | | | Control | |
| [8] | 0 | RW | RO | Yes | Level01 | SERRn Enable | |
| [9] | 0 | RsvdP | RsvdP | No | Level0 | Fast Back to Back Transactions | |
| | | | | | | Enable | |
| [10] | 0 | RW | RO | Yes | Level01 | Interrupt Disable | |
| [15:11] | 0 | RsvdP | RsvdP | No | Level0 | Reserved | |
| 6h | | | | | | PCI Status | RO for Host and RW |
| | | | | | | | for MCPU |
| [2:0] | 0 | RsvdP | RsvdP | No | Level0 | Reserved | |
| [3] | 0 | RO | RO | No | Level01 | Interrupt Status | |
| [4] | 1 | RO | RO | Yes | Level01 | Capability List | |
| [5] | 0 | RsvdP | RsvdP | No | Level0 | 66 Mhz Capable | |
| [6] | 0 | RsvdP | RsvdP | No | Level0 | User Definable Functions | |
| [7] | 0 | RsvdP | RsvdP | No | Level0 | Fast Back to Back Transactions | |
| | | | | | | Capable | |
| [8] | 0 | RW1C | RO | No | Level01 | Master Data Parity Error | Need to inform this |
| | | | | | | | error to MCPU |
| [10:9] | 0 | RsvdP | RsvdP | No | Level0 | DEVSELn Timing | |
| [11] | 0 | RW1C | RO | No | Level01 | Signal Target Abort | |
| [12] | 0 | RsvdP | RsvdP | No | Level0 | Received Target Abort | Need to inform this |
| | | | | | | | error to MCPU |
| [13] | 0 | RsvdP | RsvdP | No | Level0 | Received Master Abort | Need to inform this |
| | | | | | | | error to MCPU |
| [14] | 0 | RW1C | RO | No | Level01 | Signaled System Error | Need to inform this |
| | | | | | | | error to MCPU |
| [15] | 0 | RW1C | RO | No | Level01 | Detected Parity Error | Need to inform this |
| | | | | | | | error to MCPU |
| | Structure | | | | | PCI Power Management | Emulated by MCPU |
| 40h | | | | | | PCI Power Management | |
| | | | | | | Capability Register | |
| [31:0] | 0 | RsvdP | RsvdP | No | Level0 | Reserved | |
| 44h | | | | | | PCI Power Management Control | Emulated by MCPU |
| | | | | | | and Status Register | |
| [31:0] | 0 | RsvdP | RsvdP | No | Level0 | Reserved | |
| 4Ah | | | | | | MSI_X Control Register | RO for Host and RW |
| | | | | | | | for MCPU |
| [10:0] | 5 | RO | RO | No | Level0 | MSI_X Table Size | The default value = |
| | | | | | | | (number of RxCQs in a |
| | | | | | | | VF) +1 |
| [13:11] | 0 | RsvdP | RsvdP | No | Level0 | Reserved | |
| [14] | 0 | RW | RO | Yes | Level01 | MSI_X Function Mask | |
| [15] | 0 | RW | RO | Yes | Level01 | MSI_X Enable | |
| 70h | | | | | | Device Control Register | RO for Host and RW |
| | | | | | | | for MCPU |
| [0] | 0 | RW | RO | Yes | Level01 | Correctable Error Reporting | |
| | | | | | | Enable | |
| [1] | 0 | RW | RO | Yes | Level01 | Non Fatal Error Reporting | |
| | | | | | | Enable | |
| [2] | 0 | RW | RO | Yes | Level01 | Fatal Error Reporting Enable | |
| [3] | 0 | RW | RO | Yes | Level01 | Unsupported Request Reporting | |
| | | | | | | Enable | |
| [4] | 1 | RW | RO | Yes | Level01 | Enable Relaxed Ordering | |
| [7:5] | 0 | RW | RO | Yes | Level01 | Max Payload Size | |
| [8] | 0 | RsvdP | RsvdP | No | Level0 | Extended Tag Field | |
| [9] | 0 | RsvdP | RsvdP | No | Level0 | Phantom Functions Enable | |
| [10] | 0 | RsvdP | RsvdP | No | Level0 | AUX Power PM Enable | |
| [11] | 1 | RW | RO | Yes | Level01 | Enable No Snoop | |
| [14:12] | 0 | RsvdP | RsvdP | No | Level0 | Max Read Request Size | |
| [15] | 0 | RsvdP | RsvdP | No | Level0 | Reserved | |
| 72h | | | | | | Device Status Register | RO for Host and RW |
| | | | | | | | for MCPU |
| [0] | 0 | RW1C | RO | No | Level01 | Correctable Error Detected | |
| [1] | 0 | RW1C | RO | No | Level01 | Non Fatal Error Detected | |
| [2] | 0 | RW1C | RO | No | Level01 | Fatal Error Detected | |
| [3] | 0 | RW1C | RO | No | Level01 | Unsupported Request Detected | |
| [4] | 0 | RsvdP | RsvdP | No | Level0 | AUX Power Detected | |
| [5] | 0 | RsvdP | RsvdP | No | Level0 | Transactions Pending | |
| [15:6] | 0 | RsvdP | RsvdP | No | Level0 | Reserved | |
| 90h | | | | | | Device Control 2 | RO for Host and RW |
| | | | | | | | for MCPU |
| [3:0] | 0 | RW | RO | Yes | Level01 | Completion Timeout Value | |
| [4] | 0 | RW | RO | Yes | Level01 | Completion Timeout Disable | |
| [5] | 0 | RsvdP | RsvdP | No | Level0 | ARI Forwarding Enable | |
| [6] | 0 | RW | RO | No | Level01 | Atomic Requester Enable | |
| [7] | 0 | RsvdP | RsvdP | No | Level0 | Atomic Egress Blocking | |
| [15:8] | 0 | RsvdP | RsvdP | No | Level0 | Reserved | |
| | | | | | | | Description |
| 868h | | | | | | DMA_FUN_CTRL_STATUS | |
| [0] | 0 | RW | RW | No | Level01 | DMA_Status_Fun_Enable | 0—disabled; 1— |
| | | | | | | | enabled |
| [1] | 0 | RW | RW | No | Level01 | DMA_Status_Pause | Error interrupt |
| | | | | | | | enable/disable |
| [2] | 0 | RW1C | RW1C | No | Level01 | DMA_Status_Idle | Set by hardware if |
| | | | | | | | DMA has nothing to do, |
| | | | | | | | but initialized and |
| | | | | | | | ready |
| [3] | 0 | RO | RO | No | Level01 | DMA_Status_Reset_Pending | Write one to Abort |
| | | | | | | | DMA Engine |
| [4] | 0 | RW1C | RW1C | No | Level01 | DMA_Status_Reset_Complete | Write one to pause |
| | | | | | | | DMA engine |
| [5] | 0 | RO | RO | No | Level01 | DMA_Status_Trans_pending | |
| [13:6] | 0 | RsvdP | RsvdP | No | Level0 | | |
| [15:14] | 0 | RW | RO | No | Level0 | DMA_Status_Log_Link | RW for MCPU, RO for |
| | | | | | | | host; SOFTWARE |
| | | | | | | | ONLY; Hardware |
| | | | | | | | ignores this bit;:Logical |
| | | | | | | | link status: 1—link |
| | | | | | | | down; 2—link up |
| | | | | | | | MCPU writes this |
| | | | | | | | status; host can only |
| | | | | | | | read |
| [16] | 0 | RW | RW | Yes | Level01 | DMA_Ctrl_Fun_Enable | 0—disable DMA, |
| | | | | | | | 1—Enable DMA |
| [17] | 0 | RW | RW | Yes | Level01 | DMA_Ctrl_ Pause | function 0—continue; |
| | | | | | | | 1—(graceful) pause |
| | | | | | | | DMA operations |
| [18] | 0 | RW | RW | Yes | Level01 | DMA_Ctrl_FLR | Function reset for DMA |
| [31:19] | 0 | RsvdP | RsvdP | No | Level0 | Reserved | |
| 86Ch | | | | | | DMA_FUN_GID | MCPU sets the GID on |
| | | | | | | | init (or hardware |
| | | | | | | | generates it????) |
| [23:0] | 0 | RO | RO | | | GID of this DMA function | |
| [31:24] | | RsvdP | RsvdP | No | Level0 | | |
| 8F0h | | | | | | VPFID_CONFIG | VPFID_Configuration |
| | | | | | | | set by MCPU |
| [5:0] | 1 | RO | RO | | | DEF_VPFID | Default VPFID to use |
| [30:6] | 0 | RsvdP | RsvdP | No | Level0 | Reserved | |
| [31] | 1 | RO | RO | | | HW_VPFID_OVERRIDE | Hardware override for |
| | | | | | | | VPFID enforcement |
| | | | | | | | (only for Single Static |
| | | | | | | | VPFID Mode of fabric; |
| | | | | | | | if multiple VPFIDs are |
| | | | | | | | used, then this is not |
| | | | | | | | set) |

### Protocol Overview by Means of Ladder Diagrams

Here the basic NIC and RDMA mode write and read operations are described by means of ladder diagrams. Descriptor and message formats are documented in subsequent subsections.

### Short Packet Push Transfer

Short packet push (SPP) transfers are used to push messages or message segments less than or equal to 116B in length across the fabric embedded in a work request vendor defined message (WR VDM). Longer messages may be segmented into multiple SPPs. Spreadsheet calculation of protocol efficiency shows a clear benefit for pushing messages up to 232B in payload length. Potential congestion from an excess of push traffic argues against doing this for longer messages except when low latency is judged to be critical. Driver software chooses the length boundary between use of push or pull semantics on a packet by packet basis and can adapt the threshold in reaction to congestion feedback in TxCQ messages. A pull completion message may include congestion feedback.

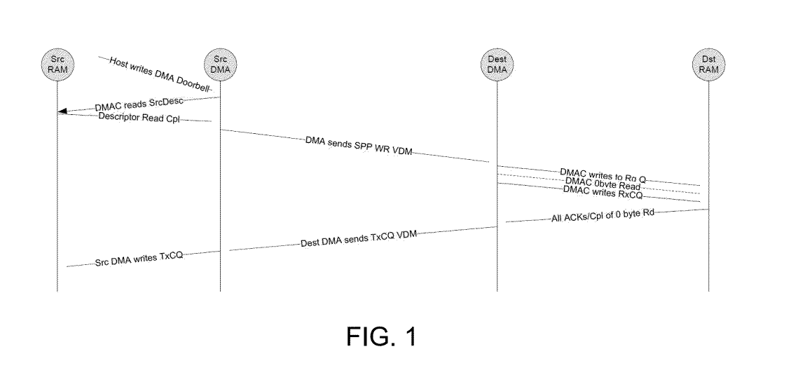

A ladder diagram for the short packet push transfer is shown in FIG. 1. The process begins when the Tx driver in the host copies the descriptor/message onto a TxQ and then writes to the queue's doorbell location. The doorbell write triggers the DMA transmit engine to read the descriptor from the TxQ. When the requested descriptor returns to the switch in form of a read completion, the switch morphs it into a SPP WR VDM and forwards it. The SPP WR VDM then ID-routes through the fabric and into a work request queue at the destination DMAC. When the SPP WR VDM bubbles to the head of its work request queue, the DMAC writes it's message payload into an Rx buffer pointed to by the next RxQ entry. After writing the message payload, the DMA writes the RxCQ. Upon receipt of the PCIe ACK to the last write and for the completion to the zero byte read, if enabled, the DMAC sends a TxCQ VDM back to the source host.

The ladder diagram assumes an Rx Q descriptor has been prefetched and is already present in the switch when the SPP WR VDM arrives and bubbles to the top of the incoming work request queue.

### NIC Mode Write Transfer Using Pull

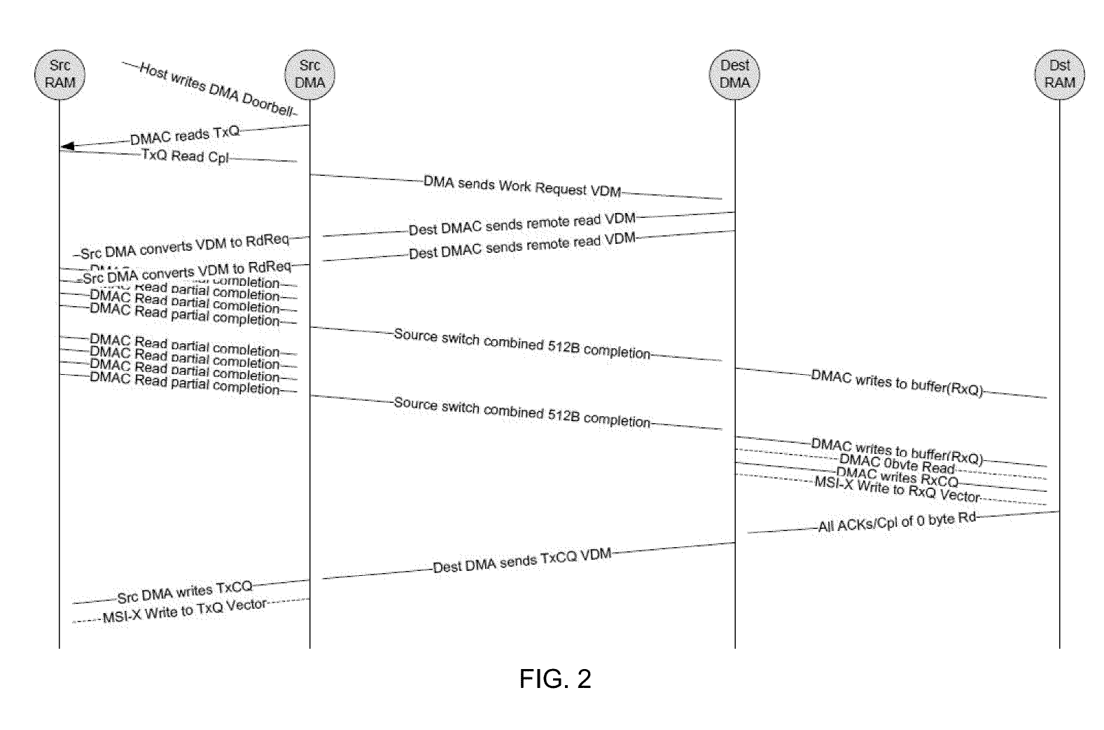

A ladder diagram for the NIC mode write pull transfer is shown in FIG. 2. The process begins when the Tx driver creates a descriptor, places the descriptor on a TxQ and then writes to the DMA doorbell for that queue. The doorbell write triggers the Tx Engine to read the TxQ. When the descriptor returns to the switch in the completion to the TxQ read, it is morphed into a NIC pull WR VDM and forwarded to the destination DMA VF. When it bubbles to the top of the target DMA's incoming work request queue, the DMA begins a series of remote reads to pull the data specified in the WR VDM from the source memory.

The pull transfer WR VDM is a gather list with up to 10 pointers and associated lengths as specified in the Pull Mode Descriptors subsection. For each pointer in the gather list, the DMA engine sends an initial remote read request of up to 64B to align to the nearest 64B boundary. From this 64B boundary, all subsequent remote reads generated by the same work request will be 64 byte aligned. Reads will not cross a 4 KB boundary. If and when the read address is already 64 byte aligned and greater than or equal to 512B from a 4 KB boundary, the maximum read request size—512B—will be issued. In NIC mode, pointers may start and end on arbitrary byte boundaries.

Partial completions to the remote read requests are combined into a single completion at the source switch. The destination DMAC then receives a single completion to each 512B or smaller remote read request. Each such completion is written into destination memory at the address specified in the next entry of the target VF's Rx Q but at an offset within the receive buffer of up to 511B. The offset used is the offset of the pull transfer pointer's starting address from the nearest 512B boundary. This offset is passed to the receive driver in the RxCQ message. When the very last completion has been written, the destination DMA engine then sends the optional ZBR, if enabled, and writes to the RxCQ, if enabled. After the last ACK for the data writes and the completion to the ZBR have been received, the DMA engine sends a TxCQ VDM back to the source DMA. The source DMA engine then writes the TxCQ message from the VDM onto the source VF's TxQ.

Transmit and receive interrupts follow their respective completion queue writes, if not masked off or inhibited by the interrupt moderation logic.

### Zero Byte Read

In PCIe, receipt of the DLLP ACK for the read completion message writes into destination memory signals that the component above the switch, the RC in the usage model, has received the writes without error. If the last write is followed by a 0-byte read (ZBR) of the last address written, then the receipt of the completion for this read signals that the writes (which don't use relaxed ordering) have been pushed through to memory. The ACK and the optional zero byte read are used in our host to host protocol guarantee delivery not just to the destination DMAC but to the RC and, if ZBR is used, to the target memory in the RC.

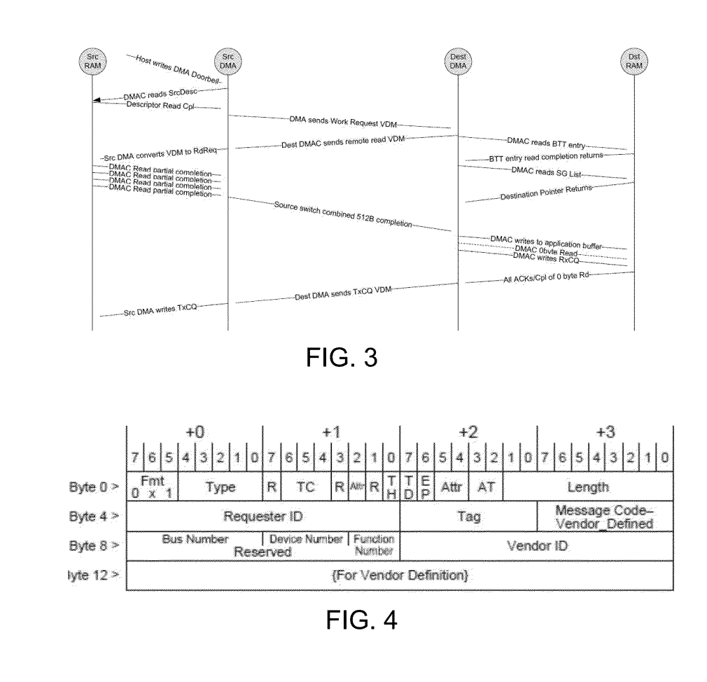

As shown in the ladder of FIG. 2 and FIG. 3, the DMAC waits for receipt of the ACK of a message's last write, which implies all prior writes succeeded, and, if it is enabled, for the completion to the optional 0-byte read, before returning a Tx CQ VDM to the source node. Completion of the optional zero byte read (ZBR) may take significantly longer than the ACK if the write has to, for example, cross a QPI link in the chip set to reach the memory controller. To allow its use selectively to minimize this potential latency impact, ZBR is enabled by a flag bit in the message descriptor and WR VDM.

The receive completion queue write, on the other hand, doesn't need to wait for the ACK because the PCIe DLL protocol ensures that if the data writes don't complete successfully, the completion queue write won't be allowed to move forward. Where the delivery guarantee isn't needed, there is some advantage to returning the TxCQ VDM at the same time that the receive completion queue is written but as yet, no mechanism has been specified for making this optional.

### RDMA Write Transfer Using Pull

FIG. 3 shows the PCIe transfers involved in transferring a message via the RDMA write pull transfer. The messaging process starts when the Tx driver in the source host places an RDMA WR descriptor onto a TxQ and then writes to the DMA doorbell to trigger a read of that queue. Each read of a TxQ returns a single WR descriptor sized and aligned on a 128B boundary. The payload of a descriptor read completion is morphed by the switch into an RDMA WR VDM and ID routed across the fabric to the switch containing its destination DMA VF where it is stored in a Work Request queue until its turn for execution.

If the WR is an RDMA (untagged) short packet push, then the short message (up to 108B for 128B descriptor) is written directly to the destination. For the longer pull transfer, the bytes used for a short packet push message in the WR VDM and descriptor are replaced by a gather list of up to 10 pointers to the message in the source host's memory. For RDMA transfers, each pointer in the gather list, except for the first and last must be an integral multiple of 4 KB in length, up to 64 KB. The first pointer may start anywhere but must end on a 4 KB boundary. The last pointer must start on a 4 KB boundary but may end anywhere. An RDMA operation represents one application message and so, the message data represented by the pointers in an RDMA Write WR is contiguous in the application's virtual address space. It may be scattered in the physical/bus address space and so each pointer in the physical/bus address list will be page aligned as per the system page size.

If, as shown in the figure, the WR VDM contains a pull request, then the destination DMA VF sends potentially many 512B remote read request VDMs back to the source node using the physical address pointers contained in the original WR, as well as shorter read requests to deal with alignment and 4 KB boundaries. Partial completions to the 512B remote read requests are combined at the source node, the one from which data is being pulled, and are sent across the fabric as single standard PCIe 512B completion TLPs. When these completions reach the destination node, their payloads are written to destination host memory.

For NIC mode, the switch maintains a cache of receive buffer pointers prefetched from each VF's receive queue (RxQ) and simply uses the next buffer in the FIFO cache for the target VF. For the RDMA transfer shown in the figure, the destination buffer is found by indexing the VF's Buffer Tag Table (BTT) with the Buffer Tag in the WR VDM. The read of the BTT is initiated at the same time as the remote read request and thus its latency is masked by that of the remote read. In some cases, two reads of host memory are required to resolve the address—one to get the security parameters and the starting address of a linked list and a second that indexes into the linked list to get destination page addresses.

For the transfer to be allowed to complete, the following fields in both the WR VDM and the BTT entry must match:
Source GRID (optional, enabled/disabled by flag in BTT entry)
Security Key
VPF ID
Read Enable and Write Enable permission flags in the BTT entry

In addition, the SEQ in the WR VDM must match the expected SEQ stored in an RDMA Connection Table in the switch. The read of the local BTT is overlapped with the remote read of the data and thus its latency is masked. If any of the security checks fail, any data already read or requested is dropped, no further reads are initiated, and the transfer is completed with a completion code indicating security check failure. The RDMA connection is then broken so no further transfers are accepted in the same connection.

After the data transfer is complete, both source and destination hosts are notified via writes into completion queues. The write to the RxCQ is enabled by a flag in the descriptor and WR VDM and by default is omitted in RDMA. Additional RDMA protocol details are in the RDMA Layer subsection.

### MCPU DMA Resources

A separate DMA function is implemented for use by the MCPU and configured/controlled via the following registers in the GEP BARO per station memory mapped space.

The following table summarizes the differences between MCPU DMA and a host port DMA as implemented in the current version of hardware (these differences may be eliminated in a future version):

| | | | Host port DMA |
|---|---|---|---|
| | Feature | MCPU DMA | (DMA VF) |
| 1 | Number of | Only 1 TXQ and 1 RXCQ | Number of DMA |
| | queues | per GEP (chip); a multi- | functions and the |
| | | switch fabric contains | number of queues/ |
| | | several GEPs - one per | function depend |
| | | switch and so the | on the DMA |
| | | MCPU DMA software has | Configuration mode |
| | | to manage all the GEPs | (2 - HPC, or 6 - IOV |
| | | as a single MCPU DMA. | modes). |
| 2 | Interrupts | Part of the GEP and | DMA is a separate |
| | | there are only 3 | function and has its |
| | | interrupts for DMA | own MSI-X vector space |
| | | (General/TXCQ/RXCQ); | in its BAR0. Number of |
| | | shares the MSI-X | vectors depend on the |
| | | interrupts of the GEP | number of RXCQ (plus a |
| | | | constant 2 for |
| | | | general and TXCQ) |
| 3 | Pull mode | On a x1 management port, | All descriptors are |
| | descriptor | pull mode is not | supported |
| | support | supported; only push | |
| | | mode is supported. | |
| | | For any host port | |
| | | serving as a | |
| | | management port | |
| | | (in-band management), | |
| | | pull mode is supported. | |
| 4 | RDMA | Management DMA does | Fully supported |
| | support | not support RDMA | |
| | | descriptors in the | |
| | | current implementation | |
| | | and will be supported | |
| | | in a future version | |
| 5 | Broadcast/ | Since a fabric may | No special bit for |
| | Multicast | contain several chips/ | enabling/disabling |
| | support | GEP, there is a per | broadcast or multicast; |
| | | chip/management DMA | always supported; for |
| | | bit for broadcast | receiving multicast, |
| | | receive enable bit (bit | the DMA function should |
| | | 19 of register 180). It | have already joined |
| | | is advisable to enable | the multicast group it |
| | | only on MCPU DMA so that | needs. |
| | | there are no duplicate | |
| | | packets received on a | |
| | | broadcast by MCPU | |
| | | There is a separate 64 | |
| | | bit mask for multicast | |
| | | group membership of the | |
| | | MCPU DMA. | |

MCPU DMA Registers are present in each station of a chip (as part of the station registers). In cases where x1 management port is used, Station 0 MCPU DMA registers should be used to control MCPU DMA. For in-band management (any host port serving as MCPU), the station that contains the management port also has the valid set of MCPU DMA registers for controlling the MCPU DMA.

| | Default | | | | | |
|---|---|---|---|---|---|---|
| | Value | Attribute | EEPROM | Reset | | |
| Offset | (hex) | (MCPU) | Writable | Level | Register or Field Name | Description |
| | | | | | MCPU DMA Function | |
| 180 h | | | | | MCPU DMA Function Control | |
| | | | | | and Status | |
| [0] | 0 | RW1C | Yes | Level01 | DMA_Status_Fun_Enable | 0—disabled; 1—enabled |
| [1] | 0 | RW1C | Yes | Level01 | DMA_Status_Pause | Error interrupt enable/disable |
| [2] | 0 | RW1C | Yes | Level01 | DMA_Status_Idle | Set by hardware if DMA has |
| | | | | | | nothing to do, but initialized and |
| | | | | | | ready |
| [3] | 0 | RW1 C | Yes | Level01 | DMA_Status_Reset_Pending | Write one to Abort DMA Engine |
| [4] | 0 | RW1 C | Yes | Level01 | DMA_Status_Reset_Complete | Write one to pause DMA engine |
| [5] | 0 | RW1C | Yes | Level01 | DMA_Status_Trans_pending | |
| [15:6] | 0 | RsvdP | No | | Reserved | |
| [16] | | RW | Yes | Level01 | DMA_Ctrl_Fun_Enable | 0—disable DMA, 1—Enable DMA |
| | | | | | | function |
| [17] | 0 | RW | Yes | Level01 | DMA_Ctrl_Pause | 0—continue; 1—(graceful) pause |
| | | | | | | DMA operations |
| [18] | 0 | RW | Yes | Level01 | DMA_Ctrl_FLR | Function reset for DMA |
| [19] | 0 | RW | Yes | Level01 | DMA_Broadcast_Enable | 0—no broadcast to the mcpu, 1— |
| | | | | | | broadcast to the mcpu |
| [20] | 0 | RW | Yes | Level01 | DMA_ECRC_Generate_Enable | 0—MCPU DMA TLPs TD bit = 0, 1 |
| | | | | | | MCPU DMA TLPs TD bit = 1 |
| [31:21] | 0 | RsvdP | No | | Reserved | |
| 184 h | | | | | MCPU RxQ Base Address Low | |
| [3:0] | 0 | RW | Yes | Level01 | RxQ Size | size of RXQ0 in entries (power of |
| | | | | | | 2 * 256) |
| [11:4] | 0 | RsvdP | No | Level0 | Reserved | Reserved |
| [31:12] | 0 | RW | Yes | Level01 | RxQ Base Address Low | Low 32 bits of NIC RX buffer |
| | | | | | | descriptor queue-zero extend for |
| | | | | | | the last 12 bits |
| 188 h | | | | | MCPU RxQ Base Address | |
| | | | | | High | |
| [31:0] | 0 | RW | Yes | Level01 | RxQ Base Address High | High 32 bits of NIC RX buffer |
| | | | | | descriptor queue base address | |
| 18Ch | | | | | | MCPU TxCQ Base Address |
| | | | | | Low | |
| [3:0] | 0 | RW | Yes | Level01 | TxCQ Size | Size of TX completion queue |
| [7:4] | 0 | RW | Yes | Level01 | Interrupt Moderation Count | Interrupt moderation-Count |
| | | | | | | (power of 2) |
| [11:8] | 0 | RW | Yes | Level01 | Interrupt Moderation Timeout | Interrupt Moderation Timeout in |
| | | | | | | microseconds (power of 2) |
| [31:12] | 0 | RW | Yes | Level01 | TxCQ Base Address Low | Low 32 bits of TX completion |
| | | | | | | queue 0-zero extend for the last |
| | | | | | | 12 bits |
| 190 h | | | | | MCPU TxCQ Base Address | |
| | | | | | High | |
| [31:0] | 0 | RW | Yes | Level01 | TxQ Base Address High | High 32 bits of TX completion |
| | | | | | | queue 0 base address |
| 194 h | | | | | MCPU RxQ Head | |
| [15:0] | 0 | RW | No | Level01 | RxQ Head Pointer | head (consumer index of RXQ- |
| | | | | | | updated by hardware) |
| [31:16] | 0 | RsvdP | | | Reserved | |
| 198 h | | | | | MCPU TxCQ Tail | |
| [15:0] | 0 | RW | No | Level01 | TxCQ Tail Pointer | tail (producer index of TxCQ- |
| | | | | | | updated by hardware) |
| [31:16] | 0 | RsvdP | No | Level0 | Reserved | Reserved |
| 19Ch | | | | | MCPU DMA Reserved 0 | |
| [31:0] | 0 | RsvdP | No | Level0 | Reserved | Reserved |
| 1A0h | | | | | MCPU TxQ Base Address Low | |
| [2:0] | 0 | RW | Yes | Level01 | TxQ Size | size of TXQ0 in entries (power of |
| | | | | | | 2 * 256) |
| [3] | 0 | RW | Yes | Level01 | TxQ Descriptor Size | Descriptor size |
| [14:4] | 0 | RsvdP | No | Level0 | Reserved | Reserved |
| [31:15] | 0 | RW | Yes | Level01 | TxQ Base Address Low | Low order bits of TxQ base |
| | | | | | | address |
| 1A4h | | | | | MCPU TxQ Base Address High | |
| [31:0] | 0 | RW | Yes | Level01 | TxQ Base Address High | High order bits of TxQ base |
| | | | | | | address |
| 1A8h | | | | | MCPU TxQ Head | |
| [15:0] | 0 | RW | No | Level01 | TxQ Head Pointer | head (consumer index of TxQ- |
| | | | | | | updated by hardware) |
| 1ACh | | | | | MCPU TxQ Arbitration Control | |
| [2:0] | 7 | RW | Yes | Level01 | TxQ DTC | DMA Traffic Class of the MCPU's |
| | | | | | | TxQ |
| [3] | 0 | RsvdP | No | | Reserved | |
| [5:4] | 2 | RW | Yes | Level01 | TxQ Priority | Priority of the MCPU's TxQ |
| [7:6] | 0 | RsvdP | No | | Reserved | |
| [11:8] | 1 | RW | Yes | Level01 | TxQ Weight | Weight of the MCPU's TxQ |
| [31:12] | 0 | RsvdP | | | Reserved | |
| 1B0h | | | | | MCPU RxCQ Base Address | |
| | | | | | Low | |
| [3:0] | 0 | RW | Yes | Level01 | RxCQ Size | Size of queue in (power of 2 * 256) |
| | | | | | | (256, 512, 1k, 2k, 4k, 8k, 16k, 32k) |
| [7:4] | 0 | RW | Yes | Level01 | RxCQ Interrupt Moderation | Interrupt moderation-Count |
| | | | | | | (power of 2) (0—no interrupt) |
| [11:8] | 0 | RW | Yes | Level01 | Interrupt Moderation Timeout | Interrupt Moderation Timeout in |
| | | | | | | microseconds (power of 2) |
| [31:12] | 0 | RW | Yes | Level01 | RxCQ Base Address Low | low order bits of RXCQ base |
| | | | | | | address (zero extend last 12 bits) |
| 1B4h | | | | | MCPU RxCQ Base Address | |
| | | | | | High | |
| [31:0] | 0 | RW | Yes | Level01 | RxCQ Base Address High | High order bits of RxCQ base |
| | | | | | | address |
| 1B8h | | | | | MCPU RxCQ Tail | |
| [15:0] | 0 | RW | No | Level01 | RxCQ Tail Pointer | tail (producer index of RxCQ- |
| | | | | | | updated by hardware) |
| [31:16] | 0 | RsvdP | No | Level0 | Reserved | Reserved |
| 1BCh | | | | | MCPU BTT Base Address Low | |
| [3:0] | 0 | RW | Yes | Level01 | BTT Size | size of BT Table in entries (power |
| | | | | | | of 2 * 256) |
| [6:4] | 0 | RsvdP | No | Level0 | Reserved | Reserved |
| [31:7] | 0 | RW | Yes | Level01 | BTT Base Address Low | Low bits of BTT base address |
| | | | | | | (extend with Zero for the low 7 |
| | | | | | | bits) |
| 1C0h | | | | | MCPU BTT Base Address High | |
| [31:0] | 0 | RW | Yes | Level01 | BTT Base Address High | High order bits of BTT base |
| | | | | | | address |
| 1C4h | | | | | MCPU TxQ Control | |
| [0] | 0 | RW | Yes | Level01 | Enable TxQ | TxQ enable |
| [1] | 0 | RW | Yes | Level01 | Pause TxQ | Pause TxQ operation |
| [31:2] | 0 | RsvdP | No | | Reserved | |
| 1C8h | | | | | Reserved | |
| [31:0] | 0 | RsvdP | No | Level0 | Reserved | Reserved |
| 1CCh | | | | | MCPU TxCQ Head | |
| [15:0] | 0 | RW | Yes | Level01 | Tx Completion Queue Head | Tx Completion Queue Head |
| | | | | | Pointer | Pointer |
| [31:16] | 0 | RsvdP | No | Reserved | Reserved | |
| 1D0h | | | | | MCPU RxQ Tail | |
| [15:0] | 0 | RW | Yes | Level01 | RxQ Tail Pointer | tail (producer index of RxQ- |
| | | | | | | updated by software) |
| [31:16] | 0 | RsvdP | No | Level0 | Reserved | Reserved |
| 1D4h | | | | | MCPU Multicast Setting Low | |
| [31:0] | 0 | RW | Yes | Level0 | MCPU Multicast Group Low | Low order bits of the MCPU's |
| | | | | | | multicast group |
| 1D8h | | | | | MCPU Multicast Setting High | |
| [31:0] | 0 | RW | Yes | Level0 | MCPU Multicast Group High | High order bits of the MCPU's |
| | | | | | | multicast group |
| 1DCh | | | | | MCPU DMA Reserved 4 | |
| [31:0] | 0 | RsvdP | No | Level0 | Reserved | Reserved |
| 1E0h | | | | | MCPU TxQ Tail | |
| [15:0] | 0 | RW | Yes | Level01 | TxQ Tail Pointer | tail (producer index of TxQ- |
| | | | | | | updated by software) |
| [31:16] | 0 | RsvdP | No | Level0 | Reserved | |
| 1E4h | | | | | MCPU RxCQ Head | |
| [15:0] | 0 | RW | Yes | Level01 | RxCQ Tail Pointer | head (consumer index of RxCQ- |
| | | | | | | updated by software) |
| [31:16] | 0 | RsvdP | No | Level0 | Reserved | |
| 1E8h | | | | | MCPU DMA Reserved 5 | |
| [31:0] | 0 | RsvdP | No | Level0 | Reserved | |
| 1ECh | | | | | MCPU DMA Reserved 6 | |
| [31:0] | 0 | RsvdP | No | Level0 | Reserved | |
| 1F0h | | | | | MCPU DMA Reserved 7 | |
| [31:0] | 0 | RsvdP | No | Level0 | Reserved | |
| 1F4h | | | | | MCPU DMA Reserved 8 | |
| [31:0] | 0 | RsvdP | No | Level0 | Reserved | |
| 1F8h | | | | | MCPU DMA Reserved 9 | |
| [31:0] | 0 | RsvdP | No | Level0 | Reserved | |
| 1FCh | | | | | MCPU DMA Reserved 10 | |
| [31:0] | 0 | RsvdP | No | Level0 | Reserved | |

### Host to Host DMA Descriptor Formats

The following types of objects may be placed in a TxQ:
Short Packet Push Descriptor
   NIC
   CTRL
   RDMA, short untagged
Pull Descriptor
   NIC
   RDMA Tagged
   RDMA Untagged
RDMA Read Request Descriptor
   The formats of each of these objects are defined in the following subsections.

The three short packet push and pull descriptor formats are treated exactly the same by the hardware and differ only in how the software processes their contents. As will be shown shortly, for RDMA, the first two DWs of the short packet payload portion of the descriptor and message generated from it contain RDMA parameters used for security check and to look up the destination application buffer based on a buffer tag.

The RDMA Read Request Descriptor is the basis for a RDMA Read Request VDM, which is a DMA engine to DMA engine message used to convert an RDMA read request into a set of RDMA write-like data transfers.

### Common Descriptor and VDM Fields

Packets, descriptors, and Vendor Defined Messages that carry them across the fabric share the common header fields defined in the following subsections. As noted, some of these fields appear in both descriptors and the VDMs created from the descriptors and others only in the VDMs.

### Destination Global RID

This is the Global RID of the destination host's DMA VF.

### Source Global RID

This field appears in the VDMs only and is filled in by the hardware to identify the source DMA VF.

### VDM Pyld Len (DWs)

This field defines the length in DWs of the payload of the Vendor Defined Message that will be created from the descriptor that contains it. For a short packet push, this field, together with “Last DW BE” indirectly defines the length of the message portion of the short packet push VDM and requires that the VDM payload be truncated at the end of the DW that contains the last byte of message.

### Last DW BE

LastDW BE appears only in NIC and RDMA short packet push messages but not in their descriptors. It identifies which leading bytes of the last DW of the message are valid based on the lowest two bits of the encapsulated packet's length. (This isn't covered by the PCIe Payload Length because it resolves only down to the DW.)

The cases are:
Only first byte valid: LastDW BE=4′b0001
First two bytes valid: LastDW BE=4′b0011
First three bytes valid: LastDW BE=4′b0111
All four bytes valid: LastDW BE=4′b1111

### Destination Domain

This is the DomainID (independent bus number space) of the destination.

When the Destination Domain differs from the source's Domain, then the DMAC adds an Interdomain Routing Prefix to the fabric VDM generated from the descriptor.

### TC

The TC field of the VDM defines the fabric Traffic Class, of the work request VDM. The TC field of the work request message header is inserted into the TLP by the DMAC From the field of the same name in the descriptor.

### D-Type

D-Type stands for descriptor type, where the “D-” is used to differentiate it from the PCIe packet “type”. A TxQ may contain any of the object types listed in the table below. An invalid type is defined to provide robustness against some software errors that might lead to unintended transmissions. D-Type is a 4-bit wide field.

TABLE 14
Descriptor Type Encoding
Descriptor Format

| D-Type | Name |
|---|---|
| 0 | Invalid |
| 1 | NIC short packet |
| 2 | CTRL short packet |
| 3 | RDMA short untagged |
| 4 | NIC pull, no prefetch |
| 5 | RDMA Tagged Pull |
| 6 | RDMA Untagged Pull |
| 7 | RDMA Read Request |
| 8-15 | Reserved |

The DMAC will not process an invalid or reserved object other than to report its receipt as an error.

### TxQ Index

TxQ Index is a zero based TxQ entry number. It can be calculated as the offset from the TxQ Base Address at which the descriptor is located in the TxQ, divided by the configured descriptor size of 64B or 128B. It doesn't appear in descriptors but is inserted into the resulting VDM by the DMAC. It is passed to the destination in the descriptor/short packet and returned to the source software in the transmit completion message to facilitate identification of the object to which the completion message refers.

### TxQ ID

TxQ ID is the zero based number of the TxQ from which the work request originated. It doesn't appear in descriptors but is inserted into the resulting VDM by the DMAC. It is passed to the destination in the descriptor/short packet message and returned to the source software in the transmit completion message to facilitate processing of the TxCQ message.

The TxQ ID has the following uses:
Used to index TxQ pointer table at the Tx
Potentially used to index traffic shaping or congestion management tables

### SEQ

SEQ is a sequence number passed to the destination in the descriptor/short packet message, returned to the source driver in the Tx Completion Message and passed to the Rx Driver in the Rx Completion Queue entry. A sequence number can be maintained by each source {TC, VF} for each destination VF to which it sends packets. A sequence number can be maintained by each destination VF for each source {TC, VF} from which it receives packets. The hardware's only role in sequence number processing is to convey the SEQ between source and destination as described. The software is charged with generating and checking SEQ so as to prevent out of order delivery and to replay transmissions as necessary to guarantee deliver in order and without error. A SEQ number is optional for most descriptor types, except for RDMA descriptors that have the SEQ_CHK flag set.

### VPFID

This 6-bit field identifies the VPF of which the source of the packet is a member. It will be checked at the receiver and the WR will be rejected if the receiver is not also a member of the same VPF. The VPFID is inserted into WR VDMs at the transmitting node.

### O_VPFID

The over-ride VPFID inserted by the Tx HW if OE is set.

### OE

Override enable for the VPFID. If this bit is set, then the Rx VLAN filtering is done based on the)_VPFID field rather than the VPFID field inserted in the descriptor by the Tx driver.

### P-Choice

P_Choice is used by the Tx driver to indicate its choice of path for the routing of the ordered WR VDM that will be created from the descriptor.

### ULP Flags

ULP (Upper Layer Protocol) Flags is an opaque field conveyed from source to destination in all work request message packets and descriptors. ULP Flags provide protocol tunneling support. PLX provided software components use the following conventions for the ULP Flags field:
Bits 0:4 are used as the ULP Protocol ID:

| Value in bits 0:4 | Protocol |
|---|---|
| 0 | Invalid protocol |
| 1 | PLX Ethernet over PCIe protocol |
| 2 | PLX RDMA over PCIe protocol |
| 3 | SOP |
| 4 | PLX stand-alone MPI protocol |
| 5-15 | Reserved for PLX use |
| 16-31 | Reserved for custom use/third party software |

Bits 5:6 Reserved/unused
Bits 7:8 WR Flags (Start/Continue/End for a WR chain of a single message)

### RDMA Buffer Tag

The 16-bit RDMA Buffer Tag provides a table ID and a table index used with the RDMA Starting Buffer Offset to obtain a destination address for an RDMA transfer.

### RDMA Security Key

The RDMA Security Key is an ostensibly random 16-bit number that is used to authenticate an RDMA transaction. The Security Key in a source descriptor must match the value stored at the Buffer Tag in the RDMA Buffer Tag Table in order for the transfer to be completed normally. A completion code indicating a security violation is entered into the completion messages sent to both source and destination VF in the event of a mismatch.

### RxConnId

The 16-bit RxConnID identifies an RDMA connection or queue pair. The receiving node of a host to host RDMA VDM work request message uses the RxConnID to enforce ordering, through sequence number checking, and to force termination of a connection upon error. When EnSeqChk flag is set in a Work Request (WR), the RxConnID is used by hardware to validate the SEQ number field in the WR for the connection associated with the RxConnID

### RDMA Starting Buffer Offset

The RDMA Starting Buffer Offset specifies the byte offset into the buffer defined via the RDMA Buffer Tag at which transfer will start. This field contains a 64-bit value that is subtracted from the Virtual Base Address field of the BTT entry to define the offset into the buffer. This is the virtual address of the first byte of the RDMA message given by the RDMA application as per RDMA specifications. When the Virtual Base Address field in the BTT is made zero, this RDMA Starting buffer offset can denote absolute offset of the first byte of transfer in the current WR, within the destination buffer.

### ZBR

ZBR stands for Zero Byte Read. If this bit is a ONE, then a zero byte read of the last address written is performed by the Rx DMAC prior to returning a TxCQ message indicating success or failure of the transfer.

The following tables define the formats of the defined TxQ object types, which include short packet and several descriptors. In any TxQ, objects are sized/padded to a configured value of 64 or 128 bytes and aligned 64 or 128 byte boundaries per the same configuration. The DMA will read a single 64B or 128B object at a time from a TxQ.

### NoRxCQ

If this bit is set, a completion message won't be written to the designated RxCQ and no interrupt will be asserted on receipt of the message, independent of the state of the interrupt moderation counts on any of the RxCQs.

### IntNow

If this bit is set in the descriptor, and NoRxCQ is clear, then an interrupt will be asserted on the designated RxCQ at the destination immediately upon delivery of the associated message, independent of the interrupt moderation state. The assertion of this interrupt will reset the moderation counters.

### RxCQ Hint

This 8-bit field seeds the hashing and masking operation that determines the RxCQ and interrupt used to signal receipt of the associated NIC mode message. RxCQ Hint isn't used for RDMA transfers. For RDMA, the RxCQ to be used is designated in the BTT entry.

### Invalidate

This flag in an RDMA work request causes the referenced Buffer Tag to be invalidated upon completion of the transfer.

### EnSeqChk

This flag in an RDMA work request signals the receive DMA to check the SEQ number and to perform an RxCQ write independent of the RDMA verb and the NoRxCQ flag.

### Path

The PATH parameter is used to choose among alternate paths for routing of WR and TxCQ VDMs via the DLUT.

### RO

Setting of the RO parameter in a descriptor allows the WR VDM created from the descriptor to be routed as an unordered packet. If RO is set, then the WR VDM marks the PCIe header as RO per the PCIe specification by setting ATTR[2:1] to 2′b01.

### NIC Mode Short Packet Descriptor

Descriptors are defined as little endian. The NIC mode short packet push descriptor is shown in the table below.

TABLE 15
NIC Mode Short Packet Descriptor
NIC & CTRL Mode Short Packet Descriptor

| Byte | +3 | | | | | | | | +2 | | | | | | | | +1 |
|---|---|---|---|---|---|---|---|---|---|---|---|---|---|---|---|---|---|
| DW | 31 | 30 | 29 | 28 | 27 | 26 | 25 | 24 | 23 | 22 | 21 | 20 | 19 | 18 | 17 | 16 | 15 |

| 0 | Destination Global RID [15:0] | | | TC |
|---|---|---|---|---|
| 1 | PATH | RC | Reserved | Destination |
| | | | | Domain |

| | | | | | | | |
|---|---|---|---|---|---|---|---|
| 2 | RxCQ Hint | EnSeqChk | NoRxCQ | IntNow | ZBR | Invalidate | LastDW BE |

| 3 | up to 116 bytes of short packet push message when configured for 128B descriptor size | | | | | | | | | | | | | | | | |
|---|---|---|---|---|---|---|---|---|---|---|---|---|---|---|---|---|---|
| 4 | or up to 52 bytes when configured for 64B descriptor size | | | | | | | | | | | | | | | | |
| 24 | | | | | | | | | | | | | | | | | |
| 25 | | | | | | | | | | | | | | | | | |
| 26 | | | | | | | | | | | | | | | | | |
| 27 | | | | | | | | | | | | | | | | | |
| 28 | | | | | | | | | | | | | | | | | |
| 29 | | | | | | | | | | | | | | | | | |
| 30 | | | | | | | | | | | | | | | | | |
| 31 | | | | | | | | | | | | | | | | | |
| | Byte | +1 | | | | | | | +0 | | | | | | | | Byte |
| | DW | 14 | 13 | 12 | 11 | 10 | 9 | 8 | 7 | 6 | 5 | 4 | 3 | 2 | 1 | 0 | Offset |

| | | | | | | |
|---|---|---|---|---|---|---|
| 0 | TC | VDM Pyid Len (DWs) | Reserved | D-Type | 128 | 00h |

| | | | | |
|---|---|---|---|---|
| 1 | Destination Domain | SEQ | byte | 04h |

| | | | | |
|---|---|---|---|---|
| 2 | VPFID | ULP flags [8:0] | RCB | 08h |

| | | |
|---|---|---|
| 3 | up to 116 bytes of short packet push message when | 0Ch |
| 4 | configured for 128B descriptor size | 10h |
| 24 | or up to 52 bytes when configured for 64B descriptor size | 60h |
| 25 | | 64h |
| 26 | | 68h |
| 27 | | 6Ch |
| 28 | | 70h |
| 29 | | 74h |
| 30 | | 78h |
| 31 | | 7Ch |

The bulk of the NIC Mode short packet descriptor is the short packet itself. This descriptor is morphed into a VDM with data that is sent to the {Destination Domain, Destination Global RID}, aka GID, where the payload is written into a NIC mode receive buffer and then the receiver is notified via a write to a receive completion queue, RxCQ. With 128B descriptors, up to 116 byte messages may be sent this way; with 64B descriptor the length is limited to 52 bytes. The VDM used to send the short packet through the fabric is defined in Table 19 NIC Mode Short Packet VDM.

The CTRL short packet is identical to the NIC Mode Short Packet, except for the D-Type code. CTRL packets are used for Tx driver to Rx driver control messaging.

### Pull Mode Descriptors

TABLE 16
128B Pull Mode Descriptor
Pull Mode Packet Descriptor

| Byte | +3 | | | | | | | | +2 | | | | | | | | +1 |
|---|---|---|---|---|---|---|---|---|---|---|---|---|---|---|---|---|---|
| Bit | 31 | 30 | 29 | 28 | 27 | 26 | 25 | 24 | 23 | 22 | 21 | 20 | 19 | 18 | 17 | 16 | 15 |

| Destination Global RID | | | TC |
|---|---|---|---|
| PATH | RC | Reserved | Destination Domain |

| | | | | | | |
|---|---|---|---|---|---|---|
| RxCQ Hint (NIC) | EnSeqChk | NoRxCQ | IntNow | ZBR | In- | NumPtrs |
| | | | | | validate | |

| RDMA Security Key | RDMA RxConnID |
|---|---|
| RDMA Starting Buffer Offset [63:32] | |
| RDMA Starting Buffer Offset [31:0] | |
| RDMA Buffer Tag | Total Transfer |
| | Length (Bytes)/16 |
| Length at Pointer 0 (bytes) | Length at Pointer 1 (bytes) |
| Packet Pointer 0 [63:32] | |
| Packet Pointer 0 [31:00] | |
| Packet Pointer 1 [63:32] | |
| Packet Pointer 1 [31:00] | |
| Length at Pointer 2 (bytes) | Length at Pointer 3 (bytes) |
| Packet Pointer 2 [63:32] | |
| Packet Pointer 2 [31:00] | |
| Packet Pointer 3 [63:32] | |
| Packet Pointer 3 [31:00] | |
| Length at Pointer 4 (bytes) | Length at Pointer 5 (bytes) |
| Packet Pointer 4 [63:32] | |
| Packet Pointer 4 [31:00] | |
| Packet Pointer 5 [63:32] | |
| Packet Pointer 5 [31:00] | |
| Length at Pointer 6 (bytes) | Length at Pointer 7 (bytes) |
| Packet Pointer 6 [63:32] | |
| Packet Pointer 6 [31:00] | |
| Packet Pointer 7 [63:32] | |
| Packet Pointer 7 [31:00] | |
| Length at Pointer 8 (bytes) | Length at Pointer 9 (bytes) |

| Packet Pointer 8 [63:32] | | | | | | | | | | | | | | | | |
|---|---|---|---|---|---|---|---|---|---|---|---|---|---|---|---|---|
| Packet Pointer 8 [31:00] | | | | | | | | | | | | | | | | |
| Packet Pointer 9 [63:32] | | | | | | | | | | | | | | | | |
| Packet Pointer 9 [31:00] | | | | | | | | | | | | | | | | |
| Byte | +1 | | | | | | | +0 | | | | | | | | Byte |
| Bit | 14 | 13 | 12 | 11 | 10 | 9 | 8 | 7 | 6 | 5 | 4 | 3 | 2 | 1 | 0 | Offset |

| | | | | | |
|---|---|---|---|---|---|
| TC | VDM Pyld Len (DWs) | Reserved | D-Type | 128- | 00h |

| | | | |
|---|---|---|---|
| Destination Domain | SEQ | Byte | 04h |

| | | | |
|---|---|---|---|
| VPFID | ULP Flags [8:0] | RCB | 08h |

| | |
|---|---|
| RDMA RxConnID | 0Ch |
| RDMA Starting Buffer Offset [63:32] | 10h |
| RDMA Starting Buffer Offset [31:0] | 14h |
| Total Transfer Length (Bytes)/16 | 18h |
| Length at Pointer 1 (bytes) | 1Ch |
| Packet Pointer 0 [63:32] | 20h |
| Packet Pointer 0 [31:00] | 24h |
| Packet Pointer 1 [63:32] | 28h |
| Packet Pointer 1 [31:00] | 2Ch |
| Length at Pointer 3 (bytes) | 30h |
| Packet Pointer 2 [63:32] | 34h |
| Packet Pointer 2 [31:00] | 38h |
| Packet Pointer 3 [63:32] | 3Ch |
| Packet Pointer 3 [31:00] | 40h |
| Length at Pointer 5 (bytes) | 44h |
| Packet Pointer 4 [63:32] | 48h |
| Packet Pointer 4 [31:00] | 4Ch |
| Packet Pointer 5 [63:32] | 50h |
| Packet Pointer 5 [31:00] | 54h |
| Length at Pointer 7 (bytes) | 58h |
| Packet Pointer 6 [63:32] | 5Ch |
| Packet Pointer 6 [31:00] | 60h |
| Packet Pointer 7 [63:32] | 64h |
| Packet Pointer 7 [31:00] | 68h |
| Length at Pointer 9 (bytes) | 6Ch |
| Packet Pointer 8 [63:32] | 70h |
| Packet Pointer 8 [31:00] | 74h |
| Packet Pointer 9 [63:32] | 78h |
| Packet Pointer 9 [31:00] | 7Ch |

Pull mode descriptors contain a gather list of source pointers. A “Total Transfer Length (Bytes)” field has been added for the convenience of the hardware in tracking the total amount in bytes of work requests outstanding. The 128B pull mode descriptor is shown in the table above and the 64B pull mode descriptor in the table below. These descriptors can be used in both NIC and RDMA modes with the RDMA information being reserved in NIC mode.

The User Defined Pull Descriptor follows the above format through the first 2 DWs. Its contents from DW2 through DW31 are user definable. The Tx engine will convert and transmit the entire descriptor RCB as a VDM.

### Length at Pointer X Fields

While the provision of a separate length field for each pointer implies a more general buffer structure, this generation of hardware assumes the following re′ pointer length and alignment:
A value of 0 in a Length at Pointer field means a length of 2¹⁶
A value of “x” in a Length at Pointer field where x !=0 means a length of “x” bytes.
NIC mode pull transfers:
   lengths and pointers have no restrictions (byte aligned, any length subject to 1-64K (1−2̂̂16).
For RDMA pull mode descriptor type:
   Only the first pointer may have an offset. Intermediate pointers have to be page aligned.
   Only the first and last lengths can be any number. The intermediate lengths have to be multiples of 4 KB

TABLE 17
64 B Pull Mode Descriptor
Pull Mode Packet Descriptor (64 B)

| Byte | +3 | | | | | | | | +2 | | | | | | | | +1 | | | | | | |
|---|---|---|---|---|---|---|---|---|---|---|---|---|---|---|---|---|---|---|---|---|---|---|---|
| DW | 31 | 30 | 29 | 28 | 27 | 26 | 25 | 24 | 23 | 22 | 21 | 20 | 19 | 18 | 17 | 16 | 15 | 14 | 13 | 12 | 11 | 10 | 9 |

| | | | |
|---|---|---|---|
| 0 | Destination Global RID | TC | VDM Pyld |
| | | | Len (DWs) |

| | | | | |
|---|---|---|---|---|
| 1 | PATH | RO | Reserved | Destination Domain |

| | | | | | | | | |
|---|---|---|---|---|---|---|---|---|
| 2 | RxCQ Hint (NIC) | EnSeqChk | NoRxCQ | IntNow | ZBR | Inval- | NumPtrs | VPFID |
| | | | | | | idate | | |

| 3 | RDMA Security Key | RDMA RxConnID |
|---|---|---|
| 4 | RDMA Starting Buffer Offset [63:32] | |
| 5 | RDMA Starting Buffer Offset [31:0] | |
| 6 | RDMA Buffer Tag | Total Transfer Length |
| | | (Bytes)/16 |
| 7 | Length at Pointer 0 (bytes) | Length at Pointer 1 |
| | | (bytes) |
| 8 | Packet Pointer 0 [63:32] | |
| 9 | Packet Pointer 0 [31:00] | |
| 10 | Packet Pointer 1 [63:32] | |
| 11 | Packet Pointer 1 [31:00] | |
| 12 | Length at Pointer 2 (bytes) | Reserved |

| | |
|---|---|
| 13 | Packet Pointer 2 [63:32] |
| 14 | Packet Pointer 2 [31:00] |
| 15 | Reserved |

| Byte | +1 | +0 | | | | | | | | Byte |
|---|---|---|---|---|---|---|---|---|---|---|
| DW | 8 | 7 | 6 | 5 | 4 | 3 | 2 | 1 | 0 | Offset |

| | | | | | |
|---|---|---|---|---|---|
| 0 | VDM Pyld | Reserved | D-Type | 64- | 00 h |
| | Len (DWs) | | | Byte | |

| | | | | |
|---|---|---|---|---|
| 1 | Destination | SEQ | RCB | 04 h |
| | Domain | | | |

| | | |
|---|---|---|
| 2 | ULP Flags[8:0] | 08 h |
| 3 | RDMA RxConnID | 0 Ch |
| 4 | RDMA Starting Buffer Offset [63:32] | 10 h |
| 5 | RDMA Starting Buffer Offset [31:0] | 14 h |
| 6 | Total Transfer Length (Bytes)/16 | 18 h |
| 7 | Length at Pointer 1 (bytes) | 1 Ch |
| 8 | Packet Pointer 0 [63:32] | 20 h |
| 9 | Packet Pointer 0 [31:00] | 24 h |
| 10 | Packet Pointer 1 [63:32] | 28 h |
| 11 | Packet Pointer 1 [31:00] | 2 Ch |
| 12 | Reserved | 30 h |
| 13 | Packet Pointer 2 [63:32] | 34 h |
| 14 | Packet Pointer 2 [31:00] | 38 h |
| 15 | Reserved | 3 Ch |

An example pull descriptor VDM is shown in Table 22 Pull Descriptor VDM with only 3 Pointers. The above table shows the maximum pull descriptor message that can be supported with a 128-byte descriptor. It contains 10 pointers. This is the maximum length. If the entire message can be described with fewer pointers, then unneeded pointers and their lengths are dropped. An example of this is shown in Table. The above table shows that the maximum pull descriptor supported with a 64B descriptor includes only 3 pointers. (64B descriptors aren't supported in Capella 2 but are documented here for completeness.)

The above descriptor formats are used for pull mode transfers of any length. In NIC mode, (also encoded in the Type field) the following RDMA fields: security keys, and starting offset, are reserved. Unused pointers and lengths in a descriptor are don't cares. (IS THIS CORRECT?)

The descriptor size is fixed at 64B or 128B as configured for the TxQ independent of the number of pointers actually used. For improved protocol efficiency, pointers and length fields not used are omitted from the vendor defined fabric messages that convey the pull descriptors to the destination node.

### Vendor Defined Descriptor and Short Packet Messages

The following subsections define the PCIe Vendor Defined Message TLPs used in the host to host messaging. For each TxQ object defined in the previous subsection there is a definition of the fabric message into which it is morphed. The Vendor Defined Messages (VDM) are encoded as Type 0, which specifies UR instead of silent discard when received by an unsupported source, as shown in FIG. 4. Like the table below from the PCIe specification, the VDMs are presented in transmission order with first transmitted (and most significant) bit on the left of each row of the tables.

The PCIe Message Code in the VDM identifies the message type as vendor defined Type0. The table below defines the meaning of the PLX Message Code that is inserted in the otherwise unused TAG field of the header. The table includes all the message codes defined to date. In the cases where a VDM is derived from a descriptor, the descriptor type and name are listed in the table.

TABLE 18
PLX Vendor Defined Message Code Definitions

| Vendor Defined Message | | | |
|---|---|---|---|
| PLX Msg | Message | Corresponding Descriptor | |
| Code | Type/Description | D-Type | Name |
| 5′h00 | Invalid | 0 | Invalid |
| 5′h01 | NIC short packet push | 1 | NIC short packet |
| 5′h02 | CTRL short packet push | 2 | CTRL short packet |
| 5′h03 | RDMA Short Untagged | 3 | RDMA short untagged |
| | Push | | |
| 5′h04 | NIC Pull | 4 | NIC pull, no prefetch |
| 5′h05 | RDMA Tagged Pull | 5 | RDMA Tagged Pull |
| 5′h06 | RDMA Untagged Pull | 6 | RDMA Untagged Pull |
| 5′h07 | RDMA Read Request | 7 | RDMA Read Request |
| 5′h08 | Command Relay | NA | Command Relay |
| 5′h09-5′h0F | Reserved | 8-15 | Reserved |
| 5′h10 | RDMA Pull ACK | NA | |
| 5′h11 | Remote Read Request | NA | |
| 5′h12 | Tx CQ Message | NA | |
| 5′h13 | PRFR (pull request | NA | |
| | for read) | | |
| 5′h14 | Doorbell | NA | |
| 5′h1F | Reserved | NA | |

### NIC Mode Short Packet Push VDM

TABLE 19
NIC Mode Short Packet VDM

| | | | | |
|---|---|---|---|---|
| Byte | +3 | +2 | +1 | +0 |

| | | | | | | |
|---|---|---|---|---|---|---|
| 0 | PATH | OE | O_VPFID | Pad of zeros inserted at Tx | VDM Pyld Len | Vendor |

| | | | | | | | | | | |
|---|---|---|---|---|---|---|---|---|---|---|
| 1 | RxCQ Hint | EnSeqChk | NoRxCQ | IntNow | ZBR | Invalidate | LastDW BE | VPFID | ULP Flags[8:0] | Defined |

| | | |
|---|---|---|
| 2 | Short Packet Push Message | Message |
| 3 | Up to 116 bytes with 128 B descriptor | Payload |
| 4 | up to 52 bytes with 64 B descriptor | |
| 5 | | |
| 6 | | |
| 7 | | |
| 8 | | |
| 9 | | |
| 10 | | |
| 11 | | |
| 12 | | |
| 13 | | |
| 14 | | |
| 15 | | |
| 16 | | |
| 17 | | |
| 18 | | |
| 19 | | |
| 20 | | |
| 21 | | |
| 22 | | |
| 23 | | |
| 24 | | |
| 25 | | |
| 26 | | |
| 27 | | |
| 28 | | |
| 29 | | |
| 30 | | |
| | ECRL added by DMAC | |

The NIC mode short packet push VDM is derived from Table 15 NIC Mode Short Packet Descriptor. NIC mode short packet push VDMs are routed as unordered. Their ATTR fields should be set to 3′b010 to reflect this property (under control of a chicken bit, in this case).

For NIC mode, only the IntNow flag may be used.

### Pull Mode Descriptor VDMs

TABLE 20
Pull Mode Descriptor VDM from 128 B Descriptor with Maximum of 10 Pointers
Pull Mode Descriptor Vendor Defined Message

| Byte | +0 | | | | | | | | +1 | | | | | | | | +2 | | | | | |
|---|---|---|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 | 4 | 3 | 2 |

| | | | | | | | | | | | | |
|---|---|---|---|---|---|---|---|---|---|---|---|---|
| 0 | FMT = | Type | R | TC | R | Attr | R | TH | TD | EP | ATTR | AT |
| | 0x1 | | | | | | | | | | | |

| | | | |
|---|---|---|---|
| 1 | Source Global RID (filled in by HW) | Reserved | PLX MSG |

| | | |
|---|---|---|
| 2 | Destination Global RID | Vendor ID = PLX |

| | | | |
|---|---|---|---|
| 3 | Tx Q Index (filled in by HW) | TxQ ID[8:0] filled in by HW | Rsvd |

| | | | |
|---|---|---|---|
| Byte | +3 | +2 | +1 |

| | | | | |
|---|---|---|---|---|
| 0 | PATH | OE | O_VPFID | Pad of zeros inserted at Tx |

| | | | | | | | | |
|---|---|---|---|---|---|---|---|---|
| 1 | RxCQ Hint (NIC) | EnSeqChk | NoRxCQ | IntNow | ZBR | Inval- | NumPtrs | VPFID |
| | | | | | | idate | | |

| 2 | RDMA Security Key | | | | | | | | | RDMA RxConnID | | |
|---|---|---|---|---|---|---|---|---|---|---|---|---|
| 3 | RDMA Starting Buffer Offset [63:32] | | | | | | | | | | | |
| 4 | RDMA Starting Buffer Offset [31:0] | | | | | | | | | | | |
| 5 | RDMA Buffer Tag | | | | | | | | | Total Transfer Length | | |
| | | | | | | | | | | (Bytes)/16 | | |
| 6 | Length at Pointer 0 (bytes) | | | | | | | | | Length at Pointer 1 | | |
| | | | | | | | | | | (bytes) | | |
| 7 | Packet Pointer 0 [63:32] | | | | | | | | | | | |
| 8 | Packet Pointer 0 [31:00] | | | | | | | | | | | |
| 9 | Packet Pointer 1 [63:32] | | | | | | | | | | | |
| 10 | Packet Pointer 1 [31:00] | | | | | | | | | | | |
| 11 | Length at Pointer 2 (bytes) | | | | | | | | | Length at Pointer 3 | | |
| | | | | | | | | | | (bytes) | | |
| 12 | Packet Pointer 2 [63:32] | | | | | | | | | | | |
| 13 | Packet Pointer 2 [31:00] | | | | | | | | | | | |
| 14 | Packet Pointer 3 [63:32] | | | | | | | | | | | |
| 15 | Packet Pointer 3 [31:00] | | | | | | | | | | | |
| 16 | Length at Pointer 4 (bytes) | | | | | | | | | Length at Pointer 5 | | |
| | | | | | | | | | | (bytes) | | |
| 17 | Packet Pointer 4 [63:32] | | | | | | | | | | | |
| 18 | Packet Pointer 4 [31:00] | | | | | | | | | | | |
| 19 | Packet Pointer 5 [63:32] | | | | | | | | | | | |
| 20 | Packet Pointer 5 [31:00] | | | | | | | | | | | |
| 21 | Length at Pointer 6 (bytes) | | | | | | | | | Length at Pointer 7 | | |
| | | | | | | | | | | (bytes) | | |
| 22 | Packet Pointer 6 [63:32] | | | | | | | | | | | |
| 23 | Packet Pointer 6 [31:00] | | | | | | | | | | | |
| 24 | Packet Pointer 7 [63:32] | | | | | | | | | | | |
| 25 | Packet Pointer 7 [31:00] | | | | | | | | | | | |
| 26 | Length at Pointer 8 (bytes) | | | | | | | | | Length at Pointer 9 | | |
| | | | | | | | | | | (bytes) | | |
| 27 | Packet Pointer 8 [63:32] | | | | | | | | | | | |
| 28 | Packet Pointer 8 [31:00] | | | | | | | | | | | |
| 29 | Packet Pointer 9 [63:32] | | | | | | | | | | | |
| 30 | Packet Pointer 9 [31:00] | | | | | | | | | | | |
| | ECRC added by DMAC | | | | | | | | | | | |
| | | Byte | +2 | | +3 | | | | | | | |
| | | DW | 1 | 0 | 7 | 6 | 5 | 4 | 3 | 2 | 1 | 0 |

| 0 | Payload Length | | VDM |
|---|---|---|---|
| 1 | PLX MSG | ‘Vendor Defined | HDR |
| 2 | Vendor ID = PLX | | |
| 3 | Rsvd | SEQ | |
| Byte | +1 | +0 | |

| 0 | Pad of zeros inserted at Tx | |
|---|---|---|
| 1 | VPFID | ULP Flags[8:0] |

| | |
|---|---|
| 2 | RDMA RxConnID |
| 3 | RDMA Starting Buffer Offset [63:32] |
| 4 | RDMA Starting Buffer Offset [31:0] |
| 5 | Total Transfer Length (Bytes)/16 |
| 6 | Length at Pointer 1 (bytes) |
| 7 | Packet Pointer 0 [63:32] |
| 8 | Packet Pointer 0 [31:00] |
| 9 | Packet Pointer 1 [63:32] |
| 10 | Packet Pointer 1 [31:00] |
| 11 | Length at Pointer 3 (bytes) |
| 12 | Packet Pointer 2 [63:32] |
| 13 | Packet Pointer 2 [31:00] |
| 14 | Packet Pointer 3 [63:32] |
| 15 | Packet Pointer 3 [31:00] |
| 16 | Length at Pointer 5 (bytes) |
| 17 | Packet Pointer 4 [63:32] |
| 18 | Packet Pointer 4 [31:00] |
| 19 | Packet Pointer 5 [63:32] |
| 20 | Packet Pointer 5 [31:00] |
| 21 | Length at Pointer 7 (bytes) |
| 22 | Packet Pointer 6 [63:32] |
| 23 | Packet Pointer 6 [31:00] |
| 24 | Packet Pointer 7 [63:32] |
| 25 | Packet Pointer 7 [31:00] |
| 26 | Length at Pointer 9 (bytes) |
| 27 | Packet Pointer 8 [63:32] |
| 28 | Packet Pointer 8 [31:00] |
| 29 | Packet Pointer 9 [63:32] |
| 30 | Packet Pointer 9 [31:00] |
| | ECRC added by DMAC |

The Pull Mode Descriptor VDM is derived from Table 16 128B Pull Mode Descriptor.

The above table shows the maximum pull descriptor message that can be supported with a 128-byte descriptor. It contains 10 pointers. This is the maximum length. If the entire message can be described with fewer pointers, then unneeded pointers and their lengths are dropped. An example of this is shown in Table.

RDMA parameters are reserved in NIC mode.

TABLE 21
Pull Mode Descriptor VDM from 64 B Descriptor with Maximum of 3 Pointers
Pull Descriptor Vendor Defined Message (64 B)

| Byte | +0 | | | | | | | | +1 | | | | | | | | +2 | | | | | |
|---|---|---|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 | 4 | 3 | 2 |

| | | | | | | | | | | | | |
|---|---|---|---|---|---|---|---|---|---|---|---|---|
| 0 | FMT = 0x1 | Type | R | TC | R | Attr | R | TH | TD | EP | ATTR | AT |

| | | | |
|---|---|---|---|
| 1 | Source Global RID (filled in by HW) | Reserved | PLX MSG |

| | | |
|---|---|---|
| 2 | Destination Global RID | Vendor ID = PLX |

| | | | |
|---|---|---|---|
| 3 | Tx Q Index (filled in by HW) | TxQ ID[8:0] filled in by HW | Rsvd |

| | | | |
|---|---|---|---|
| Byte | +3 | +2 | +1 |

| | | | | |
|---|---|---|---|---|
| 0 | PATH | OE | O_VPFID | Pad of zeros inserted at Tx |

| | | | | | | | | |
|---|---|---|---|---|---|---|---|---|
| 1 | RxCQ Hint (NIC) | EnSeqChk | NoRxCQ | IntNow | ZBR | Invalidate | NumPtrs | VPFID |

| 2 | RDMA Security Key | RDMA RxConnID |
|---|---|---|
| 3 | RDMA Starting Buffer Offset [63:32] | |
| 4 | RDMA Starting Buffer Offset [31:0] | |
| 5 | RDMA Buffer Tag | Total Transfer Length |
| | | (Bytes)/16 |
| 6 | Length at Pointer 0 (bytes) | Length at Pointer 1 (bytes) |
| 7 | Packet Pointer 0 [63:32] | |
| 8 | Packet Pointer 0 [31:00] | |
| 9 | Packet Pointer 1 [63:32] | |
| 10 | Packet Pointer 1 [31:00] | |
| 11 | Length at Pointer 2 (bytes) | Length at Pointer 3 (bytes) |

| 12 | Packet Pointer 2 [63:32] | | | | | | | | | | | |
|---|---|---|---|---|---|---|---|---|---|---|---|---|
| 13 | Packet Pointer 2 [31:00] | | | | | | | | | | | |
| | ECRC added by DMAC | | | | | | | | | | | |
| | | Byte | +2 | | +3 | | | | | | | |
| | | DW | 1 | 0 | 7 | 6 | 5 | 4 | 3 | 2 | 1 | 0 |

| 0 | Payload Length | | VDM |
|---|---|---|---|
| 1 | PLX MSG | ‘Vendor Defined | HDR |
| 2 | Vendor ID = PLX | | |
| 3 | Rsvd | SEQ | |
| Byte | +1 | +0 | |

| 0 | Pad of zeros inserted at Tx | |
|---|---|---|
| 1 | VPFID | ULP Flags[8:0] |

| | |
|---|---|
| 2 | RDMA RxConnID |
| 3 | RDMA Starting Buffer Offset [63:32] |
| 4 | RDMA Starting Buffer Offset [31:0] |
| 5 | Total Transfer Length (Bytes)/16 |
| 6 | Length at Pointer 1 (bytes) |
| 7 | Packet Pointer 0 [63:32] |
| 8 | Packet Pointer 0 [31:00] |
| 9 | Packet Pointer 1 [63:32] |
| 10 | Packet Pointer 1 [31:00] |
| 11 | Length at Pointer 3 (bytes) |
| 12 | Packet Pointer 2 [63:32] |
| 13 | Packet Pointer 2 [31:00] |
| | ECRC added by DMAC |

The above table shows the maximum pull descriptor supported with a 64B descriptor.

TABLE 22
Pull Descriptor VDM with only 3 Pointers
3-Pointer Pull Mode Descriptor Vendor Defined Message

| Byte | +0 | | | | | | | | +1 | | | | | | | | +2 | | |
|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 |

| | | | | | | | | | | | |
|---|---|---|---|---|---|---|---|---|---|---|---|
| 0 | FMT = 0x1 | Type | R | TC | R | Attr | R | TH | TD | EP | ATTR |

| | | |
|---|---|---|
| 1 | Source Global RID (filled in by HW) | Reserved |
| 2 | Destination Global RID | Vendor ID = PLX |

| | |
|---|---|
| 3 | Tx Q Index (filled in by HW) |

| | | | |
|---|---|---|---|
| Byte | +3 | +2 | +1 |

| | | | | |
|---|---|---|---|---|
| 0 | PATH | OE | O_VPFID | Pad of zeros inserted at Tx |

| | | | | | | | | |
|---|---|---|---|---|---|---|---|---|
| 1 | RxCQ Hint (NIC) | EnSeqChk | NoRxCQ | IntNow | ZBR | Invalidate | NumPtrs | VPFID |

| 2 | RDMA Security Key | RDMA RxConnID |
|---|---|---|
| 3 | RDMA Starting Buffer Offset [63:32] | |
| 4 | RDMA Starting Buffer Offset [31:0] | |
| 5 | RDMA Buffer Tag | Total Transfer |
| | | Length (Bytes)/16 |
| 6 | Length at Pointer 0 (bytes) | Length at Pointer |
| | | 1 (bytes) |
| 7 | Packet Pointer 0 [63:32] | |
| 8 | Packet Pointer 0 [31:00] | |
| 9 | Packet Pointer 1 [63:32] | |
| 10 | Packet Pointer 1 [31:00] | |
| 11 | Length at Pointer 2 (bytes) | Don't Care |

| 12 | Packet Pointer 2 [63:32] | | | | | | | | | | | | | |
|---|---|---|---|---|---|---|---|---|---|---|---|---|---|---|
| 13 | Packet Pointer 2 [31:00] | | | | | | | | | | | | | |
| | ECRC added by DMAC | | | | | | | | | | | | | |
| | | +2 | | | | | +3 | | | | | | | |
| | | 4 | 3 | 2 | 1 | 0 | 7 | 6 | 5 | 4 | 3 | 2 | 1 | 0 |

| | | | |
|---|---|---|---|
| ATTR | AT | Payload Length | VDM |

| PLX MSG | | ‘Vendor Defined | HDR |
|---|---|---|---|
| Vendor ID = PLX | | | |
| TxQ ID[8:0] | Rsvd | SEQ | |
| filled in by HW | | | |

| | |
|---|---|
| +1 | +0 |

| Pad of zeros inserted at Tx | |
|---|---|
| VPFID | ULP Flags[8:0] |

RDMA RxConnID
RDMA Starting Buffer Offset [63:32]
RDMA Starting Buffer Offset [31:0]
Total Transfer Length (Bytes)/16
Length at Pointer 1 (bytes)
Packet Pointer 0 [63:32]
Packet Pointer 0 [31:00]
Packet Pointer 1 [63:32]
Packet Pointer 1 [31:00]
Don't Care
Packet Pointer 2 [63:32]
Packet Pointer 2 [31:00]
ECRC added by DMAC

The above table illustrates the compaction of the message format by dropping unused Packet Pointers and Length at Pointers fields. Per the NumPtrs field, only 3 pointers were needed. Length fields are rounded up to a full DW so the 2 bytes that would have been “Length at Pointer 3” became don't care.

### Remote Read Request VDM

The remote read requests of the pull protocol are sent from destination host to the source host as ID-routed Vendor Defined Messages using the format of Table 23 Remote Read Request VDM. The address in the message is a physical address in the address space of the host that receives the message, which was also the source of the original pull request. In the switch egress port that connects to this host, the VDM is converted to a standard read request using the Address, TAG for Completion, Read Request DW Length, and first and last DW BE fields of the message. The message and read request generated from it are marked RO via the ATTR fields of the headers.

This VDM is to be routed as unordered so the ATTR fields should be set to 3′b010 to reflect its RO property.

TABLE 23
Remote Read Request VDM

| Byte | +0 | | | | | | | | +1 | | | | | | | | +2 | | | | | | | | +3 | | | | | | | |
|---|---|---|---|---|---|---|---|---|---|---|---|---|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 |

| | | | | | | | | | | | | | | |
|---|---|---|---|---|---|---|---|---|---|---|---|---|---|---|
| 0 | FMT = 0x1 | Type | R | TC | R | Attr | R | TH | TD | EP | ATTR | AT | Message Payload Length in DWs | VDM |

| | | | | | |
|---|---|---|---|---|---|
| 1 | Requester GRID (the reader) | Reserved | ‘RemRdReq | ‘Vendor Defined | hder |

| 2 | Destination GRID (the node being read) | | Vendor ID = ‘PLX | | |
|---|---|---|---|---|---|
| 3 | Reserved | Read Request DW Length | TAG for completion | Last DW BE | 1st DW BE |

| 0 | Address[63:32] | | Pyld |
|---|---|---|---|
| 1 | Address[31:2] | PH | |

ECRC

### Doorbell VDM

The doorbell VDMs, whose structure is defined in the table below are sent by a hardware mechanism that is part of the TWC-H endpoint. Refer to the TWC chapter for details of the doorbell signaling operation.

TABLE 24
Doorbell VDM

| Byte | +0 | | | | | | | | +1 | | | | | | | | +2 | | | | | | | | +3 | | | | | | | |
|---|---|---|---|---|---|---|---|---|---|---|---|---|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 |

| | | | | | | | | | | | | | | |
|---|---|---|---|---|---|---|---|---|---|---|---|---|---|---|
| 0 | FMT = 0x1 | Type | R | TC | R | Attr | R | TH | TD | EP | ATTR | AT | Payload Length | VDM |

| | | | | | |
|---|---|---|---|---|---|
| 1 | Source Global RID (filled in by HW) | Rsvd | PLX MSG | ‘Vendor Defined | HDR |

| | | |
|---|---|---|
| 2 | Destination Global RID from register | Vendor ID = PLX |

| | |
|---|---|
| 3 | Reserved |

### Completion Messages

### Transmit Completion Message

A completion message is returned to the source host for each completed message (i.e. a short packet push or a pull or an RDMA read request) in the form of an ID-routed TxCQ VDM. The source host expects to receive this completion message and initiates recovery if it doesn't. To detect missing completion numbers, the Tx driver maintains a SEQ number for each {source ID, destination ID, TC}. Within each streams, completion messages are required to return in SEQ order. An out of order SEQ in an end to end defined stream indicates a missed/lost completion message and may results in a replay or recovery procedure.

The completion message includes a Condition Code (CC) that indicates either success or the reason for a failed message delivery. CCs are defined in CCode subsection.

The completion message ultimately written into the sender's Transmit Completion Queue crosses the fabric embedded in bytes 12-15 of an ID routed VDM with 1 DW of payload, as shown in Table. This VDM is differentiated from other VDMs by the PLX MSG field embedded in the PCIe TAG field. When the TxCQ VDM finally reaches its target host's egress, it is transformed into a posted write packet with payload extracted from the VDM and the address obtained from the Completion Queue Tail Pointer of the queue pointed to by the TxQ ID field in the message.

TABLE 25
TxCQ Entry and Message
Vendor Defined Transmit Completion Message

| Byte | +0 | | | | | | | | +1 | | | | | | | | +2 | | | | | | | | +3 | | | | | | | |
|---|---|---|---|---|---|---|---|---|---|---|---|---|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 |

| | | | | | | | | | | | | | | |
|---|---|---|---|---|---|---|---|---|---|---|---|---|---|---|
| 0 | FMT = 0x1 | Type | R | TC | R | Attr | R | TH | TD | EP | ATTR | AT | Payload Length | VDM |

| | | | | | |
|---|---|---|---|---|---|
| 1 | Completer GRID | Reserved | Msg Type = | ‘Vendor Defined | hder |
| | | | ‘TxCQ | | |

| 2 | Requester GRID (destination of this ID routed VDM) | | Vendor ID = PLX | |
|---|---|---|---|---|
| 3 | Tx Q Index | Reserved | SEQ | Completer Domain |

| | | | | | | | |
|---|---|---|---|---|---|---|---|
| 0 | PATH | Reserved | TxQ ID[8:0] | CongInd | Ctype | Ccode | Pyld |

| | | |
|---|---|---|
| 1 | Reserved | Total Transfer Length (Bytes)/16 |

ECRC

Tx Completion Queue Entry

| Byte | +3 | | | | | | | | +2 | | | | | | | | +1 | | | | | | | | +0 | | | | | | | |
|---|---|---|---|---|---|---|---|---|---|---|---|---|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 |

| | | | | |
|---|---|---|---|---|
| 0 | Completer GRID | Completer Domain | Ctype | Ccode |

| | | | | |
|---|---|---|---|---|
| 1 | Tx Q Index | TxQ ID[8:0] | CongInd | SEQ |

The PCIe definition of an ID routed VDM includes both Requester and Destination ID fields. They are shown in the table above as GRIDs because Global RIDs are used in these fields. Since this is a completion message, the Requester GRID field is filled with the Completer's GRID, which was the Destination GRID of the message to which the completion responds. The Destination GRID of the completion message was the Requester GRID of that original message. It is used to route the completion message back to the original message's source DMA VF TxQ.

The Completer Domain field is filled with the Domain in which the DMAC creating the completion message is located.

The VDM is routed unchanged to the host's egress pipeline and there morphed into a Posted Write to the current value of the Tx CQ pointer of the TxQ from which the message being completed was sent and sent out the link to the host. The queue pointer is then incremented by the fixed payload length of 8 byes and wrapped back to the base address at the limit+1.

The Tx Driver uses the TxQ ID field and TxQ Index field to access its original TxQ entry where it keeps the SEQ that it must check. If the SEQ check passes, the driver frees the buffer containing the original message. If not and if the transfer was RDMA, it initiates error recovery. In NIC mode, dealing with out of order completion is left to the TCP/IP stack. The Tx Driver may use the congestion feedback information to modify its policies so as to mitigate congestion.

After processing a transmit completion queue entry, the driver writes zeros into its Completion Type field to mark it as invalid. When next processing a Transmit Completion Interrupt, it reads and processes entries down the queue until it finds an invalid entry. Since TxCQ interrupts are moderated, it is likely that there are additional valid TxCQ entries in the queue to be processed.

The software prevents overflow of its Tx completion queues by limiting the number of outstanding/incomplete source descriptors, by proper sizing of TXCQ based on the number and sizes of TXQs, and by taking in to consideration the bandwidth of the link

### Receive Completion Message

For each completed source descriptor and short packet push, a completion message is also written into a completion queue at the receiving host. Completion messages to the receiving host are standard posted writes using one of its VF's RxCQ Pointers, per the PLX-RSS algorithm. Table shows the payload of the Completion Message written into the appropriate RxCQ for each completed source descriptor and short packet push transfer received with the NoRxCQ bit clear. The payload changes in DWs three and four for RDMA vs. NIC mode as indicated by the color highlighting in the table. The “RDMA Buffer Tag” and Security Key” fields are written with the same data (from the same fields of the original work request VDM) as for an RDMA transfer. The Tx driver sometimes conveys connection information to the Rx driver in these fields when NIC format is used.

TABLE 26
Receive Completion Queue Entry Format for NIC mode Transfers and Short Packet Pushes
RDMA Rx Completion Queue Entry

| Byte | +3 | | | | | | | | +2 | | | | | | | | +1 | | | | | | | | +0 | | | | | | | |
|---|---|---|---|---|---|---|---|---|---|---|---|---|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 |

| | | | | |
|---|---|---|---|---|
| 0 | Source Global RID (filled in by HW) | Source Domain | Ctype | Ccode |

| | | | | | | | |
|---|---|---|---|---|---|---|---|
| 1 | EnSeqChk | TTL [19:16] | Conglnd | SEQ | NoRxQ | VPFID | ULP Flags[8:0] |

| 2 | RDMA Security Key | RDMA RxConnID |
|---|---|---|
| 3 | RDMA Starting Buffer Offset[63:32] | |
| 4 | RDMA Starting Buffer Offset[31:0] | |
| 5 | RDMA Buffer Tag | Total Transfer Length[15:0] (Bytes) |

NIC/CTRL/Send Rx Completion Queue Entry

| Byte | +3 | | | | | | | | +2 | | | | | | | | +1 | | | | | | | | +0 | | | | | | | |
|---|---|---|---|---|---|---|---|---|---|---|---|---|---|---|---|---|---|---|---|---|---|---|---|---|---|---|---|---|---|---|---|---|
| DW | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 | 7 | 6 | 5 | 4 | 3 | 2 | 1 | 0 |

| | | | | |
|---|---|---|---|---|
| 0 | Source Global RID (filled in by HW) | Source Domain | Ctype | Ccode |

| | | | | | | | |
|---|---|---|---|---|---|---|---|
| 1 | EnSeqChk | Reserved | Conglnd | SEQ | NoRxQ | VPFID | ULP Flags[8:0] |

| | | |
|---|---|---|
| 2 | RDMA Security Key | RDMA RxConnID |

| | | | | |
|---|---|---|---|---|
| 3 | Starting Offset[11:0] | Cflags | WR_ID[5:0] | Transfer Length in the Buffer (Bytes) |

| | | |
|---|---|---|
| 4 | RDMA Buffer Tag | RxDescr Ring Index[15:0] |

In NIC mode, the receive buffer address is located indirectly via the Rx Descriptor Ring Index. This is the offset from the base address of the Rx Descriptor ring from which the buffer address was pulled. Again in NIC mode, one completion queue write is done for each buffer so the transfer length of each completion queue entry contains only the amount in that message's buffer, up to 4K bytes. Software uses the WR_ID and SEQ fields to associate multiple buffers of the same message with each other. The CFLAGS field indicates the start, continuation, and end of a series of buffers containing a single message. It's not necessary that messages that span multiple buffers use contiguous buffers or contiguous RxCQ entries for reporting the filling of those buffers.

The NIC/CTRL/Send form of the RxCQ entry is also used for CTRL transfers and for RDMA transfers, such as untagged SEND, that don't transfer directly into a pre-registered buffer. The RDMA parameters are always copied from the pull request VDM into the RxCQ entry as shown because for some transfers that use the NIC form, they are valid.

The RDMA pull mode completion queue entry format is shown in the table above. A single entry is created for each received RDMA pull message in which the NoRxCQ flag is de-asserted or for which it is necessary to report an error. It is defined as 32B in length but only the first 20B are valid. The DMAC creates a posted write with a payload length of 20B to place an RDMA pull completion message onto a completion queue. After each such write, the DMAC increments the queue pointer by 32B to preserve RxCQ alignment. Software is required to ignore bytes 21-31 of an RDMA RxCQ entry. An RxCQ may contain both 20B RDMA completion entries and 20B NIC mode completion entries also aligned on 32B boundaries. For tagged RDMA transfers, the destination buffer is defined via the RDMA Buffer Tag and the RDMA Starting Offset. One completion queue write is done for each message so the transfer length field contains the entire byte length received.

### Completion Message Field Definitions

The previously undefined fields of completion queue entries and messages are defined here.

### CTYPE

This definition applies to both Tx and Rx CQ entries.

| [symbol] | [symbol] | [symbol] |
|---|---|---|
| 3′b001 | NIC/CTRL WR (TX) Completion | TXCQ |
| 3′b010 | NIC and CTRL RX completion | RXCQ |
| 3′b011 | RDMA descriptor/operation complete | TXCQ |
| | (send/read/write, tagged/untagged) | |
| 3′b011 | RDMA Tagged Write RX completion | RXCQ |
| | (if NoRXCQ bit is not set) | |
| 3′b100 | RDMA Send (untagged Rx) Completion | RXCQ |
| 3′b101 | Reserved | |
| 3′b110 | Reserved | |
| 3′b111 | unknown (used in some error | ALL |
| | completions) | |

[symbol]

indicates data missing or illegible when filed

### CCode

The definition of completion codes in Table applies to both Tx and Rx CQ entries. If multiple error/failure conditions obtain, the one with the lowest completion code is reported.

TABLE 27
RxCQ and TxCQ Completion Codes

| Completion Code in RxCQ and TxCQ | | | Report |
|---|---|---|---|
| Code | Meaning | Notes | to |
| 0 | Invalid (this allows software | | ALL |
| | to zero the CCode field of a | | |
| | completion queue entry it has | | |
| | processed to indicate to | | |
| | itself that the entry is | | |
| | invalid. The entry will be | | |
| | marked valid when the DMAC | | |
| | writes it again. | | |
| 1 | Successful message completion | | ALL |
| 2 | Message failed due to host | | TXCQ |
| | link down at destination | | |
| 3 | Message failed due to | Dma in effect | TXCQ |
| | persistent credit starvation | declares host | |
| | on host link | down and rejects | |
| 4 | Message failed, WR dropped by | no further | TXCQ |
| | VLAN filter | processing | |
| 5 | Message failed due to HW SEQ | Mark connection | ALL |
| | check error | broken | |
| 6 | Message failed due to invalid | Expected SEQ | TXCQ |
| | RxConnID | was 0 | |
| 7 | RDMA security key or grid | RDMA security | TXCQ |
| | check failure | checks (assumed | |
| 8 | RDMA Read or Write Permission | to assert | ALL |
| | Violation | simultaneously) | |
| 9 | Message failed due to use of | | TXCQ |
| | Invalidated Buffer Tag | | |
| 10 | Message failed due to RxCQ | | TXCQ |
| | full or disabled | | |
| 11 | Message failed due to | ECRC or repeated | ALL |
| | unrecoverable data error | failure of link | |
| | | level retry or | |
| | | receipt of | |
| | | poisoned | |
| | | completion to | |
| | | remote read | |
| | | request | |
| 12 | Message failed due to CTO | | ALL |
| 13 | Message failed, WR dropped at | in TxCQ returned | TXCQ |
| | fabric fault | from fabric port | |
| | | at fault | |
| 14 | Message failed due to no RxQ | Only applies to | TxCQ |
| | entry available | untagged RDMA | |
| | | and NIC | |
| 15 | Message failed due to | | TxCQ |
| | unsupported PLX MSG code | | |
| 16 | Message failed due to | | TxCQ |
| | unsupported D-Type | | |
| 17 | Message failed due to zero | | TxCQ |
| | byte read failure | | |
| 18:30 | Reserved | | |
| 31 | Message failed due to any | | TXCQ |
| | other error at destination | | |

### Congestion Indicator (CI)

The 3-bit Congestion Indicator field appears in the TxCQ entry and is the basis for end to end flow control. The contents of the field indicate the relative queue depth of the DMA Destination Queue(TC) of the traffic class of the message being acknowledged. The Destination DMA hardware fills in the CI field of the TxCQ message based on the fill level of the work request queue of its port and TC.

The 3-bit Congestion Indicator field appears in the TxCQ entry and is the basis for end to end flow control. The contents of the field indicate the relative queue depth of the DMA Destination Queue(TC) of the traffic class of the message being acknowledged. The Destination DMA hardware fills in the CI field of the TxCQ message based on the fill level of the work request queue of its port and TC.

TABLE 28
Congestion Indication Value Description

| CI Value | Description |
|---|---|
| 0 | No Congestion: WR queue is below RxWRThreshold |
| 1 | Some Congestion: WR queue is above RxWRThreshold |
| 2 | Severe Congestion: WR queue is in overflow state, |
| | above RxWROvfThreshold |

The Congestion Indicator field can be used by the driver SW to adjust the rate at which it enqueues messages to the node that returned the feedback.

### Tx Q Index

Tx Q Index in a TxCQ VDM is a copy of the TxQ Index field in the WR VDM that the TxCQ VDM completes. The Tx Q Index in a TxCQ VDM points to the original TXQ entry that is receiving the completion message.

### TxQ ID

TxQ ID is the name of the queue at the source from which the original message was sent. The TxQ ID is included in the work request VDM and returned to the sender in the TxCQ VDM. TxQ ID is a 9-bit field.

### SEQ

A field from the source descriptor that is returned in both Tx CQ and Rx CQ entries. It is maintained as a sequence number by the drivers at each end to enforce ordering and implement the delivery guarantee.

### EnSeqChk

This bit indicates to the Rx Driver, whether the sender requested a SEQ check. For non-RDMA WR, software can implement sequence checking, as an optional feature, using this flag. Such sequence checking may also be accompanied by validating an application stream for maintaining order of operations in a specific application in a specific application flow.

Destination Domain of Message being Completed

This field identifies the bus number Domain of the source of the completion message, which was the destination of the message being completed.

### CFlags[1:0]

The CFlags are part of the NIC mode RxCQ message and indicate to the receive driver that the message spans multiple buffers. The Start Flag is asserted in the RxCQ message written for the first buffer. The Continue Flag is asserted for intermediate buffers and the End Flag is asserted for the last buffer of a multiple buffer message. This field helps to collect all the data buffers that result from a single WR by the receiving side software.

### Total Transfer Length [15:0] (Bytes)

This field appears only in the RDMA RxCQ message. The maximum RDMA message length is 10 pointers each with a length of up to 65 KB. The total fits in the 20-bit “Transfer Length of Entire Message” field. The 16 bits of this field are extended with the 4 bits of the following TTL field.

### TTL[19:19]

The TTL field provides the upper 4 bits of the Total Transfer Length.

Transfer Length of this Buffer (Bytes)

This field appears only in the NIC form of the RxCQ message. NIC mode buffers are fixed in length at 4 KB each.

### Starting Offset

This field appears only in the NIC form of the RxCQ message. The DMAC starts writing into the Rx buffer at an offset corresponding A[8:0] of the remote source address in order to eliminate source-destination misalignment. The offset value informs the Rx driver where the start of the data is in the buffer.

### VPF ID

The VPF ID is inserted into the WR by HW at the Tx and delivered to the Rx driver, after HW checking at the Rx, in the RxCQ message.

### ULP Flags

ULP Flags is an opaque field conveyed from the Tx driver to the Rx driver in all short packet and pull descriptor push messages and is delivered to the Rx driver in the RxCQ message.

### RDMA Layer

This section describes an RDMA transactions as the exchange of the VDMs defined in the previous section.

### Verbs Implementation

This table below summarizes how the descriptor and VDM formats defined in the previous section are used to implement the RDMA Verbs.

TABLE 29
Mapping of RDMA Verbs onto the VDMs

| | Vendor Defined Message | | | | | | | |
|---|---|---|---|---|---|---|---|---|
| | PLX | | | | | | | |
| | Msg | | Corresponding Descriptor and Flags | | | | | |
| RDMA Verb | Code | Message Type/Description | D-Type | Name | NoRxCQ | IntNow | ZBR | Invalidate |
| Write | 5′h04 | RDMA Pull | 4 | RDMA pull | 1 | 0 | P | 0 |
| Read | 5′h05 | RDMA Read Request | 5 | RDMA Read Request | 1 | 0 | P | 0 |
| Read Response | 5′h13 | PRFR (pull request for read) | NA | | | | | |
| Send (short packet) | 5′h03 | RDMA Short Untagged Push | 3 | RDMA short untagged | 0 | 0 | P | 0 |
| Send (long packet) | 5′h06 | RDMA Untagged Pull | 6 | RDMA Untagged Pull | 0 | 0 | P | 0 |
| Send (short) with Invalidate | 5′h03 | RDMA Tagged Pull | 3 | RDMA Pull | 0 | 0 | P | 1 |
| Send (long) with Invalidate | 5′h06 | RDMA Tagged Pull | 6 | RDMA Pull | 0 | 0 | P | 1 |
| Send (short) with Sol. Event | 5′h03 | RDMA Short Untagged Push | 3 | RDMA short untagged | 0 | 1 | P | 0 |
| Send (long) with Sol. Event | 5′h06 | RDMA Untagged Pull | 6 | RDMA Untagged Pull | 0 | 1 | P | 0 |
| Send (short) with SE and Invalidate | 5′h03 | RDMA Tagged Pull | 3 | RDMA Pull | 0 | 1 | P | 1 |
| Send (long) with SE and Invalidate | 5′h06 | RDMA Tagged Pull | 6 | RDMA Pull | 0 | 1 | P | 1 |

Note:
P => per policy

Solicited Event implies INTNOW flag and interrupt at the other end! But we should at least receive a RxCQ so software can do the event after that RDMA operation; that's the current implementation.

### Buffer Tag Invalidation

Hardware buffer tag security checks verify that the security key and source ID in the WR VDM match those in the BTT entry for all RDMA write and RDMA read WRs and for Send with Invalidate. If hardware receives the RDMA Send with Invalidate (with or without SE (solicited event), hardware will read the buffer tag table, check the security key and source GRID. If the security checks pass, hardware will write set the “Invalidated” bit in the buffer tag table entry after completion of the transfer. The data being transferred is written directly into the tagged buffer at the starting offset in the work request VDM.

If an RDMA transfer references a Buffer Tag Table entry marked “Invalidated”, the work request will be dropped without data transfer and a completion message will be returned with a CC indicating Invalidated BTT entry. There is no case where an RDMA write or RDMA read can cause hardware to invalidate the buffer tag entry—this can only be done via a Send With Invalidate. Other errors such as security violation do not invalidate the buffer tag.

### Connection Termination on Error

RDMA protocol has the idea of a stream (connection) between two members of a transmit—receive queue pair. If there is any problem with messages in the stream, the stream is shut down, the connection is terminated—no subsequent messages in the stream will get through. All traffic in the stream must complete in order. Connection status can't be maintained via the BTT because untagged RDMA transfers don't use a BTT entry.

When SEQ checking is performed only in the Rx driver software, SEQ isn't checked until after the data has been transferred but before upper protocol layers or the application have been informed of its arrival via a completion message. RDMA applications by default don't rely on completion messages but peek into the receive buffer to determine when data has been transferred and thus may receive data out of order unless SEQ checking is performed in the hardware. (Note however that some of the data of a single transfer may be written out of order but it is guaranteed that the last quanta (typically a PCIe maximum payload or the remainder after the last full maximum payload is transferred) will be written last.) HW SEQ checking is provided for a limited number of connections as described in the next subsection.

SEQ checking, in HW or SW, allows out of sequence WR messages, perhaps due to a lost WR message, to be detected. In such an event, the RDMA specification dictates that the associated connection be terminated. We have the option of initiating replay in the Tx driver so that upper layers never see the ordering violation and therefore we don't need to terminate the connection. However, lost packets of any type will be extremely rare so the expedient solution of simply terminating the connection is acceptable.

Our TxCQ VDM is the equivalent of the RDMA Terminate message. Any time that there is an issue with a transfer at the Rx end of the connection, such as remote read time out or a TxCQ message reports a fabric fault, the connection is taken down. The following steps are taken:
A TxCQ VDM is returned with the Condition Code indicating the reason for the error
An Expected SEQ of 00h is written into the SEQ ram at the index equal to the RxConnID in the packet provided the EnSeqChk flag in the packet is set.
   Any new WR that hits a connection that is down will be immediately completed with invalid connection status.

### Hardware Sequence Number Checking

As described earlier, the receive DMA engine maintains a SEQ number for up to at least 4K connections per x4 port, shared by the DMA VFs in that port. The receive sequence number RAM is indexed by an RxConnID that is embedded in the low half of the Security Key field. HW sequence checking is enabled/disabled for RDMA transfers per the EnSeqChk flag in the descriptor and work request VDM.

Sequence numbers increment from 01h to FFh and wrap back to 01. 00 is defined as invalid. The Rx side driver must validate a connection RAM entry before any RDMA traffic can be sent by setting its ExpectedSEQ to 01h, else it will all fail the Rx connection check. The Tx driver must do the same thing in its interal SEQ table.

If a sequence check fails, the connection will be terminated and the associated work request will be dropped/rejected with an error completion message. These completion messages are equivalent to the Terminate message described in the RDMA specification. The terminated state is stored/maintained in the SEQ RAM by changing the ExpectedSEQ to zero. No subsequent work requests will be able to use a terminated connection until software sets the expected SEQ to 01h.

### No Rx Buffer

If there is no receive buffer available for an untagged Send due to consumption of all entries on the buffer ring, the connection must fail. In order to support this, the Tx driver inserts an RxConnID into the descriptor for an untagged Send. The RDMA Untagged Short Push and Pull Descriptors include the full set of RDMA parameter fields. For an untagged send, the Tx Driver puts the RxConnId in the Security Key just as for tagged transfers. This allows either HW or SW SEQ checking for untagged transfers, signaled via the EnSeqChk flag. In the event of an error, the connection ID is known and so the protocol requirement to terminate the connection can be met.

### RDMA Buffer Registration

Memory allocated to an application is visible in multiple address spaces:
1. User mode virtual address—this is what applications use in user mode
2. Kernel mode virtual address—this is what kernel/drivers can use to access the same memory
3. Kernel mode physical address—this is the real physical address of the memory (got by a lookup of the OS/CPU page tables)
4. Bus Address/DMA Address—this is the address by which IO devices can read/write to that memory
   The above is a simple case of non-hypervisor, single OS system.

When an application allocates memory, it gets user mode virtual address. It passes this virtual address to kernel mode driver when it wants to register this memory with the hardware for a Buffer Tag Entry. Driver converts this to DMA address using system calls and sets up the required page tables in memory and then allocates/populates the BTT entry for this memory. The BTT index is returned as a KEY (LKEY/RKEY of RDMA capable NIC) for the memory registration.

A destination buffer may be registered for use as a target of subsequent RDMA transfers by:
1. Assigning/associating Buffer Tag, Security Key, and Source Global RID values to it
2. Creating a BTT entry at the table offset corresponding to the Buffer Tag
3. Creating the SG List(s) List of SG Lists referenced by the table entry, if any
4. Sending the Buffer Tag, Security Key and buffer length to the VF(Source Global RID) to enable it to initiate transfers into the buffer

### The Buffer Tag Table

The BTT entry is defined by the following table.

TABLE 30
RDMA Buffer Tag Table Entry Format

| Byte | +3 | | | | | | | | +2 | | | | | | | | +1 | | |
|---|---|---|---|---|---|---|---|---|---|---|---|---|---|---|---|---|---|---|---|
| DW | 31 | 30 | 29 | 28 | 27 | 26 | 25 | 24 | 23 | 22 | 21 | 20 | 19 | 18 | 17 | 16 | 15 | 14 | 13 |

| | | | |
|---|---|---|---|
| 0 | RxCQ ID | Source Domain | Source Global RID[15:0] |

| | | | | |
|---|---|---|---|---|
| 1 | Security Key | EnKeyChk | EnGridChk | AT |

| | | | |
|---|---|---|---|
| 2 | VPFID | Reserved | NumBytes[47:32] |

| 3 | NumBytes[31:0] | | | | | | | | | | | | | | | |
|---|---|---|---|---|---|---|---|---|---|---|---|---|---|---|---|---|
| 4 | Buffer Pointer[63:32] | | | | | | | | | | | | | | | |
| 5 | Buffer Pointer[31:0] | | | | | | | | | | | | | | | |
| 6 | Virtual Base Address[63:32] | | | | | | | | | | | | | | | |
| 7 | Virtual Base Address[31:0] | | | | | | | | | | | | | | | |
| | | Byte | +1 | | | | | +0 | | | | | | | | Byte |
| | | DW | 12 | 11 | 10 | 9 | 8 | 7 | 6 | 5 | 4 | 3 | 2 | 1 | 0 | Offset |

| 0 | Source Global RID[15:0] | | | | | | 00h |
|---|---|---|---|---|---|---|---|
| 1 | Btype[1:0] | WrEn | RdEn | In- | Re- | Log2 | 04h |
| | | | | validated | served | PageSize-12 | |

| | | |
|---|---|---|
| 2 | NumBytes[47:32] | 08h |
| 3 | NumBytes[31:0] | 0Ch |
| 4 | Buffer Pointer[63:32] | 10h |
| 5 | Buffer Pointer[31:0] | 14h |
| 6 | Virtual Base Address[63:32] | 18h |
| 7 | Virtual Base Address[31:0] | 1Ch |

Definition of Buffer Pointer as Function of Buffer Length

| BType | Type | Buffer Pointer |
|---|---|---|
| 2′b00 | Contiguous buffer | Actual Starting Address of Buffer |
| 2;b01 | List of pages | Pointer to SG List |
| 2′b10 | List of lists | Pointer to List of SG Lists |
| 2′b11 | Reserved | Don't care |

Each list page is 4 KB and contains (upto) 512 pointers; Entry 0 may have the starting offset of non-zero value.
Bytes in last page can be calculated using ((Virtual Base address + NumBytes) AND (Page size in byte −1))
PageSize = 2 to the ((Log2PageSize-12) + 12)
Minimum PageSize = 2 to the ((0) + 12) = 4 KB
MaximumPageSize = 2\hat{ }\hat{ }((15) + 12) = 2 \hat{ }\hat{ }27 = 134,217,728 = 128 MB
Log2PageSize-12-defines the page size for the SGList of its table entry. The default value of zero in this field
defines a 4 KB field. The maximum legal value of 9 defines a 2 MB page size

The fields of the BTT entry are defined in the following table. The top two fields in this table define how the buffer mode is inferred from the size of the buffer and the MMU page size for the buffer.

TABLE 31
Buffer Tag Table Entry Fields

| | <=1 page of | >1 page | |
|---|---|---|---|
| | memory or | AND <=512 | More than 512 |
| | Contiguous | pages of | pages of |
| Field | Buffer Mode | memory | memory |
| BType | Default = 0 = | Value = 1 Paged | Value = 2: |
| | Contiguous | Mode | List of Lists |
| | Buffe [symbol] | | Mode |
| Buffer | 54 bit pointer | 64 bit pointer | 64 bit pointer |
| Pointer | to the first | to the 4 KB SG | to the 4 KB |
| | byte of the | List page of | List of SG |
| | memory buffer | the buffer | Lists page(s) |
| | | | of the buffer |

| | |
|---|---|
| Source | The Domain and Global RID of the single node |
| Domain and | (source of the WR) allowed to transfer to this |
| Source | buffer. Don't care unless EnGridChk is set. |
| GRID | |
| RXCQ_ID | Filled in to tie this BT entry to a specific |
| | RXCQ. Default = 0. This is only applicable if the |
| | incoming WR's NoRXCQ flag bit is clear |
| (Log2Page- | This defines the page size. Default = 0 = 4 KB |
| Size-12) | page size. One implies a page size of 8 KB, and |
| | so forth. The maximum page size supported is |
| | 2\hat{ }\hat{ }((15) + 12) = 2\hat{ }\hat{ }27 = 134,217,728 = 128 MB |
| Invalidated | Default = 0 which means that the BTT entry is |
| | valid. Invalided is set by the hardware upon |
| | completion of a WR whose Invalidate flag is set. |
| RdEn | Default = 1, which means that reads of this |
| | buffer by a remote node are allowed |
| WrEn | Default = 1, which means that writes of this |
| | buffer by a remote node are allowed |
| AT | Defines the setting of the AT field used in the |
| | header of memory request TLPs that access the |
| | buffer. The default setting of zero means that |
| | the address is a BUS address that needs to be |
| | translated by the RC's IOMMU. Therefore, the |
| | TLP's AT field should be set to 2′b00 to |
| | indicate an untranslated address. |
| EnGridChk | Set to 1 if any access to this entry should be |
| | checked for valid SRC GRID and DOMAIN |
| | values, by hardware. |
| EnKeyChk | Set to 1 if SecurityKey is to be checked |
| | against incoming WR's security key field by |
| | hardware. |
| SecurityKey | 15 bit security key for the memory registration. |
| | Applications exchange this security key during |
| | connection establishment. Don't care unless |
| | EnKeyChk is set. |
| NumBytes | Size of the memory buffer defined by this entry, |
| [47:0] | in bytes |
| VPFID | The VPFID to be checked against the VPFID in |
| | the WR VDM to authorize a transfer. Default |
| | value = 0. |
| Virtual | Application mode virtual base address of the |
| Base | memory; exchanged with remote nodes. Hardware |
| Address | calculates the absolute offset for getting to |
| | the correct page in BTTE. by using the |
| | calculation: Offset = WR's |
| | RDMA_STARTING_BUFFER_OFFSET-BTTE's |
| | Virtual Base address |

[symbol]

indicates data missing or illegible when filed

### Buffer Modes

Per the table above, buffers are defined in one of three ways:

1. Contiguous Buffer Mode
a. A buffer consisting of a single page or a single contiguous region, whose base address is the Buffer Pointer field of the BTT entry itself

2. Single Page Buffer Mode
a. A buffer consisting of 2 to 512 pages defined by a single 4 KB SG List contained in a single 4 KB memory page
b. The Buffer Pointer field of the BTT entry points to an SG List, whose entries are pointers to the memory pages of the buffer.

3. List of Lists BufferMode
a. A buffer consisting of more than 512 pages defined by a List of SG Lists, with up to 512 64 bit entries, each a pointer to a 4 KB page containing an SG List
b. The List of SG Lists may be larger than 4 KB but must be a single physically contiguous region
c. The Buffer Pointer field of the BTT entry points to the start of the List of SG Lists

The maximum size of a single buffer is 2⁴⁸ bytes or 65K times 4 GB, far larger than needed to describe any single practical physical memory. A 4 GB buffer spans 1 million 4 KB pages. A single SG list contains pointers to 512 pages. 2K SG Lists are needed to hold 1M page pointers. Thus, the List of SG Lists for a 4 GB buffer requires a physically contiguous region 20 KB in extent. If the page size is higher, this size comes down accordingly. For example, for a page size of 128 MB, a single SG list of 512 entries can cover 64 GB.

### Contiguous Buffer Mode

If the BType bit of the entry is a ONE, then the buffer's base address is found in the Buffer Pointer field of the entry. In this case, the starting DMA address is calculated as:

DMA Start Address=Buffer pointer+(RDMA_Starting Offset from the WR−Virtual Base address in BTTE).

That the transfer length fits within the buffer is determined by evaluating this inequality:

RDMA_STARTING_OFFSET+Total Transfer Length from WR<=Virtual base address in BTTE+NumBytes in BTTE.

If this check fails, then transfer is aborted and completion messages are sent indicating the failure. Note the difficulty in resolving last 16 bytes of TTL without summing the individual Length at Pointer fields.

### Single Page Buffer Mode

If the buffer is comprised of a single memory page then the Buffer Pointer of the BTT entry is the physical base address of the first byte of the buffer, just as for Contiguous Buffer mode.

### SG List Buffer

When the buffer extends to more than one page but contains less than (or equal to) 512 pages, then a the Buffer pointer in the BTT entry points to an SG List.

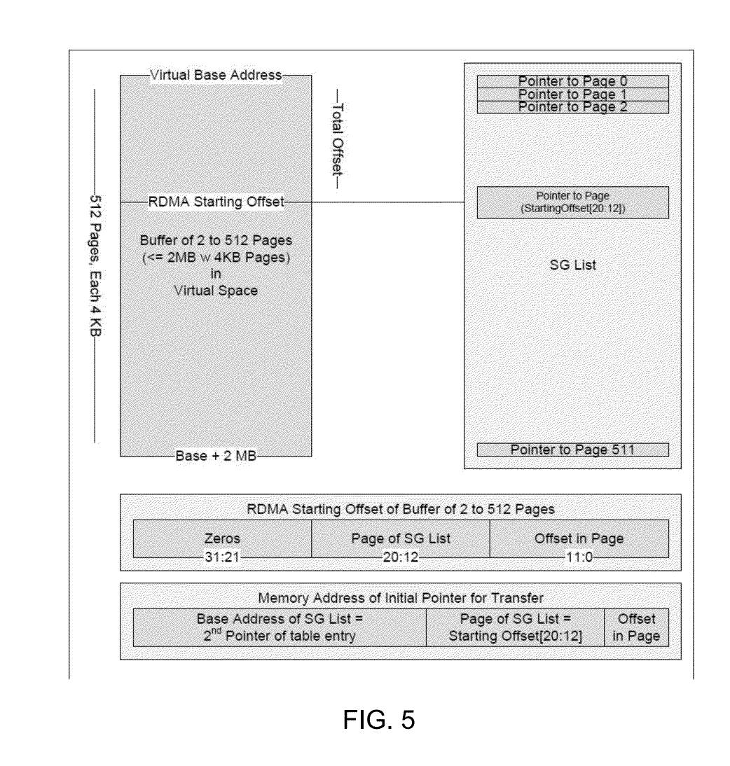

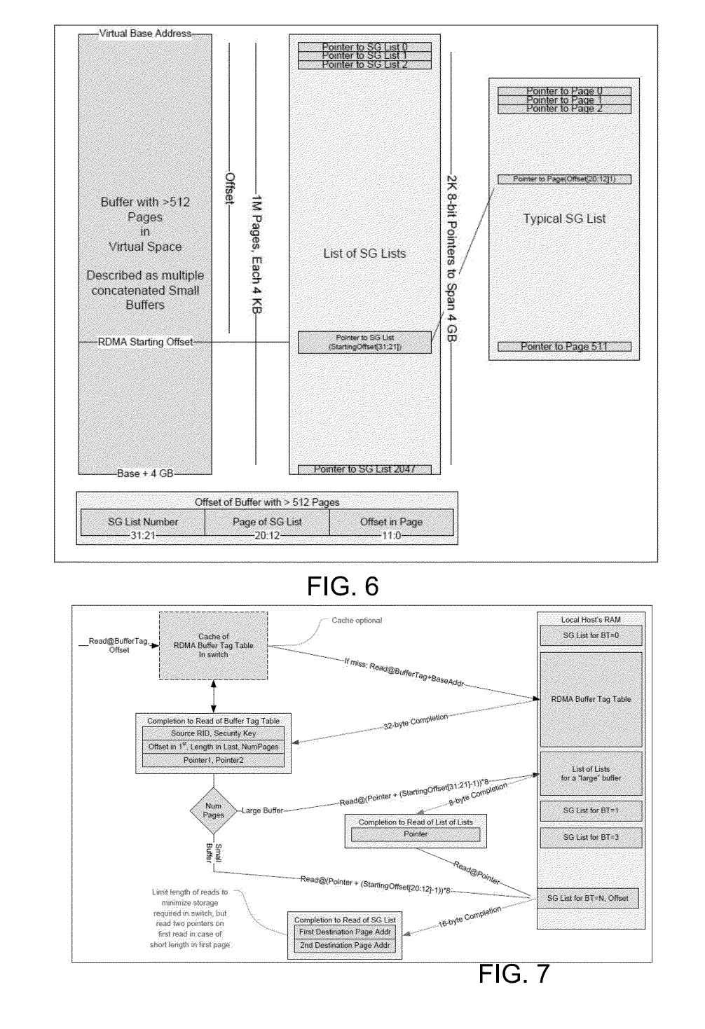

An SG List, as used here, is a 4 KB aligned structure containing up to 512 physical page addresses ordered in accordance with their offset from the start of the buffer. This relationship is illustrated in FIG. 5. Bits [(Log₂(PageSize)−1):0] of each of the page pointers in the SG lists are zero except for the very last page of a buffer where the full 64-bit address defines the end of the buffer.

The offset from the start of a buffer is given by:

Offset=RDMA Starting Buffer Offset−Virtual Base Address

where the RDMA Starting Buffer Offset is from the WR VDM and the Virtual Base Address is from the BTT entry pointed to by the WR VDM.

Offset divided by the page size gives the Page Number:

Page=Offset<<Log₂PageSize

The starting offset within that page is given by:

Start Offset in Page=RDMA Starting Buffer Offset && (PageSize−1)

where && indicates a bit-wise AND.

### Small Paged Buffer's Destination Address

A “small” buffer is one described by a pointer list (SG list) that fits within a single 4 KB page, and can thus span 512 4 KB pages. For a “small” buffer, a second BTT read is required to get the destination address's page pointer. A second read of host memory is required to retrieve the pointer to the memory page in which the transfer starts. Using 4 KB pages, the page number within the list is Starting Offset[20:12]. The DMA reads starting at address={BufferPointer[63:12, Starting Offset[20:12], 3′b000}, obtaining at least one 8-byte aligned pointer and more according to transfer length and how many pointers it has temporary storage for.

### Large Paged Buffer's Destination Address

A Large Paged Buffer requires more than one SG List to hold all of its page pointers. For this case, Buffer Pointer in the BTT entry points to a List of SG Lists. A total of three reads are required to get the starting destination address:
1. Read of the BTT to get the BTT entry
2. Read of the List of SG Lists to get a pointer to the SG List
3. Read of the SG List to get the pointer to the page containing the destination start address.

### RDMA BTT Lookup Process

In RDMA, the Security Key and Source ID in the RDMA Buffer Tag Table entry at the table index given by the Buffer Tag in the descriptor message are checked against the corresponding fields in the descriptor message. If these checks are enabled by the EnKeyChk and EnGridChk BTT entry fields, the message is allowed to complete only if each matches and, in addition, the entire transfer length fits within the buffer defined by the table entry and associated pointer lists. For pull protocol messages, these checks are done in HW by the DMAC. For RDMA short packet pushes, the validation information is passed to the software in the receive completion message and the checks are done by the Rx driver.

The table lookup process used to process an RDMA pull VDM at a destination switch is illustrated in FIG. 7. When processing a source descriptor, the DMAC reads the BTT at the offset from its base address corresponding to Buffer Tag. The switch implementation may include an on-chip cache of the BTT (unlikely at this point) but if no cache or a cache miss, this requires a read of the local host's memory. The latency of this read is masked by the remote read of the data/message.

This singe BTT read returns the full 32 byte entry defined in Table 30 RDMA Buffer Tag Table Entry Format, illustrated by the red arrow labeled 32-byte Completion in the figure. The source RID and security key of the entry are used by the DMAC to authenticate the access. If the parameters for which checks are enabled by the BTT entry don't match the same parameters in the descriptor, completion messages are sent to both source and destination with a completion code indicating security violation. In addition, any message data read from the source is discarded and no further read requests for the message data are initiated.

If the parameters do match or the checks aren't enabled, then the process continues to determine the initial destination address for the message. The BTT entry read is followed by zero, one, or two more reads of host memory to get the destination address depending on the size and type of buffer, as defined by the BTT entry.

### RDMA Control and Status Registers

RDMA transfers are managed via the following control registers in the VF's BARO memory mapped register space and associated data structures.

TABLE 32
RDMA Control and Status Registers

| | Default | | | | | | |
|---|---|---|---|---|---|---|---|
| | Value | Attribute | Attribute | EEPROM | Reset | | |
| Offset | (hex) | (MCPU) | (Host) | Writable | Level | Register or Field Name | Description |
| 830h | | | | | | QUEUE_INDEX | Index (0 based entry |
| | | | | | | | number) for all index |
| | | | | | | | based read/write of |
| | | | | | | | queue/data structure |
| | | | | | | | parameters below this |
| | | | | | | | register; software |
| | | | | | | | writes this first before |
| | | | | | | | read/write of other |
| | | | | | | | index based registers |
| | | | | | | | below (TXQ, RXCQ, |
| | | | | | | | RDMA CONN) |
| 850h | | | | | | BTT BASE_ADDR_LOW | Low 32 bits of Buffer |
| | | | | | | | tag table base |
| | | | | | | | address |
| [3:0] | | RW | RW | Yes | Level01 | BTT Size | size of BT Table in |
| | | | | | | | entries ( power of 2 * |
| | | | | | | | 256) |
| [6:4] | | RsvdP | RsvdP | No | Level0 | Reserved | |
| [31:7] | | RW | RW | Yes | Level01 | BTT Base Address Low | Low bits of BTT base |
| | | | | | | | address (extend with |
| | | | | | | | Zero for the low 7 bits) |
| 854h | | | | | | BTT_BASE_ADDR_HIGH | |
| [31:0] | | RW | RW | Yes | Level01 | | High 32 bits of BTT |
| | | | | | | | base address |
| 858h | | | | | | RDMA_CONN_CONFIG | RDMA Connection |
| | | | | | | | table configuration for |
| | | | | | | | this Function set by |
| | | | | | | | MCPU (RW for |
| | | | | | | | MCPU) |
| [13:0] | | RO | RO | | | RDMA_CONN_START_INDEX | Starting index in the |
| | | | | | | | station's RDMA |
| | | | | | | | Connection table |
| [15:14] | | RsvdP | RsvdP | No | Level0 | Reserved | |
| [29:16] | | RO | RO | | | MAX_RDMA_CONN | Maximum RDMA |
| | | | | | | | connections allowed |
| | | | | | | | for this function |
| [31:30] | | RsvdP | RsvdP | No | Level0 | Reserved | |
| 85Ch | | | | | | RDMA_SET_RESET | Set or Reset the |
| | | | | | | | RDMA connection |
| | | | | | | | indexed by |
| | | | | | | | QUEUE_INDEX |
| | | | | | | | register |
| [0] | | RW | RW | Yes | Level01 | RDMA_SET_CONNECTION | Set the connection |
| | | | | | | | valid and the |
| | | | | | | | sequence number to 1 |
| [1] | | RW | RW | Yes | Level01 | RDMA_RESET_CONNECTION | Reset the connection |
| | | | | | | | (mark invalild), and |
| | | | | | | | set seq. num to 0 |
| [31:2] | | RsvdP | RsvdP | No | Level0 | Reserved | |
| 860h | | | | | RDMA_GET_CONNECTION_STATE | | Get current |
| | | | | | | | connection state for |
| | | | | | | | the connection |
| | | | | | | | indexed by |
| | | | | | | | QUEUE_INDEX |
| | | | | | | | register (DEBUG |
| | | | | | | | REGISTER) |
| [7:0] | | RO | RO | No | Level0 | RDMA_CONNECTION_STATE | current sequence |
| | | | | | | | number (0—invalid) |
| [31:8] | | RsvdP | RsvdP | No | Level0 | Reserved | |

### Broadcast/Multicast Usage Models

Support for broadcast and multicast is required in Capella. Broadcast is used in support of networking (Ethernet) routing protocols and other management functions. Broadcast and multicast may also be used by clustering applications for data distribution and synchronization.

Routing protocols typically utilize short messages. Audio and video compression and distribution standards employ packets just under 256 bytes in length because short packets result in lower latency and jitter. However, while a Capella fabric might be at the heart of a video server, the multicast distribution of the video packets is likely to be done out in the Ethernet cloud rather than in the ExpressFabric.

In HPC and instrumentation, multicast may be useful for distribution of data and for synchronization (e.g. announcement of arrival at a barrier). A synchronization message would be very short. Data distribution broadcasts would have application specific lengths but can adapt to length limits

There are at best limited applications for broadcast/multicast of long messages and so these won't be supported directly. To some extent, BC/MC of messages longer than the short packet push limit may be supported in the driver by segmenting the messages into multiple SPPs sent back to back and reassembled at the receiver.

Standard MC/BC routing of Posted Memory Space requests is required to support dualcast for redundant storage adapters that use shared endpoints.

### Broadcast/Multicast of DMA VDMs

For Capella-2 we need to extend PCIe MC to support multicast of the ID-routed Vendor Defined Messages used in host to host messaging and to allow broadcast/multicast to multiple Domains.

To support broadcast and multicast of DMA VDMs in the Global ID space, we:
Define the following BC/MC GIDs:
   Broadcast to multiple Domains uses a GID of {0FFh, 0FFh, 0FFh}
   Multicast to multiple Domains uses a GID of {0FFh, 0FFh, MCG}
      Where the MCG is defined per the PCIe Specification MC ECN
   Broadcast confined to the home Domain uses a GID of {HomeDomain, 0FFh, 0FFh}
   Multicast confined to the home Domain uses a GID of {HomeDomain, 0FFh, MCG}
Use the FUN of the destination GRID of a DMA Short Packet Push VDM as the Multicast Group number (MCG).
   Use of 0FFh as the broadcast FUN raises the architectural limit to 256 MCGs
   Capella will support 64 MCGs defined per the PCIe specification MC ECN
Multicast/broadcast only short packet push ID routed VDMs
   At a receiving host, DMA MC packets are processed as short packet pushes. The PLX message code in the short packet push VDM can be NIC, CTRL, or RDMA Short Untagged. If a BC/MC message with any other message code is received, it is rejected as malformed by the destination DMAC.

With these provisions, software can create and queue broadcast packets for transmission just like any others. The short MC packets are pushed just like unicast short packets but the multicast destination IDs allow them to be sent to multiple receivers.

Standard PCIe Multicast is unreliable; delivery isn't guaranteed. This fits with IP multicasting which employs UDP streams, which don't require such a guarantee. Therefore Capella will not expect to receive any completions to BC/MC packets as the sender and will not return completion messages to BC/MC VDMs as a receiver. The fabric will treat the BC/MC VDMs as ordered streams (unless the RO bit in the VDM header is set) and thus deliver them in order with exceptions due only to extremely rare packet drops or other unforeseen losses.

When a BC/MC VDM is received, the packet is treated as a short packet push with nothing special for multicast other than to copy the packet to ALL VFs that are members of its MCG, as defined by a register array in the station. The receiving DMAC and the driver can determine that the packet was received via MC by recognition of the MC value in the Destination GRID that appears in the RxCQ message.

### Broadcast Routing and Distribution

Broadcast/multicast messages are first unicast routed using DLUT provided route Choices to a “Domain Broadcast Replication Starting Point (DBRSP)” for a broadcast or multicast confined to the home domain and a “Fabric Broadcast Replication Starting Point (FBRSP)” for a fabric consisting of multiple domains and a broadcast or multicast intended to reach destinations in multiple Domains.

Inter-Domain broadcast/multicast packets are routed using their Destination Domain of 0FFh to index the DLUT. Intra-Domain broadcast/multicast packets are routed using their Destination BUS of 0FFh to index the DLUT. PATH should be set to zero in BC/MC packets. The BC/MC route Choices toward the replication starting point are found at D-LUT[{1, 0xff}] for inter-Domain BC/MC TLPs and at D-LUT[{0, 0xff}] for intra-Domain BC/MC TLPs. Since DLUT Choice selection is based on the ingress port, all 4 Choices at these indices of the DLUT must be configured sensibly.

Since different DLUT locations are used for inter-Domain and intra-Domain BC/MC transfers, each can have a different broadcast replication starting point. The starting point for a BC/MC TLP that is confined to its home Domain, DBRSP, will typically be at a point on the Domain fabric where connections are made to the inter-Domain switches, if any. The starting point for replication for an Inter-Domain broadcast or multicast, FBRSP, is topology dependent and might be at the edge of the domain or somewhere inside an Inter-Domain switch.

At and beyond the broadcast replication starting point, this DLUT lookup returns a route Choice value of 0xFh. This signals the route logic to replicate the packet to multiple destinations.
If the packet is an inter-Domain broadcast, it will be forwarded to all ports whose Interdomain_Broadcast_Enable port attribute is asserted.
If the packet is an inter-Domain broadcast, it will be forwarded to all ports whose Intradomain_Broadcast_Enable port attribute is asserted.
   For multicast packets, as opposed to broadcast packets, the multicast group number is present in the Destination FUN. If the packet is a multicast, destination FUN !=0FFh, it will be forwarded out all ports whose PCIe Multicast Capability Structures are member of the multicast group of the packet and whose Interdomain_Broadcast_Enable or Intradomain_Broadcast_Enable port attribute is asserted.

### General Example

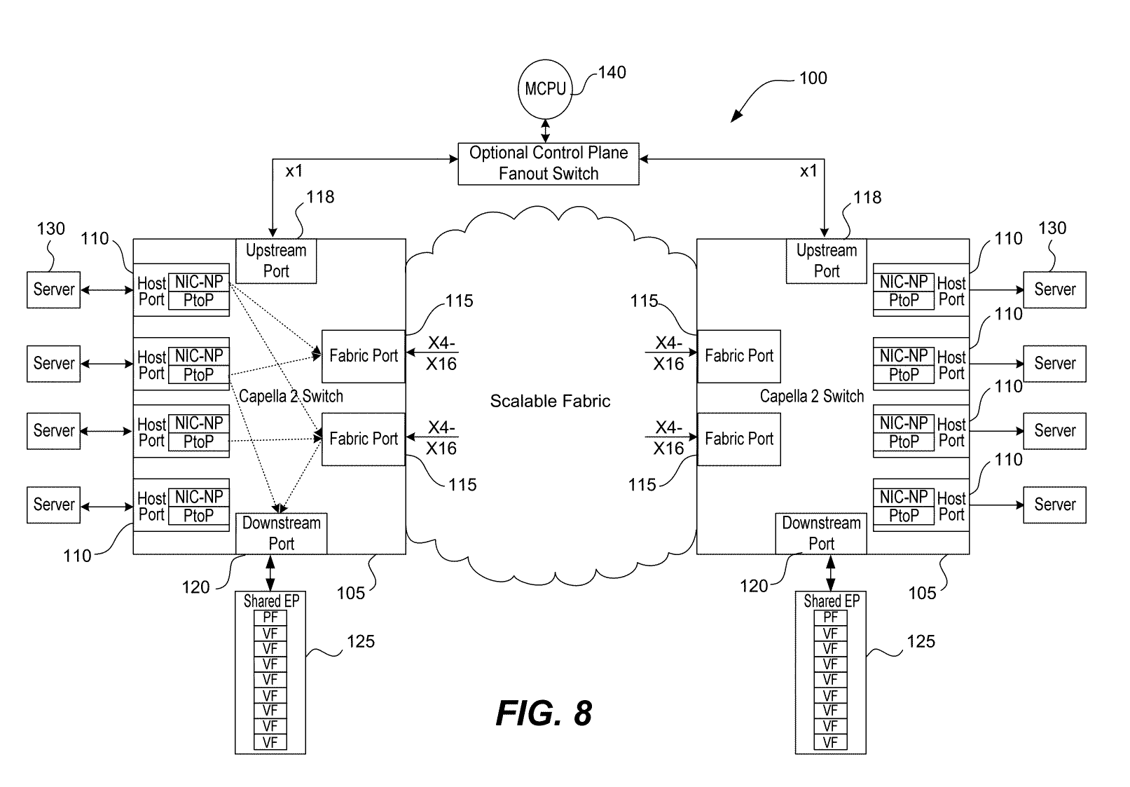

To facilitate understanding of an embodiment of the invention, FIG. 8 is a switch fabric system 100 block. Diagram that may be used in an embodiment of the invention. Some of the main system concepts of ExpressFabric™ are illustrated in FIG. 8, with reference to a PLX switch architecture known as Capella 2.

Each switch 105 includes host ports 110 with and embedded NIC 200, fabric ports 115, an upstream port 118, and a downstream port 120. The individual host ports 110 may include PtoP (peer-to-peer) elements. In this example, a shared endpoint 125 is coupled to the downstream port and includes physical functions (PFs) and Virtual Functions (VFs). Individual servers 130 may be coupled to individual host ports. The fabric is scalable in that additional switches can be coupled together via the fabric ports. While two switches are illustrated, it will be understood that an arbitrary number may be coupled together as part of the switch fabric. While a Capella 2 switch is illustrated, it will be understood that embodiments of the present invention are not limited to the Capella 2 switch architecture.

A Management Central Processor Unit (MCPU) 140 is responsible for fabric and I/O management and may include an associated memory having management software (not shown). In one optional embodiment, a semiconductor chip implementation uses a separate control plan 150 and provides an x1 port for this use. Multiple options exist for fabric, control plane, and MCPU redundancy and fail over. The Capella 2 switch supports arbitrary fabric topologies with redundant paths and can implement strictly non-blocking fat tree fabrics that scale from 72×4 ports with nine switch chips to literally thousands of ports.

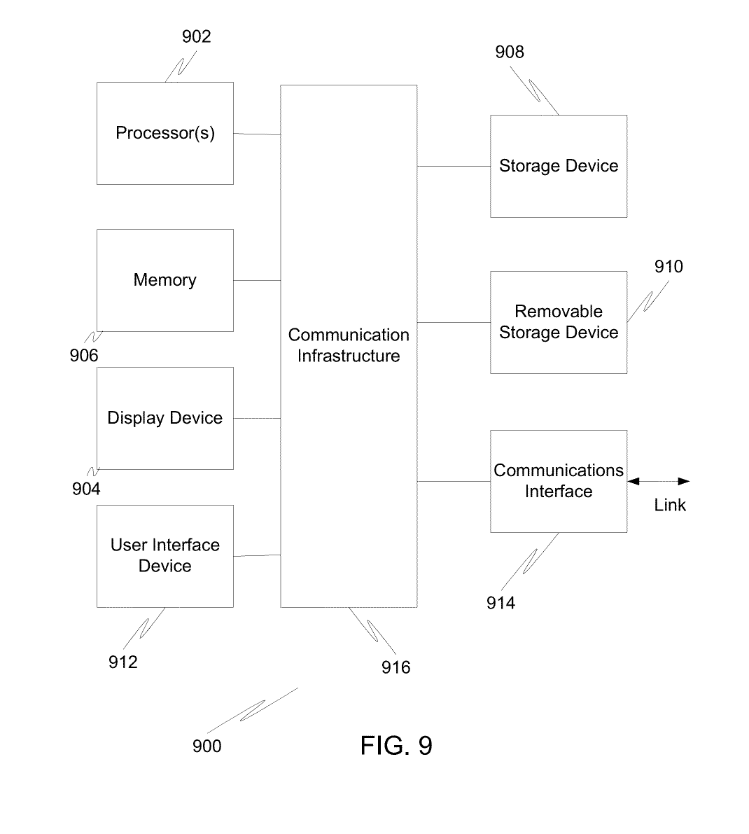

FIG. 9 is a high level block diagram showing a computing device 900, which is suitable for implementing a computing component used in embodiments of the present invention. The computing device may have many physical forms ranging from an integrated circuit, field programmable gate array, a printed circuit board, a switch with computing ability, and a small handheld device up to a huge super computer. The computing device 900 includes one or more processing cores 902, and further can include an electronic display device 904 (for displaying graphics, text, and other data), a main memory 906 (e.g., random access memory (RAM)), storage device 908 (e.g., hard disk drive), removable storage device 910 (e.g., optical disk drive), user interface devices 912 (e.g., keyboards, touch screens, keypads, mice or other pointing devices, etc.), and a communication interface 914 (e.g., wireless network interface). The communication interface 914 allows software and data to be transferred between the computing device 900 and external devices via a link. The system may also include a communications infrastructure 916 (e.g., a communications bus, cross-over bar, or network) to which the aforementioned devices/modules are connected.

Information transferred via communications interface 914 may be in the form of signals such as electronic, electromagnetic, optical, or other signals capable of being received by communications interface 914, via a communication link that carries signals and may be implemented using wire or cable, fiber optics, a phone line, a cellular phone link, a radio frequency link, and/or other communication channels. With such a communications interface, it is contemplated that the one or more processors 902 might receive information from a network, or might output information to the network in the course of performing the above-described method steps. Furthermore, method embodiments of the present invention may execute solely upon the processors or may execute over a network such as the Internet in conjunction with remote processors that shares a portion of the processing.

The term “non-transient computer readable medium” is used generally to refer to media such as main memory, secondary memory, removable storage, and storage devices, such as hard disks, flash memory, disk drive memory, CD-ROM and other forms of persistent memory and shall not be construed to cover transitory subject matter, such as carrier waves or signals. Examples of computer code include machine code, such as produced by a compiler, and files containing higher level code that are executed by a computer using an interpreter. Computer readable media may also be computer code transmitted by a computer data signal embodied in a carrier wave and representing a sequence of instructions that are executable by a processor.

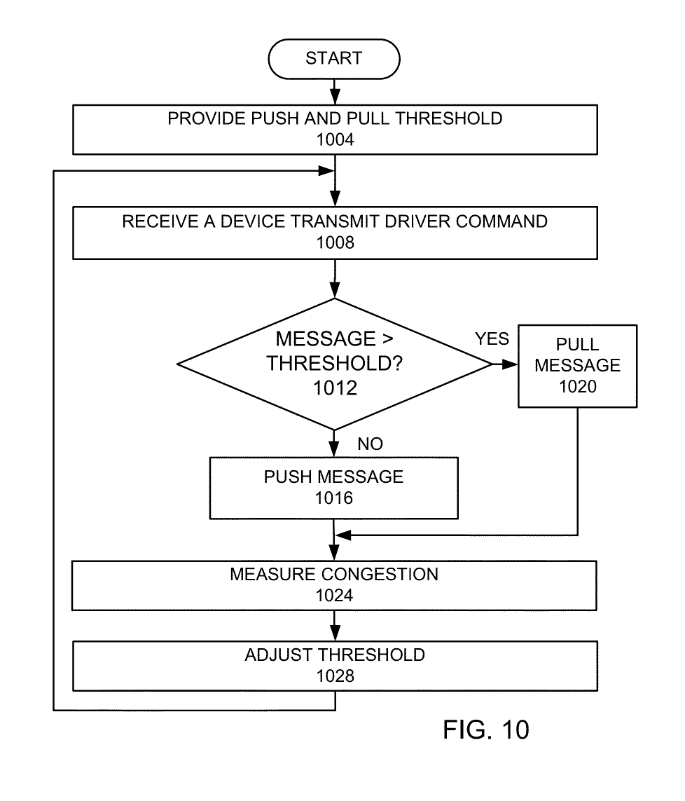

FIG. 10 is a high level flow chart of an embodiment of the invention. A push and pull threshold is provided (step 1004). A device transmit driver command to transfer a message is received (step 1008). A determination is made of whether the message is greater than a threshold (step 112). If the message is not greater than the threshold, then the message is pushed (step 1016). If the message is greater than the threshold, then the message is pulled (step 1020). Congestion is measured (step 1024) The measured congestion is used to adjust the threshold (step 1028).

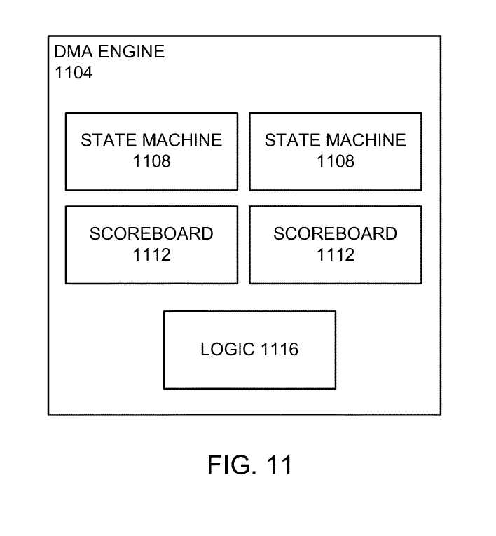

FIG. 11 is a schematic illustration of a DMA engine 1104 that may be part of a switch 105. The DMA engine 1104 may have one or more state machines 1108 and one or more scoreboards 1112. The DMA engine 1104 may have logic 1116. The logic 1116 may be used to provide a zero byte read option with a guaranteed delivery option. In other embodiments logic used to provide a zero byte read option with a guaranteed delivery option may be in another part of the switch fabric system 100 block.

In other embodiments of the invention, a NIC may be replaced by another type of network class device endpoint such as a host bus adapter or a converged network adapter.

In the specification and claims, physical devices may also be implemented by software.

While this invention has been described in terms of several preferred embodiments, there are alterations, permutations, modifications, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A method of transferring data over a fabric switch with at least one switch with an embedded network class endpoint device, comprising:
initializing a push vs. pull threshold;
receiving at a device transmit driver a command to transfer a message;
if the message length is less than the push vs. pull threshold the message is pushed;
if the message length is greater than the push vs. pull threshold, the message is pulled;
measuring congestion at various message destinations; and
adjusting the push vs. pull threshold according to the measured congestion.

2. The method, as recited in claim 1, further comprising prefetching data to be pulled into a switch at a source node while waiting for the message to be pulled from the destination node, provided that the message length is greater than the push vs pull threshold and less than a configured limit.

3. The method, as recited in claim 2, further comprising tuning the push and pull threshold using dynamic tuning.

4. The method, as recited in claim 3, further comprising providing a pull completion message with congestion feedback.

5. The method, as recited in claim 2, further comprising a buffer tag table (BTT) in host memory, wherein the BTT has a read latency, wherein the latency of the BTT read is masked by the latency of the remote read of the pull method.

6. An apparatus, comprising:
a switch; and
at least one network class device endpoint embedded in the switch.

7. The apparatus, as recited in claim 6, wherein the switch includes logic to provide a zero byte read option with a guaranteed delivery option.

8. The apparatus as recited in claim 6, wherein the switch further comprises a physical DMA engine, wherein each network class device endpoint embedded in the switch is a virtual function whose physical operations are performed by the physical DMA engine embedded in the switch.

9. The apparatus, as recited in claim 8, wherein the physical DMA engine includes state machines and scoreboards for performing RDMA transfers.

10. The apparatus, as recited in claim 9, wherein the state machines and scoreboards provide RDMA pull with BTT read latency masking.

11. The apparatus, as recited in claim 8, wherein the physical DMA engine includes state machines and scoreboards for performing for performing Ethernet tunneling.

12. The apparatus, as recited in claim 11, wherein message data is written into a receive buffer at an offset and the offset value is communicated to message receiving software in a completion message.

13. The apparatus, as recited in claim 8, wherein the physical DMA engine performs sequence number generation and checking in order to enforce ordering, wherein a sequence value of zero is interpreted to indicate an invalid connection and wherein when the sequence value is incremented above a maximum value the count is wrapped back to one.

14. The apparatus as recited in claim 8, where address traps are used to map the BARs of the network class endpoint Virtual Functions to the control registers of the physical DMA engine.

15. The apparatus, as recited in claim 6, wherein support for tunneling multiple protocols is provided by descriptor and message header fields that allow protocol specific information to be carried from sender to receiver in addition to the normal message payload data.

16. The apparatus as recited in claim 6, where in provision is made for balancing the workload associated with receiving messages across multiple processor cores, each associated with a specific receive completion queue, by use of a RxCQ_hint field in the message and a hash of source and destination IDs with the hint.

17. A method of transferring data over a fabric switch with at least one switch with an embedded network class endpoint device, comprising:
receiving at a device transmit driver a command to transfer a message;
if the message length is less than the threshold the message is pushed; and
if the message length is greater than the threshold, the message is pulled.

18. A method of transferring data over a switch fabric, comprising:
providing a fabric switch;
embedding at least one network class end point device in the fabric switch.

19. The method, as recited in claim 18, further comprising providing within the fabric switch a zero byte read option with a guaranteed delivery option.

20. The method as recited in claim 18, further comprising providing a physical DMA engine within the fabric switch, wherein each network class device endpoint embedded in the switch is a virtual function whose physical operations are performed by the physical DMA engine embedded in the fabric switch.

21. The method, as recited in claim 18, further comprising providing support for tunneling multiple protocols by providing descriptor and message header fields that allow protocol specific information to be carried from sender to receiver in addition to the normal message payload data.

22. The method as recited in claim 18, further comprising providing provision for balancing workload associated with receiving messages across multiple processor cores, each associated with a specific receive completion queue, by use of a RxCQ_hint field in the message and a hash of source and destination IDs with the hint.
